(19) United States
(12) Patent Application Publication
(10) Pub. No.: US 2026/0021452 A1
(43) Pub. Date: Jan. 22, 2026

(54) MEMBRANES, DEVICES, AND METHODS OF MAKING AND USE THEREOF

(71) Applicant: VANDERBILT UNIVERSITY, Nashville, TN (US)

(72) Inventors: Piran R. Kidambi, Nashville, TN (US); Nicole Moehring, Nashville, TN (US); Pavan Chaturvedi, Nashville, TN (US)

(21) Appl. No.: 19/272,308

(22) Filed: Jul. 17, 2025

Related U.S. Application Data
(60) Provisional application No. 63/672,387, filed on Jul. 17, 2024.
(60) Provisional application No. 63/743,902, filed on Jan. 10, 2025.

(51) Int. Cl. B01D 69/14; B01D 71/02

(52) U.S. Cl. CPC B01D 69/148; B01D 71/0211

(57) ABSTRACT

Disclosed herein are membranes, devices, and methods of making and use thereof. For example, disclosed herein are membranes comprising: a two-dimensional (2D) material, a support, and an ionomer, wherein the two-dimensional (2D) material disposed on the support, thereby forming a construct, wherein the two-dimensional material is infilled with the ionomer, the support is infilled with the ionomer, the construct is infilled with the ionomer, or a combination thereof, thereby forming the membrane.

### CROSS-REFERENCE TO RELATED APPLICATIONS

This application claims the benefit of priority to U.S. Provisional Application No. 63/672,387 filed Jul. 17, 2024 and U.S. Provisional Application No. 63/743,902 filed Jan. 10, 2025, each of which is hereby incorporated herein by reference in its entirety.

### STATEMENT OF GOVERNMENT SUPPORT

This invention was made with government support under grant no. 1944134 awarded by the National Science Foundation and grant no. DE-SC0022915 awarded by the Department of Energy. The government has certain rights in the invention.

### BACKGROUND

Permeance versus selectivity trade-offs are endemic to polymeric membranes. Membranes and devices with improved properties are needed. The membranes, devices, and methods discussed herein address these and other needs.

### SUMMARY

In accordance with the purposes of the disclosed devices and methods as embodied and broadly described herein, the disclosed subject matter relates to membranes, devices, and methods of making and use thereof.

For example, disclosed herein are membranes comprising: a two-dimensional (2D) material, a support, and an ionomer, wherein the two-dimensional (2D) material disposed on the support, thereby forming a construct, wherein the two-dimensional material is infilled with the ionomer, the support is infilled with the ionomer, the construct is infilled with the ionomer, or a combination thereof, thereby forming the membrane.

In some examples, the two-dimensional material comprises graphene, hexagonal boron nitride (h-BN), a transition metal dichalcogenide (e.g., porous TMDC), a covalent organic framework, a metal organic framework, ultra-thin oxides, mica, graphdyene like periodic porous structures, layered clays, mineral clays, or a combination thereof. In some examples, two-dimensional material comprises graphene, hexagonal boron nitride (h-BN), or a combination thereof. In some examples, the two-dimensional material comprises graphene. In some examples, the two-dimensional material comprises graphene oxide. In some examples, the two-dimensional material comprises h-BN. In some examples, the two-dimensional material has an average thickness of from 0.3 to 100 nm. In some examples, the 2D material is permeated by one or more pores, one or more defects, or a combination thereof. In some examples, at least a portion of the one or more pores, the one or more defects, or a combination thereof in the 2D material are infilled by the ionomer.

In some examples, the support comprises polyether sulfone (PES), polystyrene (PS), polyvinylidene fluoride (PVDF), polyethylene terephthalate (PET), polycarbonate and polycarbonate track etch supports (PCTE), polyethylene (PE), high density polyethylene (HDPE), Polyester, Poly imide, Teflon, Nylon, Rayon, electrospun fibers, woven cloths or metal meshes, anodic alumina (AAO), porous silicon, derivatives thereof, or combinations thereof.

In some examples, the support has no pores (e.g., wherein the support is dense).

In some examples, the support is porous in that the support is permeated by one or more pores, one or more defects, or a combination thereof. In some examples, at least a portion of the one or more pores, the one or more defects, or a combination thereof in the porous support are infilled by the ionomer.

In some examples, the ionomer comprises a proton conducting polymer, an anion conducting polymer, or a combination thereof. In some examples, the ionomer comprises a proton conducting polymer. In some examples, the ionomer comprises an anion conducting polymer.

In some examples, the ionomer comprises Polybenzimidazoles (PBIs); Poly(aryl ether sulfones), such as sulfonated poly(arylene ether sulfone)s; Poly(phenylene oxide) (PPO) and derivatives thereof, such as PPO polymers, such as sulfonated poly(phenylene oxide) (SPPO); Poly(ether imide); Poly(vinyl alcohol) (PVA), such as PVA-based polymers, especially when modified or blended with other materials; Poly(ionic liquids), such as poly(ionic liquid) materials; conductive polymers, such as polyaniline, polypyrrole, and polythiophene, when doped with suitable acids; Nafion; SPEEK (Sulfonated PolyEtherEtherKetone); ammonium-functionalized (e.g., quaternary ammonium-functionalized) polysulfones or polyethers or Polyarylene Ethers or Polyethylene or Polyvinyl Alcohol; Ammonium-functionalized (e.g., Quaternary ammonium-functionalized) poly(phenylene oxide) (PPO); ammonium-functionalized (e.g., quaternary ammonium-functionalized) poly(styrene); Imidazolium-functionalized polysulfones or polyethers or Polyarylene Ethers or Polyethylene or Polyvinyl Alcohol; Imidazolium-functionalized poly(phenylene oxide) (PPO); Imidazolium-functionalized poly(styrene); Phosphonium-functionalized polysulfones or polyethers or Polyarylene Ethers or Polyethylene or Polyvinyl Alcohol; Phosphonium-functionalized poly(phenylene oxide) (PPO); Phosphonium-functionalized poly(styrene); derivatives thereof; or combinations thereof. In some examples, the ionomer comprises Polybenzimidazoles (PBIs); Poly(aryl ether sulfones), such as sulfonated poly(arylene ether sulfone)s; Poly(phenylene oxide) (PPO) and derivatives thereof, such as PPO polymers, such as sulfonated poly(phenylene oxide) (SPPO); Poly(ether imide); Poly(vinyl alcohol) (PVA), such as PVA-based polymers, especially when modified or blended with other materials; Poly(ionic liquids), such as poly(ionic liquid) materials; conductive polymers, such as polyaniline, polypyrrole, and polythiophene, when doped with suitable acids; SPEEK (Sulfonated PolyEtherEtherKetone); ammonium-functionalized (e.g., quaternary ammonium-functionalized) polysulfones or polyethers or Polyarylene Ethers or Polyethylene or Polyvinyl Alcohol; Ammonium-functionalized (e.g., Quaternary ammonium-functionalized) poly(phenylene oxide) (PPO); ammonium-functionalized (e.g., quaternary ammonium-functionalized) poly(styrene); Imidazolium-functionalized polysulfones or polyethers or Polyarylene Ethers or Polyethylene or Polyvinyl Alcohol; Imidazolium-functionalized poly(phenylene oxide) (PPO); Imidazolium-functionalized poly(styrene); Phosphonium-functionalized polysulfones or polyethers or Polyarylene Ethers or Polyethylene or Polyvinyl Alcohol; Phosphonium-functionalized poly(phenylene oxide) (PPO); Phosphonium-functionalized poly(styrene); derivatives thereof; or combinations thereof.

In some examples, the ionomer comprises Polybenzimidazoles (PBIs); Poly(aryl ether sulfones), such as sulfonated poly(arylene ether sulfone)s; Poly(phenylene oxide) (PPO) and derivatives thereof, such as PPO polymers, such as sulfonated poly(phenylene oxide) (SPPO); Poly(ether imide); Poly(vinyl alcohol) (PVA), such as PVA-based polymers, especially when modified or blended with other materials; Poly(ionic liquids), such as poly(ionic liquid) materials; conductive polymers, such as polyaniline, polypyrrole, and polythiophene, when doped with suitable acids; Nafion; SPEEK (Sulfonated PolyEtherEtherKetone); derivatives thereof; or combinations thereof. In some examples, the ionomer comprises Polybenzimidazoles (PBIs); Poly(aryl ether sulfones), such as sulfonated poly(arylene ether sulfone)s; Poly(phenylene oxide) (PPO) and derivatives thereof, such as PPO polymers, such as sulfonated poly(phenylene oxide) (SPPO); Poly(ether imide); Poly(vinyl alcohol) (PVA), such as PVA-based polymers, especially when modified or blended with other materials; Poly(ionic liquids), such as poly(ionic liquid) materials; conductive polymers, such as polyaniline, polypyrrole, and polythiophene, when doped with suitable acids; SPEEK (Sulfonated PolyEtherEtherKetone); derivatives thereof; or combinations thereof.

In some examples, the ionomer is substantially free of perfluoroalkyl and polyfluoroalkyl substances (PFAS).

In some examples, the ionomer comprises a first ionomer and a second ionomer, wherein the first ionomer and the second ionomer are different, and wherein the two-dimensional material is infilled with the first ionomer and the support is infilled with the second ionomer.

In some examples, the membrane is substantially free of perfluoroalkyl and polyfluoroalkyl substances (PFAS).

In some examples, the membrane is an electrolysis membrane, an ion exchange membrane, a cation exchange membrane, a proton exchange membrane, an anion exchange membrane, or a combination thereof.

Also disclosed herein are methods of making any of the membranes disclosed herein.

Also disclosed herein are devices comprising any of the membranes disclosed herein. In some examples, the device comprises a fuel cell; a separation device, such as a hydrogen, deuterium, and/or tritium separation device; a purification device, such as a gas purification device ang/or a hydrogen purification device; a hydrogen generation device; an electrolysis device; an energy storage device, such as a battery; or a combination thereof.

Also disclosed herein are methods of use of any of the membranes disclosed herein and/or any of the devices disclosed herein. In some examples, the method comprises using the membrane or device in a fuel cell, in a gas purification, in an energy conversion process, in environmental remediation, in an isotope separation, in a detector, in a membrane electrode application, or a combination thereof.

In some examples, the method comprises using the membrane or device in a gas purification. In some examples, the gas purification comprises D₂-He separation; tritium-³He separation; separation of H, D, and/or T from a mixture of HD, TD, and/or HT; or a combination thereof. In some examples, the gas purification comprises hydrogen gas purification.

In some examples, the method comprises using the membrane or device in an isotope separation. In some examples, the isotope separation comprises hydrogen isotope separation. In some examples, the isotope separation comprises a ¹H-D separation.

In some examples, the method comprises using the membrane or device in a proton exchange application.

In some examples, the method comprises using the membrane or device in an application including, but not limited to, hydrogen technologies, such as electrolysis for H₂ production, fuel cells for transport, flow batteries for grid scale storage, seasonal energy storage, hydrogen purification, distributed hydrogen production, isotope separations, chemical production, etc.

In some examples, the method comprises using the membrane or device in hydrogen, deuterium, and tritium separation.

Additional advantages of the disclosed devices and methods will be set forth in part in the description which follows, and in part will be obvious from the description. The advantages of the disclosed devices and methods will be realized and attained by means of the elements and combinations particularly pointed out in the appended claims. It is to be understood that both the foregoing general description and the following detailed description are exemplary and explanatory only and are not restrictive of the disclosed devices and methods, as claimed.

The details of one or more embodiments of the invention are set forth in the accompanying drawings and the description below. Other features, objects, and advantages of the invention will be apparent from the description and drawings, and from the claims.

### BRIEF DESCRIPTION OF THE FIGURES

The accompanying figures, which are incorporated in and constitute a part of this specification, illustrate several aspects of the disclosure, and together with the description, serve to explain the principles of the disclosure.

FIG. 1A-FIG. 1E. Interfacing graphene with Nafion 211 and PTFE-reinforced Nafion thin films. FIG. 1A) Schematic of the graphene transfer process. A thin Nafion layer (˜700 nm thickness) is spin coated on to CVD graphene on Cu foil, the Cu etched, and the Nafion-graphene stack is scooped onto the desired Nafion support (N211˜25 μm, N10˜10 μm, N5˜5 μm thickness). FIG. 1B) Optical image of centimeter-scale graphene transferred to Nafion 211 (black lines are guide for eye indicating graphene edges). FIG. 1C) SEM cross-section image of the spin coated Nafion layer (dotted white lines are just a guide for the eye) on graphene on Cu foil. FIG. 1D) SEM image of graphene on the spin coated Nafion film shows wrinkles and minor bilayer patches characteristic to CVD graphene. Absence of ruptures or large/macroscopic damage to graphene suggests high quality transfer. FIG. 1E) Raman spectrum for graphene transferred on 300 nm SiO₂/Si wafer (orange) shows the characteristic 2D (˜2700 cm⁻¹) and G (˜1600 cm⁻¹) peaks as well as an absence of a D (˜1350 cm-1) peak indicating high quality of the as-synthesized CVD graphene. The G and 2D peaks observed in the Raman spectrum for graphene on spin coated Nafion (purple) compared to the control spin coated Nafion (blue) without peaks indicate successful transfer. Shift to higher wavenumbers for the G and 2D peak for graphene on spin coated Nafion could potentially originate from doping and/or strain of the graphene lattice [A49, A50].

FIG. 2A-FIG. 2H. Transport through CVD graphene interfaced with different thicknesses of Nafion (N5, 5 μm), (N10, 10 μm) and (N211, 25 μm) in a custom-built cell at room temperature. FIG. 2A) Proton transport is characterized by supplying humidified H₂ to either side of the membrane (see inset schematic, active arca ˜0.32 cm²) and measuring the current at applied potential for graphene (G) on N5 (N5|G), N10 (N10|G), and N211 (N211|G) as well G in an N10 sandwich (N10|G|N10) and for fast graphene (FG) on N10 (N10|G). FIG. 2B) Areal conductance is extracted from (FIG. 2A, inverse of slope of I-V). Error bars represent one standard deviation. FIG. 2C) H₂ crossover curves for graphene membranes and respective controls measured with humidified H₂ on one side and humidified N₂ on the other side [A73]. FIG. 2D) H₂ crossover current density extracted from the crossover curves in (FIG. 2C) at 400 mV (as per DOE standard). Downward pointing arrows with numbers on top indicate the percent reduction in H₂ crossover upon the addition of graphene compared to the respective controls. FIG. 2E) SEM image of graphene (G) domains prior to convergence, showing square graphene domains are obtained by controlling kinetics via growth parameters [A3]. FIG. 2F) SEM of continuous CVD graphene films on Cu foil after electrochemical etch test wherein etch pits form in Cu underneath defects in graphene. These etch pits are visible as bright white spots (indicated by yellow arrow) and the percentage arca of etch pits is indicated in yellow text (˜2.9%). FIG. 2G) SEM images of graphene domains with dendritic edges are obtained by faster growth (FG) with higher CH₄ to increase intrinsic defects on the lattice [A3]. FIG. 2H) SEM of FG after electrochemical etch test shows the higher percent of etch pit arca (˜10.9%), consistent with higher proton conductance and higher H₂ crossover for N10|FG compared to N10|G. Ambient pressure and temperature with equal flow of H₂ and/or N₂ to either side were used for all experiments.

FIG. 3A-FIG. 3F. Resistance model for graphene interfaced with Nafion of different thicknesses. FIG. 3A) Structure of membrane with one layer of graphene on Nafion showing larger tears and smaller defects in the graphene layer over the Nafion support. Resistance network models for graphene interfaced with FIG. 3B) one and FIG. 3C) two Nafion layers. Resistances of a single tear (R_{TAS}=resistance to access the tear, R_{TP}=resistance to pass through the tear, R_{TSN}=resistance to spread out from the tear, R_{TCN}=resistance to transport within the Nafion) and a single defect (R_{DAS}=resistance to access the defect, R_{DP}=resistance to pass through the defect, R_{DSN}=resistance to spread out from the defect, R_{DCN}=resistance to transport within the Nafion) are shown, though many of each occur in parallel. FIG. 3D) Illustration of spreading/constriction resistance effect for different Nafion layer thicknesses, showing effectively smaller conductance area for membranes that are thin compared to the tear spacing. FIG. 3E) Areal conductance and FIG. 3F) conductance ratio from model (bands) compared to experimental measurements (symbols, filled for graphene and open for controls in FIG. 3E). Shaded bands show fractional area occupied by tears ranging from 3.5% to 14%. Conductance measurements for N211|G membrane corresponds to a higher calculated tear fraction than the N10|G and N10|GIN10 membranes. Differences in interactions between the non-reinforced (N211) and reinforced (N5, N 10) Nafion supports can affect tear formation and impact proton conductance.

FIG. 4A-FIG. 4F. Performance of N211 and N211|G membranes as PEMs in a custom-built cell at room temperature. FIG. 4A) Schematic of the cell geometry (active arca ˜0.32 cm²) and optical image of the MEA with Pt/C-cloth electrodes (0.2 mg Pt/cm² loading). The cell is operated at room temperature, atmospheric pressure, with 40 sccm humidified H² supplied to anode and 120 sccm humidified air supplied to the cathode. FIG. 4B) Polarization curves and FIG. 4C) power density curves for the N211 control membrane before and after the break-in process showing an improvement in performance. FIG. 4D) Polarization curves for N211|G membrane when the orientation of the graphene is closer to the anode (H₂, green curve) or the cathode (Air, blue curve) (see inset schematic for orientation of the graphene membrane relative to the input gases). Only marginal differences are observed when membrane orientation is changed. FIG. 4E) polarization curves and FIG. 4F) power density curves for two separate N211 control membranes (open red and green circles) and N211|G membrane (closed green circles). Also, see FIG. 2C for H₂ crossover measurements for these membranes.

FIG. 5A-FIG. 5F. Performance of N211|G membranes operating in an H₂/air and H₂/O₂ fuel cell at 80° C. and different pressures (150 and 250 kPa-abs). FIG. 5A) Image of the N211|G sample prior to coating with catalyst ink, with graphene corners indicated by red lines. The active area (defined by the Kapton window) for the N211 and N211|G membranes is ˜1 cm². Polarization curves at FIG. 5B) 150 kPa-abs and FIG. 5C) 250 kPa-abs with H₂/air (diamond symbols) and H₂/O₂ (square symbols) at 80° C. and 100% RH. Similar performance is observed for both N211 and N211|G membranes under most conditions, with the N211|G membrane showing some deviation at higher pressure with O₂. FIG. 5D) Power density curves for N211 (purple, open symbols) and N211|G (red, filled symbols) membranes with H₂/air (diamond symbols) and H₂/O₂ (square symbols) geometries at 150 kPa-abs (filled in symbol, dotted lines) and 250 kPa-abs (open symbol, solid lines). FIG. 5E) Crossover curves for a N211 control membrane at 150 kPa-abs (purple dotted line) and 250 kPa-abs (purple solid line) and N211|G membrane at 150 kPa-abs (red dotted line) and 250 kPa-abs (red solid line). FIG. 5F) Extracted H₂ crossover current density at 0.4 V from (E), demonstrating the reduction of H₂ crossover with the addition of the graphene layer by ˜57% and 53% at 150 kPa-abs and 250 kPa-abs, respectively.

FIG. 6A-FIG. 6C. Impact of hot pressing on thin (˜5-10 μm), reinforced Nafion. FIG. 6A) Areal conductance of ˜10 μm thick PTFE reinforced Nafion film (N10) after hot press at different conditions (200 psi, 130-140° C., 1-3 min). Pt/C electrodes are added at 200 psi, 140° C., for 1-3 min (only electrodes added). Hot pressing N10 for 1 min at 140° C. at 200 psi does not impact areal conductance adversely. However, when the pressing time is increased to 3 min, at ˜140° C. or ˜130° C., the areal conductance drops significantly. FIG. 6B) Optical image of a N5 membrane (transparent film), with PTFE-coated fiberglass supports underneath (brown circle in image) and Pt/C electrodes (black circle in image) on top. The region between the PTFE support and the Pt/C is prone to tearing (dotted red circle). FIG. 6C) These tears from hot pressing are visible via optical microscope images.

FIG. 7A-FIG. 7B. Areal proton conductance for N211|G and N10|G membranes. FIG. 7A) Areal conductance for two separate N211|G membranes compared to the control membrane (without graphene). Both membranes show a reduction of ˜0.5-0.6 S cm⁻² in areal proton conductance from the addition of CVD graphene. FIG. 7B) Areal conductance measurements for two separate N10|G membranes compared to a single layer N10 control membrane (without graphene). For all N10|G membranes, the drop in conductance from the addition of graphene (˜2.8-3.1 S cm⁻²) is significantly higher than observed for N211|G membranes.

FIG. 8A-FIG. 8D. Ohmic resistance losses N211 and N211|G in the custom-built cell. FIG. 8A) Polarization curves and FIG. 8B) power density plots for N211 (open circles) and N211|G (closed circles) membranes after breaking-in (voltage cycling between 0.6 and 0.2 V until current stabilizes, ˜100 cycles) when at elevated temperature in a Scribner test station (850E Test System, 80° C., 160 kPa-abs, 125 sccm H₂, 500 sccm air, active area ˜1.96 cm²). Polarization curves are collected by voltage sweep from 0.2 V to OCV at intervals of 0.05 V and holding for 1 min at each step. The addition of graphene results in ˜13% drop in peak power density compared to the control. FIG. 8C) High frequency resistance (HFR) from electrochemical impedance spectroscopy (EIS) at 450 mV for the custom-built test cell and the Scribner test station demonstrates the miniature cell has higher ohmic resistance contributions. Note that for the Scribner station, the HFR is measured at each voltage step of the polarization curve but the value at 450 mV is used for comparison and HFR correction. FIG. 8D) HFR corrected polarization curves for the small and larger area N211|G membranes. While the miniature cell allows for quick characterization of successful graphene transfer to Nafion, limitations in performance arise due to the increased ohmic losses and low temperature operation. Note polarization curves were measured with a Scribner 850E test system at elevated temperature (80° C.). ˜2×2 cm² graphene area is transferred to N211 using the methods previously described and PTFE gaskets are used to limit the active area to ˜1.4×1.4 cm² (FIG. 8A inset).

FIG. 9. Typical CO stripping voltammogram for the cathode catalyst layer (CL) of graphene-free (N211) and graphene-coated (N211|G) MEAs at 80° C., 100% relative humidity (RH), and ambient pressure, recorded at a scan rate of 20 mV s⁻¹. The active area defined by the Kapton window for both N211 and N211|G membranes is approximately 1 cm².

FIG. 10A-FIG. 10D. iR-corrected Tafel plot comparison between graphene-free (N211) and graphene-coated (N211|G) MEAs under H₂/Air conditions at 80° C. and 100% relative humidity (RH) at two different pressures: (FIG. 10A) 150 kPa-abs, electrode arca-normalized current density; (FIG. 10B) 150 kPa-abs, Pt surface area-normalized current density; (FIG. 10C) 250 kPa-abs, electrode arca-normalized current density; (FIG. 10D) 250 kPa-abs, Pt surface area-normalized current density. The active area defined by the Kapton window for both N211 and N211|G membranes is approximately 1 cm².

FIG. 11A-FIG. 11B. iR-corrected and roughness factor-normalized polarization curve comparison under H₂/air conditions between graphene-free (N211) and graphene-coated (N211|G) MEAs at 80° C. and 100% relative humidity (RH), under (FIG. 11A) 150 kPa-abs and (FIG. 11B) 250 kPa-abs backpressure conditions. The active area defined by the Kapton window for both N211 and N211|G membranes is ˜1 cm².

FIG. 12A-FIG. 12D. iR-corrected Tafel plot comparison between graphene-free (N211) and graphene-coated (N211|G) MEAs under H₂/O₂ conditions at 80° C. and 100% relative humidity (RH) at two different pressures: (FIG. 12A) 150 kPa-abs, electrode arca-normalized current density; (FIG. 12B) 150 kPa-abs, Pt surface area-normalized current density; (FIG. 12C) 250 kPa-abs, electrode area-normalized current density; (FIG. 12D) 250 kPa-abs, Pt surface area-normalized current density. The active area defined by the Kapton window for both N211 and N211|G membranes is ˜1 cm².

FIG. 13A-FIG. 13J. Graphene transfer and proton transport membrane (PEM) fabrication using spin+scoop, cold press, and hot press methods. Schematics of graphene transfer to 25 μm thick Nafion 211 (N211) using (FIG. 13A) spin-coat and scoop (referred to as spin+scoop), (FIG. 13B) cast and cold press (referred to as cold press), and (FIG. 13C) hot press methods. (FIG. 13D) Schematic of the final hot press step used to add the second N211 layer and optical image of the N211|G|N211 sandwich membrane. Black lines serve as guides to the eye and indicate graphene edges. Representative SEM images of graphene transferred to N211 via (FIG. 13E) spin+scoop, (FIG. 13F) cold press, and (FIG. 13G) hot press methods and (FIG. 13I) calculated percent defect area via image analysis using ImageJ software. Error bars represent one standard deviation. Common defects observed for each transfer method are circled. (FIG. 13H) Cross section SEM images of the spin+scoop Nafion layer coated on graphene on Cu foil, showing the thickness of the spin-coated Nafion layer is ˜700 nm. (FIG. 13J) Raman spectra for monolayer graphene transferred on to 300 nm SiO₂/Si wafer (red curve) indicates high quality with the absence of a D-peak (˜1350 cm⁻¹). The presence of G (˜1600 cm⁻¹) and 2D (˜2700 cm⁻¹) peaks in the Raman spectra of graphene transferred on to Nafion (light blue curve) in comparison to bare Nafion (dark blue curve) demonstrates successful transfer.

FIG. 14A-FIG. 14K. Areal proton conductance of N211|N211 and N211|G|N211 PEMs. (FIG. 14A) Schematic of cell and gas flow used for measurement of proton conductance. (FIG. 14B) I-V curves for Nafion sandwich membrane (N211|N211) without exposure to Cu or APS (No Cu/APS, black line), sandwich membrane which was pressed against bare Cu foil and etched in 0.2 M APS before (Hot press Cu, green line) and after soaking in 0.1 M HCl (Hot press Cu & HCl float, red line). (FIG. 14C) Areal conductance extracted from I-V curves in (FIG. 14B). An additional sandwich membrane where Nafion 211 was floated on APS solution (APS float, blue) without any Cu present, showing that ammonium ion contamination can also lead to conductance reduction. Areal conductance for N211|N211 (controls) and N211|G|N211 PEMs (FIG. 14D) as prepared and (FIG. 14E) after soaking in 0.1 M HCl. Note one of the N211|N211 control membranes was not exposed to Cu or APS solution [211|211 (no Cu/APS), black outline]. For all other membranes, Nafion is contacted with annealed bare Cu foil via hot press [211|211 (hot press Cu), green outline] or cold press [211|211 (cold press Cu), purple outline] or with graphene on Cu using hot press [211|G|211, green, filled], cold press (purple, filled), spin+scoop (yellow, filled) and the Cu is subsequently etched using 0.2 M ammonium persulfate (APS) solution. A reduced areal proton conductance is seen for all membranes (except the control not contacted with Cu or APS [N211|N211 (no Cu/APS)]. After soaking in 0.1 M HCl the proton conductance increases for all hot press and cold press membranes. Such a trend is not observed with the spin+scoop sandwich membrane as well as the N211|N211 (no Cu/APS) control membrane (black outline) and areal proton conductance remains relatively unchanged. (FIG. 14F) Ratios of proton conductance after soaking in 0.1 M HCl to conductance as prepared illustrate the change in areal proton conductance. Comparison of SEM images (FIG. 14G) before and (FIG. 14H) after soaking in HCl do not show an increase in cracks/tears (<3%) suggesting the acid soak increases areal proton conductivity without damaging the graphene significantly. Schematics of (FIG. 14I) exchange of ions in Nafion polymer chains, (FIG. 14J) the Cu etching process, and (FIG. 14K) the reservoir effect proposed to explain the observed change in areal proton conductance. Notably, the ˜700 nm thick Nafion film formed during the spin scoop process represents as significantly smaller reservoir for uptake of Cu or ammonium ions compared to the ˜25 μm thick Nafion 211 film.

FIG. 15A-FIG. 15D. Ion exchange capacity (IEC) for membranes with and without exposure to Cu and ammonium persulfate (APS). (FIG. 15A) Schematic of IEC experimental method wherein an H⁺ form Nafion sandwich (N212|N212) is soaked in 0.1 M KCl solution and the H⁺ in the membrane is replaced with K⁺ from solution, thereby decreasing the pH. The concentration of H⁺ in solution (from the Nafion) is determined by titration and used to determine IEC. (FIG. 15B) Image of the aliquots of KCl solution after Nafion soaking at different stages of the titration process. When Brothymal blue (BTB) is added to the aliquot, the color starts as yellow (acidic). Once neutralized with 0.01 M NaOH, the solution turns to teal. Additional NaOH will make the solution light blue (basic). The volume of NaOH to neutralize the solution is used in the IEC calculation (see methods). (FIG. 15C) Schematic showing the same experimental method for IEC determination but after graphene has been added (N212|G|N212), which introduces contamination from the etching process (Cu and ammonium ions) and displaces a fraction of H⁺. (FIG. 15D) The calculated IEC for Nafion control membrane [212|212 (no Cu/APS, gray bar)] compared to the graphene membrane [N212|G|N212 (with Cu/APS)]. The lower IEC for the graphene membrane is confirmation of contamination/ion exchange in the Nafion during the etching process.

FIG. 16A-FIG. 16F. Performance of PEMs in fuel cells. Schematic of experiments for (FIG. 16A) H₂ crossover and (FIG. 16B) H₂: Air fuel cell performance. The N211|G|N211 sandwich is scaled in the cell with rubber o-rings and electrical contact made with the Pt/C electrodes and Ni foam. The graphene acts as a barrier between the Nafion layers, limiting H₂ crossover but permeating protons and allow functionality in a fuel cell. (FIG. 16C) H₂ crossover curves for the fabricated membranes shows reduction upon incorporation of graphene into the PEMs. (FIG. 16D) The H₂ crossover current density for each membrane is determined from the current density at 400 mV. The reduction in H₂ crossover is comparable to previous reports of H₂ crossover reduction with single layer graphene [B11]. (FIG. 16E) Polarization I-V curves (left axis, solid lines) and power density curves (right axis, dotted lines) for each membrane in a custom-built H₂/Air fuel cell. (FIG. 16F) Maximum power density for each membrane extracted from FIG. 16C. Moderate drops in power density are observed upon the addition of graphene.

FIG. 17. Raman spectra of graphene transferred to N211 via hot press method with an extended scan range. Additional characteristic Nafion peaks are observed at ˜730 cm⁻¹, ˜810 cm⁻¹, ˜980 cm⁻¹ and 1060 cm⁻¹ (orange arrows). Peaks at ˜1580 cm⁻¹ and ˜2690 cm⁻¹ are attributed to the G and 2D peaks of graphene, respectively. Dotted lines serve as a guide to the eye.

FIG. 18A-FIG. 18D. Quantifying defects from hot press transfer method. FIG. 18A) SEM image of graphene transferred to Nafion 211 via 140° C. hot press transfer, showing defects along wrinkles. FIG. 18B) The same image as in FIG. 18A after thresholding in ImageJ is used to estimate the average defective area. FIG. 18C) Plot of the calculated percent defect area as determined from 4 different SEM images and the average (Red Bar). The average defect area of ˜3.5% is comparable to other reports in literature [C1, C2]. FIG. 18D) Image of graphene on Cu foil after oxidization in air at 220° C. for 10 minutes. The dark orange lines indicate oxidized area underneath defects in graphene on Cu foil. The features observed here are similar to graphene transferred to Nafion using hot press transfer.

FIG. 19A-FIG. 19C. Defects observed for cold press transfers. Graphene transferred to N211 via casting a thin layer of Nafion on G+Cu, then pressing at room temperature to N211. SEM of the transferred graphene shows areas with FIG. 19A) small, isolated defects, FIG. 19B) small ruptures, and FIG. 19C) large ruptures. The ruptures occur due to poor contact between the N211 and the graphene. The regions of large ruptures are sparsely occurring, with most of the defects observed being small defects and ruptures.

FIG. 20A-FIG. 20B. EDS of N211|G before HCl soaking. Graphene was transferred to N211 via hot pressing and EDS collected of the FIG. 20A) surface and FIG. 20B) after inducing deformations to the surface. For the surface probe measurements, the magnification was kept low (<800×) to reduce charging/damage to the sample. Upon increasing the magnification (>800×), deformation of the sample was observed (inset of FIG. 20B). For both measurements, the La peak for Cu at ˜0.93 keV is visible but only when the sample is undergoing beam-induced damage is the Ka peak at ˜8.04 keV visible suggesting the presence of Cu within the Nafion and not being limited to only the surface.

FIG. 21A-FIG. 21D. Comparison of sandwich membranes to single layer N211. FIG. 21A) H₂ crossover current density as a function of potential for N211, N211|N211, and N211|G|N211 (spin+scoop) membranes. FIG. 21B) Crossover current density extracted from (FIG. 21A) for each membrane at 0.4V. FIG. 21C) Areal proton conductance measured by supplying H₂ to both sides of the membrane. FIG. 21D) I-V curves (left axis, solid lines) and power density curves (right axis, dotted lines) for each membrane in the custom-built H₂/Air fuel cell at atmospheric pressure and room temperature.

FIG. 22. Stability of N211|G|N211 (spin+scoop) membranes when operated in the custom-built H₂/Air fuel cell at beginning of life. Three polarization curves were collected 10 minutes apart for a N211|G|N211 (spin+scoop) membrane. The average at each point is calculated and plotted here along with respective standard deviation in current density, showing the stability of the membrane over the course of the measurements. All measurements were completed at room temperature and atmospheric pressure.

### DETAILED DESCRIPTION

The devices and methods described herein may be understood more readily by reference to the following detailed description of specific aspects of the disclosed subject matter and the Examples included therein.

Before the present devices and methods are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

### General Definitions

In this specification and in the claims that follow, reference will be made to a number of terms, which shall be defined to have the following meanings.

Throughout the description and claims of this specification the word “comprise” and other forms of the word, such as “comprising” and “comprises,” means including but not limited to, and is not intended to exclude, for example, other additives, components, integers, or steps. As used in the specification and in the claims, the term “comprising” can include the aspects “consisting of” and “consisting essentially of.”

As used in the description and the appended claims, the singular forms “a,” “an,” and “the” include plural referents unless the context clearly dictates otherwise. Thus, for example, reference to “a composition” includes mixtures of two or more such compositions, reference to “an agent” includes mixtures of two or more such agents, reference to “the component” includes mixtures of two or more such components, and the like.

“Optional” or “optionally” means that the subsequently described event or circumstance can or cannot occur, and that the description includes instances where the event or circumstance occurs and instances where it does not.

Ranges can be expressed herein as from “about” one particular value, and/or to “about” another particular value. By “about” is meant within 5% of the value, e.g., within 4, 3, 2, or 1% of the value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, a description of a range such as from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 2, 2.7, 3, 4, 5, 5.3, 6 and any whole and partial increments therebetween. This applies regardless of the breadth of the range.

When the specific values are disclosed between two end values, it is understood that these end values can also be included.

For the terms “for example” and “such as,” and grammatical equivalences thereof, the phrase “and without limitation” is understood to follow unless explicitly stated otherwise. It is further understood that these phrases are not used in a restrictive sense, but for explanatory purposes. “Exemplary” means “an example of” and is not intended to convey an indication of a preferred or ideal embodiment.

It is understood that throughout this specification the identifiers “first” and “second” are used solely to aid in distinguishing the various components and steps of the disclosed subject matter. The identifiers “first” and “second” are not intended to imply any particular order, amount, preference, or importance to the components or steps modified by these terms.

As used herein, the term “and/or” includes any and all combinations of one or more of the associated listed items.

As used herein, the term “substantially” means that the subsequently described event or circumstance completely occurs or that the subsequently described event or circumstance generally, typically, or approximately occurs.

Still further, the term “substantially” can, in some aspects, refer to at least about 80%, at least about 85%, at least about 90%, at least about 91%, at least about 92%, at least about 93%, at least about 94%, at least about 95%, at least about 96%, at least about 97%, at least about 98%, at least about 99%, or about 100% of the stated property, component, composition, or other condition for which substantially is used to characterize or otherwise quantify an amount.

In other aspects, as used herein, the term “substantially free,” when used in the context of a composition or component of a composition that is substantially absent, is intended to refer to an amount that is then about 1% by weight, e.g., less than about 0.5% by weight, less than about 0.1% by weight, less than about 0.05% by weight, or less than about 0.01% by weight of the stated material, based on the total weight of the composition.

The expressions “ambient temperature” and “room temperature” as used herein are understood in the art and refer generally to a temperature from about 20° C. to about 35° C.

References in the specification and concluding claims to parts by weight of a particular element or component in a composition denotes the weight relationship between the element or component and any other elements or components in the composition or article for which a part by weight is expressed. Thus, in a mixture containing 2 parts by weight of component X and 5 parts by weight of component Y, components X and Y are present at a weight ratio of 2:5 and are present in such a ratio regardless of whether additional components are contained in the mixture.

A weight percent (wt. %) of a component, unless specifically stated to the contrary, is based on the total weight of the formulation or composition in which the component is included.

A volume percent (vol %) of a component, unless specifically stated to the contrary, is based on the total volume of the formulation or composition in which the component is included.

It is understood that the term “salt,” as used herein, refers to a chemical compound that can be formed form a reaction between an acid and a base. It is understood that the term “salt,” as used herein, encompasses both inorganic and organic salts capable of providing the desired properties to the composition. In still further aspects, a cation of the disclosed herein salts is a metal cation.

While aspects of the present invention can be described and claimed in a particular statutory class, such as the system statutory class, this is for convenience only and one of ordinary skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is in no way intended that an order be inferred in any respect. This holds for any possible non-express basis for interpretation, including matters of logic with respect to the arrangement of steps or operational flow, plain meaning derived from grammatical organization or punctuation, or the number or type of aspects described in the specification.

Unless otherwise defined, all technical and scientific terms used herein have the same meaning as commonly understood by one of ordinary skill in the art to which this invention belongs.

As used herein, “molecular weight” refers to number average molecular weight as measured by ¹H NMR spectroscopy, unless indicated otherwise.

The organic moieties mentioned when defining variable positions within the general formulae described herein (e.g., the term “halogen”) are collective terms for the individual substituents encompassed by the organic moiety. The prefix Cₙ-Cₘ preceding a group or moiety indicates, in each case, the possible number of carbon atoms in the group or moiety that follows.

The term “ion,” as used herein, refers to any molecule, portion of a molecule, cluster of molecules, molecular complex, moiety, or atom that contains a charge (positive, negative, or both at the same time within one molecule, cluster of molecules, molecular complex, or moiety (e.g., zwitterions)) or that can be made to contain a charge. Methods for producing a charge in a molecule, portion of a molecule, cluster of molecules, molecular complex, moiety, or atom are disclosed herein and can be accomplished by methods known in the art, e.g., protonation, deprotonation, oxidation, reduction, alkylation, acetylation, esterification, de-esterification, hydrolysis, etc.

The term “anion” is a type of ion and is included within the meaning of the term “ion.” An “anion” is any molecule, portion of a molecule (e.g., zwitterion), cluster of molecules, molecular complex, moiety, or atom that contains a net negative charge or that can be made to contain a net negative charge. The term “anion precursor” is used herein to specifically refer to a molecule that can be converted to an anion via a chemical reaction (e.g., deprotonation).

The term “cation” is a type of ion and is included within the meaning of the term “ion.” A “cation” is any molecule, portion of a molecule (e.g., zwitterion), cluster of molecules, molecular complex, moiety, or atom, that contains a net positive charge or that can be made to contain a net positive charge. The term “cation precursor” is used herein to specifically refer to a molecule that can be converted to a cation via a chemical reaction (e.g., protonation or alkylation).

“Zwitterionic” or “zwitterion” as used herein refers to a neutral molecule with a positive (or cationic) and a negative (or anionic) electrical charge at different locations within the same molecule.

As used herein the term “plurality” means 2 or more (e.g., 3 or more; 4 or more; 5 or more; 10 or more; 15 or more; 20 or more; 25 or more; 30 or more; 40 or more; 50 or more; 75 or more; 100 or more; 150 or more; 200 or more; 250 or more; 300 or more; 400 or more; 500 or more; 750 or more; 1000 or more; 1500 or more; 2000 or more; 2500 or more; 3000 or more; 4000 or more; or 5000 or more).

### Membranes, Devices, and Methods of Making and Use thereof

Disclosed herein are membranes, devices, and methods of making and use thereof.

For example, disclosed herein are membranes comprising: a two-dimensional (2D) material, a support, and an ionomer, wherein the two-dimensional (2D) material disposed on the support, thereby forming a construct, wherein the two-dimensional material is infilled with the ionomer, the support is infilled with the ionomer, the construct is infilled with the ionomer, or a combination thereof, thereby forming the membrane.

The two-dimensional material can comprise any suitable material. Examples of two-dimensional materials are described, for example, by Giem et al., Nature, 2013, 499, 419-425, which is hereby incorporated herein by reference for its description of two-dimensional materials. The two-dimensional material can, for example, comprise graphene, hexagonal boron nitride (h-BN), a transition metal dichalcogenide (e.g., porous TMDC), a covalent organic framework, a metal organic framework, ultra-thin oxides, mica, graphdyene like periodic porous structures, layered clays, mineral clays, or a combination thereof. In some examples, the two-dimensional material comprises graphene, hexagonal boron nitride (h-BN), or a combination thereof. In some examples, the two-dimensional material comprises graphene. In some examples, the two-dimensional material comprises graphene oxide. In some examples, the two-dimensional material comprises h-BN.

In some examples, the two-dimensional material comprises a transition metal dichalcogenide. As used herein, a “transition metal dichalcogenide” refers to a compound comprising a transition metal and two chalcogen atoms. As used herein, a “transition metal” refers to any element from groups 3-12, such as Sc, Ti, V, Cr, Mn, Fe, Co, Ni, Cu, Zn, Y, Zr, Nb, Mo, Tc, Ru, Rh, Pd, Ag, Cd, La, Hf, Ta, W, Re, Os, Ir, Pt, Au, Hg, and Ac. As used herein a “chalcogen” refers to any element from group 16, such as oxygen, sulfur, selenium, tellurium, and polonium. As such, transition metal chalcogenides can include transition metal oxides, transition metal sulfides, and transition metal selenides, among others. For example, the transition metal dichalcogenide can comprise MoS₂, WS₂, MoSc₂, WSc₂, MoTc₂, WTc₂, ZrS₂, ZrSc₂, NbSc₂, NbS₂, TaS₂, TiS₂, NiSe₂, Bi₂Sc₃, or a combination thereof. In some examples, the transition metal dichalcogenide can comprise MoS₂, WS₂, MoSc₂, WSc₂, MoTe₂, WTc₂, or a combination thereof. In some examples, the transition metal dichalcogenide comprises MoS₂.

In some examples, the two-dimensional material has an average thickness of 0.3 nanometers (nm) or more (e.g., 0.5 nm or more, 1 nm or more, 1.5 nm or more, 2 nm or more, 2.5 nm or more, 3 nm or more, 3.5 nm or more, 4 nm or more, 4.5 nm or more, 5 nm or more, 6 nm or more, 7 nm or more, 8 nm or more, 9 nm or more, 10 nm or more, 15 nm or more, 20 nm or more, 25 nm or more, 30 nm or more, 35 nm or more, 40 nm or more, 45 nm or more, 50 nm or more, 60 nm or more, 70 nm or more, 80 nm or more, or 90 nm or more). In some examples, the two-dimensional material has an average thickness of 100 nm or less (e.g., 90 nm or less, 80 nm or less, 70 nm or less, 60 nm or less, 50 nm or less, 45 nm or less, 40 nm or less, 35 nm or less, 30 nm or less, 25 nm or less, 20 nm or less, 15 nm or less, 10 nm or less, 9 nm or less, 8 nm or less, 7 nm or less, 6 nm or less, 5 nm or less, 4.5 nm or less, 4 nm or less, 3.5 nm or less, 3 nm or less, 2.5 nm or less, 2 nm or less, 1.5 nm or less, 1 nm or less, or 0.5 nm or less). The average thickness of the two-dimensional material can range from any of the minimum values described above to any of the maximum values described above. For example, the two-dimensional material can have an average thickness of from 0.3 to 100 nm (e.g., from 0.3 to 50 nm, from 50 to 100 nm, from 0.3 to 20 nm, from 20 to 40 nm, from 40 to 60 nm, from 60 to 80 nm, from 80 to 100 nm, from 0.3 to 80 nm, from 0.3 to 60 nm, from 0.3 to 40 nm, from 0.3 to 20 nm, from 0.3 to 10 nm, from 0.3 to 5 nm, from 1 nm to 100 nm, from 10 nm to 100 nm, from 20 nm to 100 nm, from 40 nm to 100 nm, from 60 nm to 100 nm, from 0.5 to 95 nm, from 1 nm to 90 nm, or from 10 to 80 nm).

The two-dimensional material can have any suitable lateral dimension, for example the desired lateral dimension can be selected in view of the desired use of the membrane.

In some examples, the 2D material is permeated by one or more pores, one or more defects, or a combination thereof. Defects include, but are not limited to, pentagon-heptagon rings, Stone Wales defects, missing atoms (e.g., from 1 to 100 missing atoms), etc. In some examples, at least a portion of the one or more pores, the one or more defects, or a combination thereof in the 2D material are infilled by the ionomer.

The support can comprise any suitable material. In some examples, the support comprises polyether sulfone (PES), polystyrene (PS), polyvinylidene fluoride (PVDF), polyethylene terephthalate (PET), polycarbonate and polycarbonate track etch supports (PCTE), polyethylene (PE),high density polyethylene (HDPE), Polyester, Poly imide, Teflon, Nylon, Rayon, electrospun fibers, woven cloths or metal meshes, anodic alumina (AAO), porous silicon, derivatives thereof, or combinations thereof.

In some examples, the support has no pores (e.g., wherein the support is dense).

In some examples, the support is porous in that the support is permeated by one or more pores, one or more defects, or a combination thereof. In some examples, at least a portion of the one or more pores, the one or more defects, or a combination thereof in the porous support are infilled by the ionomer.

The ionomer can comprise any suitable ionomer. In some examples, the ionomer comprises a proton conducting polymer, an anion conducting polymer, or a combination thereof. In some examples, the ionomer comprises a proton conducting polymer. In some examples, the ionomer comprises an anion conducting polymer.

In some examples, the ionomer comprises Polybenzimidazoles (PBIs); Poly(aryl ether sulfones), such as sulfonated poly(arylene ether sulfone)s; Poly(phenylene oxide) (PPO) and derivatives thereof, such as PPO polymers, such as sulfonated poly(phenylene oxide) (SPPO); Poly(ether imide); Poly(vinyl alcohol) (PVA), such as PVA-based polymers, especially when modified or blended with other materials; Poly(ionic liquids), such as poly(ionic liquid) materials; conductive polymers, such as polyaniline, polypyrrole, and polythiophene, when doped with suitable acids; Nafion; SPEEK (Sulfonated PolyEtherEtherKetone); ammonium-functionalized (e.g., quaternary ammonium-functionalized) polysulfones or polyethers or Polyarylene Ethers or Polyethylene or Polyvinyl Alcohol; Ammonium-functionalized (e.g., Quaternary ammonium-functionalized) poly(phenylene oxide) (PPO); ammonium-functionalized (e.g., quaternary ammonium-functionalized) poly(styrene); Imidazolium-functionalized polysulfones or polyethers or Polyarylene Ethers or Polyethylene or Polyvinyl Alcohol; Imidazolium-functionalized poly(phenylene oxide) (PPO); Imidazolium-functionalized poly(styrene); Phosphonium-functionalized polysulfones or polyethers or Polyarylene Ethers or Polyethylene or Polyvinyl Alcohol; Phosphonium-functionalized poly(phenylene oxide) (PPO); Phosphonium-functionalized poly(styrene); derivatives thereof; or combinations thereof. In some examples, the ionomer comprises Polybenzimidazoles (PBIs); Poly(aryl ether sulfones), such as sulfonated poly(arylene ether sulfone)s; Poly(phenylene oxide) (PPO) and derivatives thereof, such as PPO polymers, such as sulfonated poly(phenylene oxide) (SPPO); Poly(ether imide); Poly(vinyl alcohol) (PVA), such as PVA-based polymers, especially when modified or blended with other materials; Poly(ionic liquids), such as poly(ionic liquid) materials; conductive polymers, such as polyaniline, polypyrrole, and polythiophene, when doped with suitable acids; SPEEK (Sulfonated PolyEtherEtherKetone); ammonium-functionalized (e.g., quaternary ammonium-functionalized) polysulfones or polyethers or Polyarylene Ethers or Polyethylene or Polyvinyl Alcohol; Ammonium-functionalized (e.g., Quaternary ammonium-functionalized) poly(phenylene oxide) (PPO); ammonium-functionalized (e.g., quaternary ammonium-functionalized) poly(styrene); Imidazolium-functionalized polysulfones or polyethers or Polyarylene Ethers or Polyethylene or Polyvinyl Alcohol; Imidazolium-functionalized poly(phenylene oxide) (PPO); Imidazolium-functionalized poly(styrene); Phosphonium-functionalized polysulfones or polyethers or Polyarylene Ethers or Polyethylene or Polyvinyl Alcohol; Phosphonium-functionalized poly(phenylene oxide) (PPO); Phosphonium-functionalized poly(styrene); derivatives thereof; or combinations thereof.

In some examples, the ionomer comprises Polybenzimidazoles (PBIs); Poly(aryl ether sulfones), such as sulfonated poly(arylene ether sulfone)s; Poly(phenylene oxide) (PPO) and derivatives thereof, such as PPO polymers, such as sulfonated poly(phenylene oxide) (SPPO); Poly(ether imide); Poly(vinyl alcohol) (PVA), such as PVA-based polymers, especially when modified or blended with other materials; Poly(ionic liquids), such as poly(ionic liquid) materials; conductive polymers, such as polyaniline, polypyrrole, and polythiophene, when doped with suitable acids; Nafion; SPEEK (Sulfonated PolyEtherEtherKetone); derivatives thereof; or combinations thereof. In some examples, the ionomer comprises Polybenzimidazoles (PBIs); Poly(aryl ether sulfones), such as sulfonated poly(arylene ether sulfone)s; Poly(phenylene oxide) (PPO) and derivatives thereof, such as PPO polymers, such as sulfonated poly(phenylene oxide) (SPPO); Poly(ether imide); Poly(vinyl alcohol) (PVA), such as PVA-based polymers, especially when modified or blended with other materials; Poly(ionic liquids), such as poly(ionic liquid) materials; conductive polymers, such as polyaniline, polypyrrole, and polythiophene, when doped with suitable acids; SPEEK (Sulfonated PolyEtherEtherKetone); derivatives thereof; or combinations thereof.

In some examples, the ionomer is substantially free of perfluoroalkyl and polyfluoroalkyl substances (PFAS).

In some examples, the ionomer comprises a first ionomer and a second ionomer, wherein the first ionomer and the second ionomer are different, and wherein the two-dimensional material is infilled with the first ionomer and the support is infilled with the second ionomer. The first ionomer and the second ionomer can each independently comprise any of the ionomers described herein.

In some examples, the membrane is substantially free of perfluoroalkyl and polyfluoroalkyl substances (PFAS).

In some examples, the membrane is an electrolysis membrane, an ion exchange membrane, a cation exchange membrane, a proton exchange membrane, an anion exchange membrane, or a combination thereof.

Also disclosed herein are methods of making any of the membranes disclosed herein. For example, the methods can comprise disposing the 2D material on the support to form the construct, and then infilling the construct with the ionomer.

Also disclosed herein are devices comprising any of the membranes disclosed herein. For example, the device can comprise a fuel cell; a separation device, such as a hydrogen, deuterium, and/or tritium separation device; a purification device, such as a gas purification device ang/or a hydrogen purification device; a hydrogen generation device; an electrolysis device; an energy storage device, such as a battery; or a combination thereof.

Also disclosed herein are methods of use of any of the membranes disclosed herein or any of the devices disclosed herein.

For example, the method can comprise using the membrane or device in a fuel cell, in a gas purification, in an energy conversion process, in environmental remediation, in an isotope separation, in a detector, in a membrane electrode application, or a combination thereof.

In some examples, the method comprises using the membrane or device in a gas purification. In some examples, the gas purification comprises D₂-He separation; tritium-³He separation; separation of H, D, and/or T from a mixture of HD, TD, and/or HT; or a combination thereof. In some examples, the gas purification comprises hydrogen gas purification.

In some examples, wherein the method comprises using the membrane or device in an isotope separation. In some examples, the isotope separation comprises hydrogen isotope separation. In some examples, the isotope separation comprises a ¹H-D separation. In some examples, the isotope separation comprises hydrogen, deuterium, and tritium separation.

In some examples, the method comprises using the membrane or device in a proton exchange application.

In some examples, the method comprises using the membrane or device in an application including, but not limited to, hydrogen technologies, such as electrolysis for H₂ production, fuel cells for transport, flow batteries for grid scale storage, seasonal energy storage, hydrogen purification, distributed hydrogen production, isotope separations, chemical production, etc.

In some examples, the method comprises using the membrane or device in hydrogen, deuterium, and tritium separation.

A number of embodiments of the invention have been described. Nevertheless, it will be understood that various modifications may be made without departing from the spirit and scope of the invention. Accordingly, other embodiments are within the scope of the following claims.

The examples below are intended to further illustrate certain aspects of the systems and methods described herein, and are not intended to limit the scope of the claims.

### EXAMPLES

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present invention which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of measurement conditions, e.g., component concentrations, temperatures, pressures and other measurement ranges and conditions that can be used to optimize the described process.

### Example 1

### New Architecture for Proton Exchange Membranes

Described herein are new kinds of proton exchange membranes with no PFAS. PFAS regulations will mean state-of-art proton conducting polymers such as Nafion can no longer be used.

However, non-PFAS free polymers have too much hydrogen or cation cross over degrading efficiency over long term operations.

The approach described herein changes the whole architecture-the 2D layers helps minimize cross over and is supported on porous substate which is then infilled with proton conducting polymer to get the protons to and from the 2D layer.

For example, expanded PTFE can be used within Nafion to provide it more strength and minimize swelling, but described herein is a totally different approach with 2D materials.

Polyether sulfone (PES), polystyrene (PS), polyvinylidene fluoride (PVDF), polyethylene terephthalate (PET), polycarbonate and polycarbonate track etch supports (PCTE), polyethylene (PE), high density polyethylene (HDPE), Polyester, Poly imide, Teflon, Nylon, Rayon, electrospun fibers, woven cloths or metal meshes, anodic alumina (AAO), porous silicon, etc. can be used as supports for 2D layers and then in-filled with proton conducting polymers.

Described herein are methods and devices where PFAS free proton conducting polymers are infilled into porous polymers supporting 2D materials. For example, an expanded PTFE substrate infilled with Nafion can be used for proton exchange membrane with the 2D layers.

Porous supports can be made of PES, PS, PVDF, PET, PCTE, PE, HDPE, Polyester, Poly imide, Teflon, Nylon, Rayon, electrospun fibers, woven cloths or metal meshes, AAO, porous silicon, etc. for applications in neutral, acidic and basic environments as well as organic solvent environments.

2D materials can be graphene, h-BN and GO with and without pores, porous TMDC, covalent organic frameworks, metal organic frameworks, graphdyene like periodic porous structures, layered clays, mineral clays, etc. with thicknesses from 1-100 nm.

Proton conducting polymer can be: Polybenzimidazoles (PBIs); Poly(aryl ether sulfones): sulfonated poly(arylene ether sulfone)s; Poly(phenylene oxide) (PPO) derivatives: PPO polymers, such as sulfonated poly(phenylene oxide) (SPPO); Poly(ether imide); Poly(vinyl alcohol) (PVA): PVA-based polymers, especially when modified or blended with other materials; Poly(ionic liquids): poly(ionic liquid) materials; Conductive polymers: polyaniline, polypyrrole, and polythiophene, when doped with suitable acids; Nafion—Nafion has PFAS in it; SPEEK (Sulfonated PolyEtherEtherKetone); derivatives thereof; or combinations thereof.

Applications include, but are not limited to, hydrogen technologies, such as electrolysis for H₂ production, fuel cells for transport, flow batteries for grid scale storage, seasonal energy storage, hydrogen purification, distributed hydrogen production, isotope separations, chemical production, etc.

### Example 2

Applications include fuel cells, electrolysis membranes and both cation and anion exchange membranes.

For example, an expanded PTFE substrate infilled with Nafion can be used as a proton exchange membrane with the 2D layers.

For example PES, PS, PVDF, PET, PCTE, PE, HDPE, Polyester, Poly imide, Teflon, Nylon, Rayon, electrospun fibers, woven cloths or metal meshes, AAO, porous silicon, etc., can be used as supports for 2D layers and then in-filled with proton conducting polymers.

The membranes described herein comprise:
A. A porous supports: for example made of PES, PS, PVDF, PET, PCTE, PE, HDPE, Polyester, Poly imide, Teflon, Nylon, Rayon, electrospun fibers, woven cloths or metal meshes, AAO, porous silicon, etc. for applications in neutral, acidic and basic environments as well as organic solvent environments.
B. 2D material: for example, graphene, h-BN and GO with and without pores, porous TMDC, covalent organic frameworks, metal organic frameworks, graphdyene like periodic porous structures, layered clays, mineral clays, etc. with thicknesses from 1-100 nm.
C. An Ionomer, such as proton and anion conducting polymers, including:
1. Polybenzimidazoles (PBIs):
2. Poly(aryl ether sulfones): sulfonated poly(arylene ether sulfone)s
3. Poly(phenylene oxide) (PPO) derivatives: PPO polymers, such as sulfonated poly(phenylene oxide) (SPPO)
4. Poly(ether imide)
5. Poly(vinyl alcohol) (PVA): PVA-based polymers, especially when modified or blended with other materials
6. Poly(ionic liquids): poly(ionic liquid) materials
7. Conductive polymers: polyaniline, polypyrrole, and polythiophene, when doped with suitable acids.
8. Nafion
9. SPEEK (Sulfonated PolyEtherEtherKetone)
10. Quaternary ammonium-functionalized polysulfones or polyethers or Polyarylene Ethers or Polyethylene or Polyvinyl Alcohol or and other ammonium functionalized polysulfones or polyether or Polyarylene Ethers or Polyethylene or Polyvinyl Alcohol
11. Quaternary ammonium-functionalized poly(phenylene oxide) (PPO) and other ammonium-functionalized poly(phenylene oxide) (PPO)
12. Quaternary ammonium-functionalized poly(styrene) and other ammonium-functionalized poly(styrene)
13. Imidazolium or Phosphonium functionalization instead of ammonium for points 10-13or combinations thereof.

### Example 3

### Overcoming the Conductance vs Cross-Over Trade-off in State-of-the-Art Proton Exchange Fuel-Cell Membranes by Incorporating Atomically Thin CVD Graphene

Abstract. Permeance versus selectivity trade-offs are endemic to polymeric membranes. In fuel-cells, thinner proton exchange membranes (PEMs) could allow for higher proton conductance i.e. lower area-specific-resistance (ASR), lower ohmic losses and increased stack power density as well as lower ionomer cost. However, reducing thickness is accompanied by an increase in undesired species crossover detrimental to electrochemical performance and long-term efficiency. Here, it is shown that incorporating atomically thin monolayer graphene synthesized via scalable chemical vapor deposition (CVD) and with tunable defect density into PEMs (Nafion ˜5-25 μm thick) can allow for reduced H₂ crossover (˜34-78% of Nafion of similar thickness) while maintaining adequate areal proton conductance for applications (>4 S cm⁻²). Using a combination of systematic experiments and resistance modelling, the trade-offs between the complex interplay of graphene defect density and Nafion proton transport resistance on areal proton conductance of the resulting graphene|Nafion composite membranes as well as H₂ crossover are elucidated. High-quality low-defect density CVD graphene (G) supported on Nafion 211 (˜25 μm) i.e. N211|G not only showed the high areal proton conductance (˜6.1 S cm⁻²) but also the lowest H₂ crossover (˜0.7 mA cm⁻²). Finally, fully functional centimeter-scale N211|G fuel-cell membranes are demonstrated with performance comparable to state-of-the-art Nafion N211 at room temperature as well as standard operating conditions (˜80° C., ˜150-250 kPa-abs) with H₂/Air (˜0.57-0.63 W/cm²) and H₂/O₂ feed (˜1.4-1.62 W/cm²) and markedly reduced H₂ crossover (˜53-57%). This approach provides avenues to overcome the persistent crossover-conductance trade-off inherent to fuel-cell PEMs and is also highly relevant for flow-batteries, electrolysis, isotope separation, and beyond.

Introduction. Proton exchange membranes (PEMs) play an important role in a range of clean-energy generation and conversion processes [A1-A3] including hydrogen (H₂) and methanol fuel cells [A4, A5] for transportation and remote/auxiliary power respectively, redox flow batteries for grid-scale energy storage [A6, A7], electrolysis for H₂ production, isotope separations, among others [A1-A15]. PEM based H₂ fuel-cell applications utilize state-of-the-art ionomer Nafion™, a sulfonated fluoropolymer with a fluorocarbon backbone and side chains terminating in sulfonic acid that allows for selective proton transport [A7-A10]. However, Nafion exhibits the classic permeance vs. selectivity trade-offs endemic to polymeric membranes, i.e. thinner membranes could allow for higher proton conductance and increased stack power density due to lower area-specific-resistance and lower ohmic losses as well as lower ionomer cost, but reduced thickness also results in increased H₂ crossover detrimental to electrochemical performance and long-term efficiency [A7-A9].

In this context, atomically thin 2D materials such as graphene and hexagonal boron nitride (h-BN) present potential for advancing PEMs [A4, A5, A7, A9, All-A28]. The pristine lattice of graphene and h-BN allow for electric-field driven permeation of protons while hindering transport of even small gas atoms such as He. Leveraging the selective proton transport of 2D materials and integrating them with conventional polymeric PEMs can enable approaches to overcome the permeance vs selectivity trade-off in PEMs [A1, A3, A4, A6-A9, A12, A29-A39].

However, PEM applications necessitate large-arca synthesis of 2D materials via bottom-up chemical vapor deposition (CVD) processes that typically incorporate intrinsic defects into the 2D lattice [A40-A43]. Intrinsic defects could on the one hand enhance proton transport relative to the pristine lattice [A15, A44], but on the other hand larger non-selective defects can decrease membrane selectivity due to increased hydrogen crossover [A3, A12, A33, A34, A45].

Hence, understanding the complex interplay between intrinsic defects, PEMs support resistance, differences in the transport pathways for H₂ crossover and proton transport in PEMs, are imperative to enable rational design and pathways to integrate atomically thin graphene films with Nafion [A3, A4, A7-A9, A32] to simultaneously leverage the high proton conductance of selective intrinsic defects as well as reduced H₂ crossover [A3-A5, A7, A32] due to i) impermeability of the pristine 2D lattice, and ii) the low propensity of large defects in 2D materials to precisely overlapping the water channels in the Nafion that typically allow for H₂ crossover [A3, A9, A12, A18, A46].

Here, the incorporation of atomically thin monolayer CVD graphene with tunable intrinsic defect density with Nafion of varying thicknesses (˜5-25 μm) for fuel-cell applications was systematically studied. Using a combination of systematic experiments and detailed resistance modelling, the tradeoffs between the complex interplay of graphene defect density and Nafion support transport resistance and its influence on H₂ crossover as well as areal proton conductance of the resulting graphene|Nafion composite membranes were elucidated. The results show that the incorporation of monolayer CVD graphene can allow for ˜34-78% reduction in H₂ crossover compared to bare Nafion (of similar thickness), while maintaining adequate proton conductance>4 S cm⁻² for practical applications. Industry standard state-of-the-art Nafion N211 (˜25 μm) interfaced with high-quality (low-defect density) CVD graphene i.e. N211|G shows high areal proton conductance (˜6.1 S cm⁻²) as well as the lowest H₂ crossover (˜0.7 mA cm⁻²) at room temperature under 100% humidification, thereby allowing for overcoming the conductance vs cross-over trade-off. Fully functional centimeter-scale N211|G fuel-cell membranes are demonstrated with significantly reduced H₂ crossover (˜53-57%) and fuel-cell performance comparable to state-of-the-art Nafion N211 with H₂/air and H₂/O₂ feed at room temperature as well as standard operating conditions (˜80° C., ˜150-250 kPa-abs), maintaining power densities of ˜0.57-0.63 W cm⁻² (H₂/air) and ˜1.4-1.62 W/cm² (H₂/O₂).

### Results and Discussion

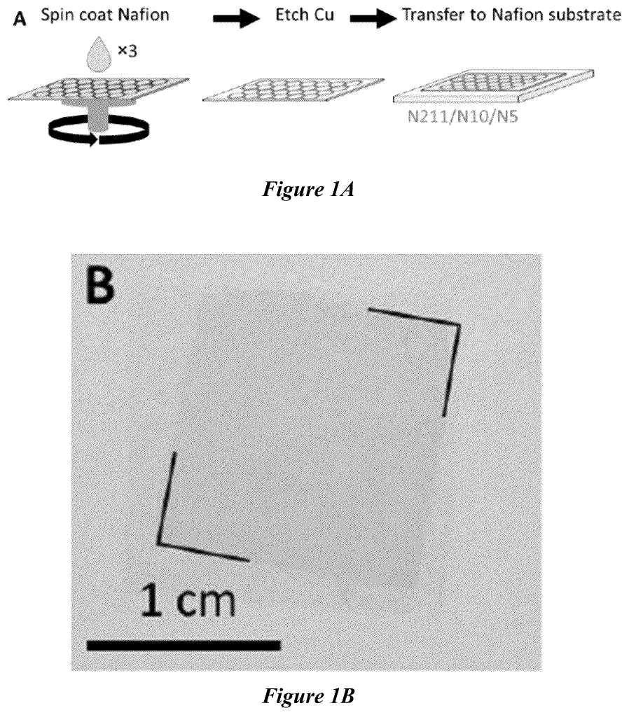

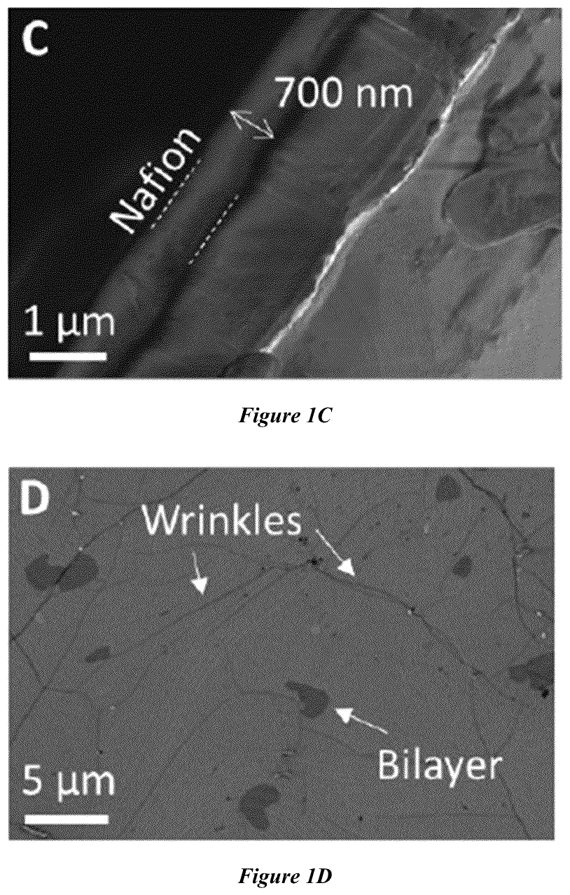

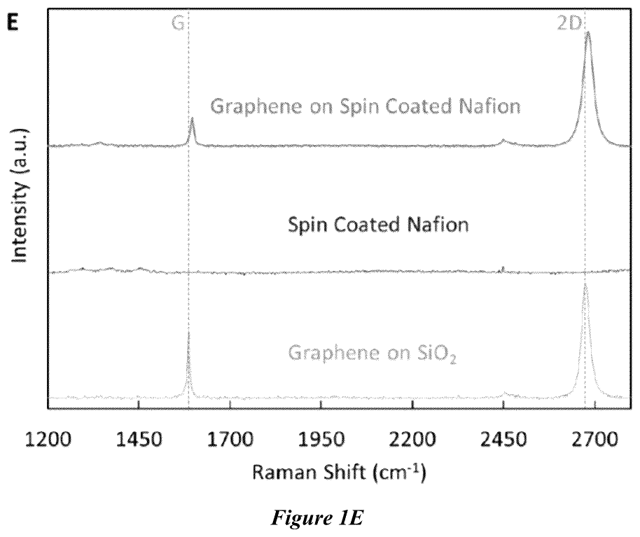

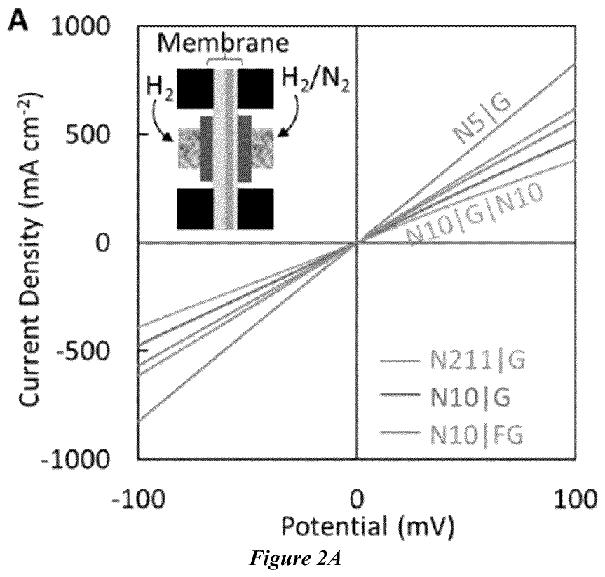

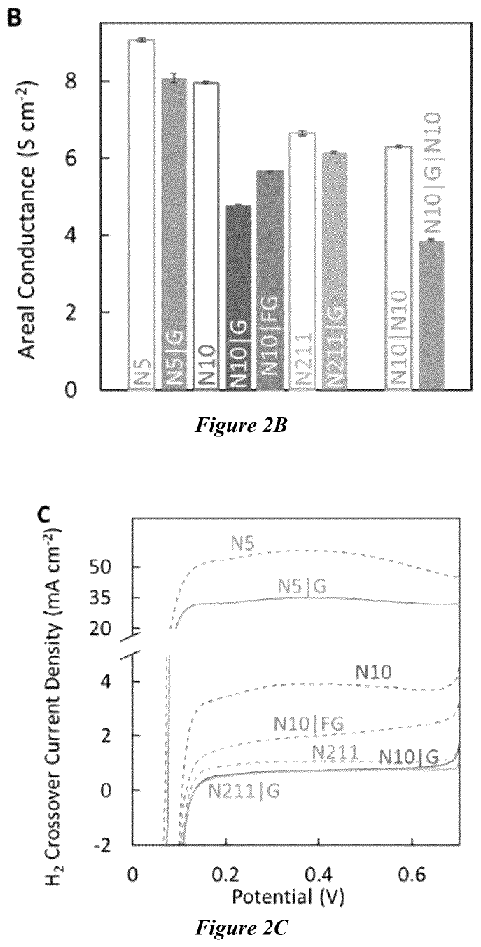

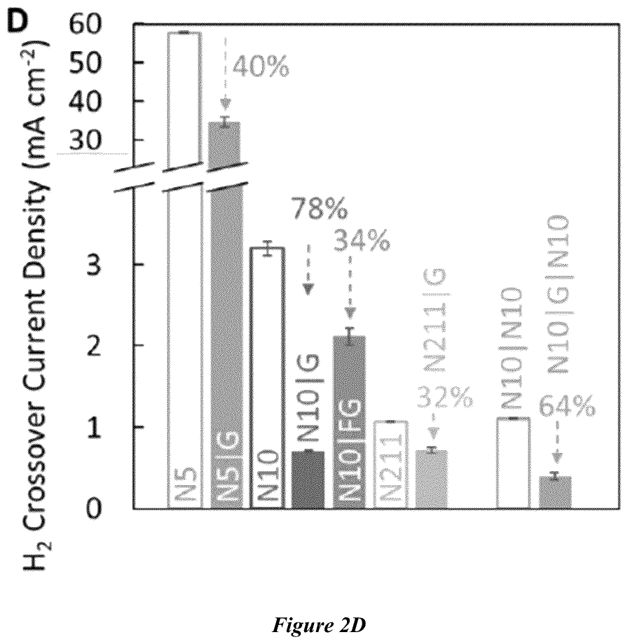

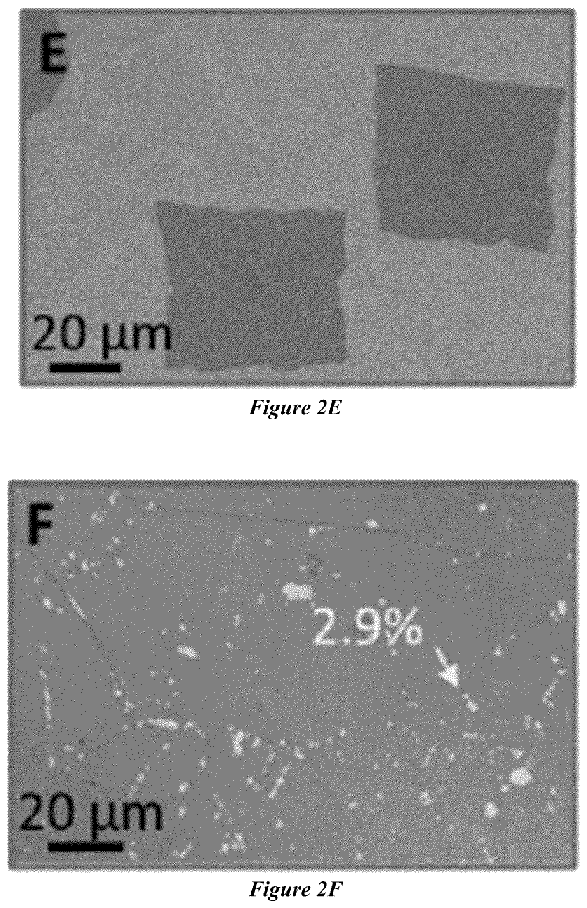

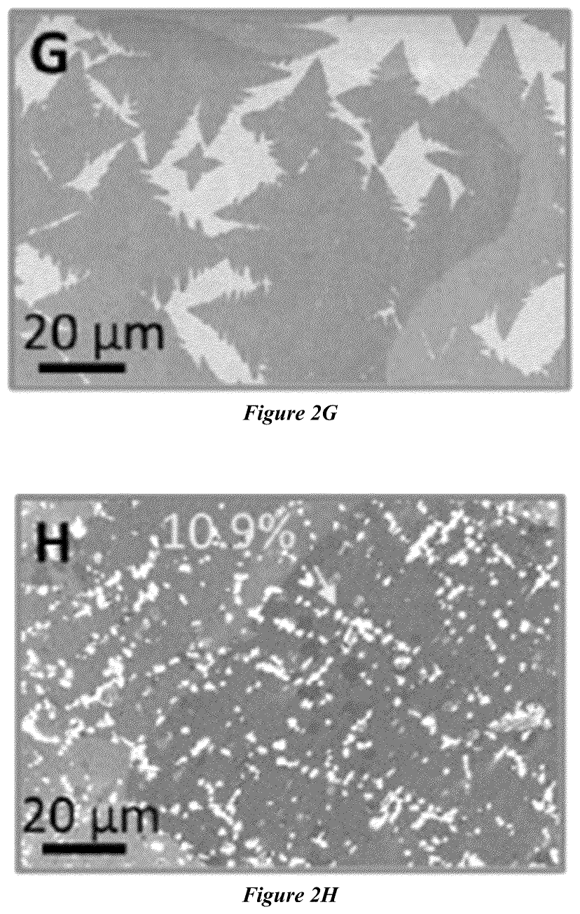

Interfacing atomically thin monolayer CVD graphene with Nafion for PEMs. To integrate graphene with the Nafion substrate (FIG. 1A), a layer of Nafion is first spin-coated on graphene grown on Cu foil via CVD. The ˜700 nm thick (FIG. 1C) spin-coated Nafion layer serves as a carrier/support layer for graphene during removal of the Cu foil by acid etch and facilitates facile graphene transfer to the target Nafion substrates of choice to form Nafion|G (Nafion|G|700 nm spin-coated Nafion) composite PEMs (FIG. 1A, FIG. 1B) [A47]. Additionally, the spin-coated Nafion layer also protects the CVD graphene from coming into direct contact with the Pt/C electrodes, during fabrication of membrane electrode assemblies (MEA, sec inset in FIG. 2A).

The efficacy of graphene transfer is evaluated using optical images (FIG. 1A) and scanning electron microscopy (SEM, FIG. 1D). Optical images show large areas of uniform contrast with no visible cracks or tears at the macroscopic scale (FIG. 1B). SEM images show features consistent with graphene films such as wrinkles in the film, small multi-layers (FIG. 1D) and absence of significant micro-scale damage (<0.25% area), indicating very high-fidelity transfer.

Raman spectroscopy of graphene transferred to Si/SiO₂ wafer (FIG. 1E) shows characteristic peaks of monolayer graphene at ˜2700 cm⁻¹ (2D) and ˜1580 cm⁻¹ (G) with I_{2D}/I_{G}˜1.8 and a negligible D peak at ˜1350 cm⁻¹ (I_{D}/l_{G} ratio ˜0.032) confirms the high quality of the as-synthesized CVD graphene [A47]. Notably, Nafion peaks at ˜1207 cm⁻¹ (E₁ CF₂ degenerate stretch), ˜1291 cm⁻¹ (E₂ CC degenerate stretch), and ˜1372 cm⁻¹ (A₁ CC symmetric stretch) [A48] are relatively weak but detectable (FIG. 1A-FIG. 1E, Spin Coated Nafion) and overlap with the D peak region for graphene. Nonetheless, successful graphene transfer to spin coated Nafion is confirmed by the presence of the characteristics 2D, and G peaks and the minor blue-shift is attributed to doping and/or lattice strain due to the flexibility of the Nafion substrate [A49, A50].

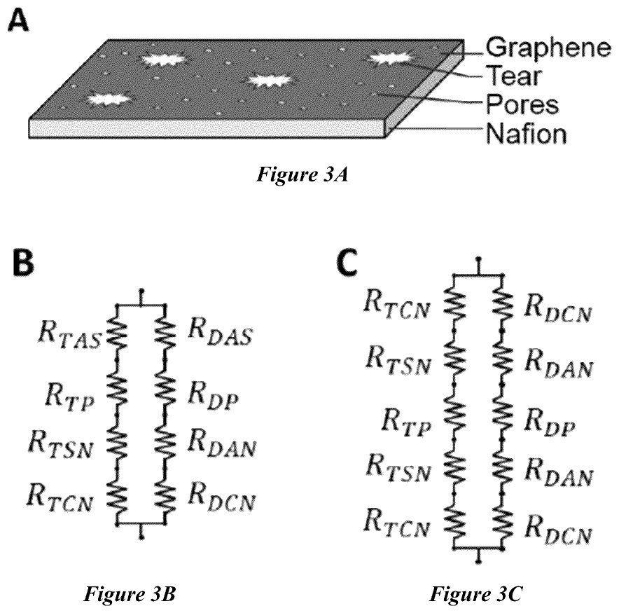

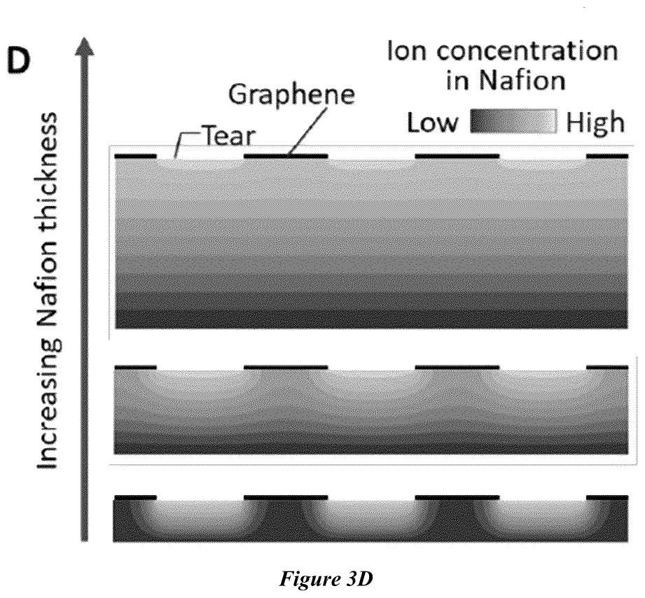

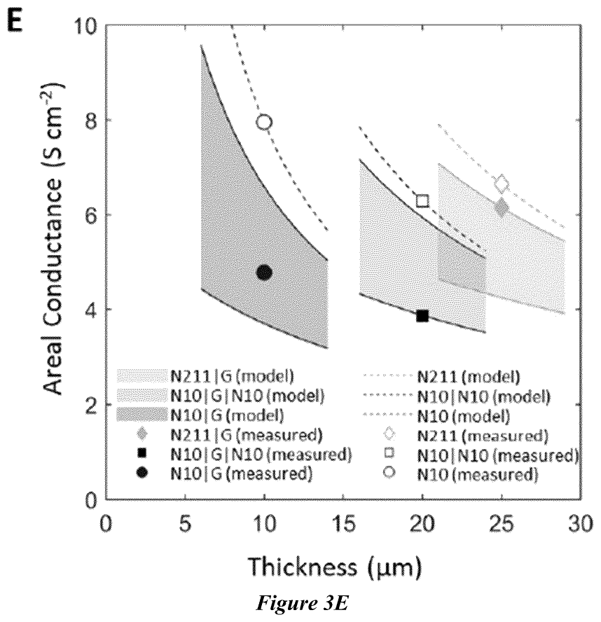

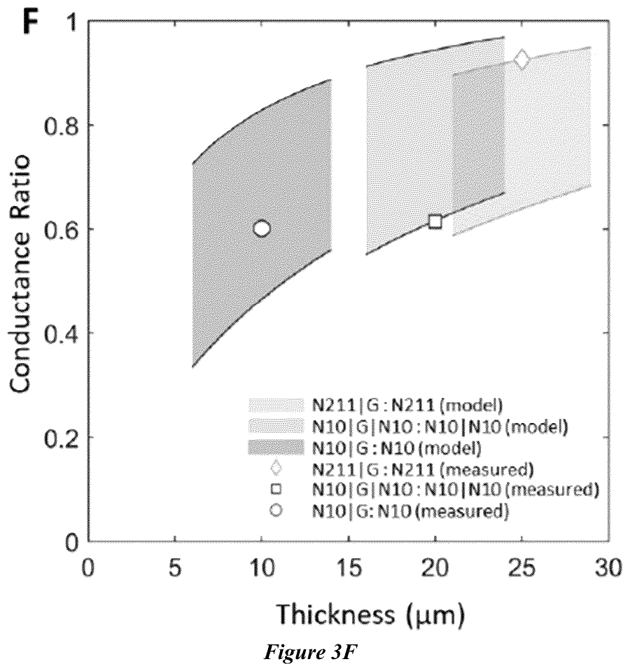

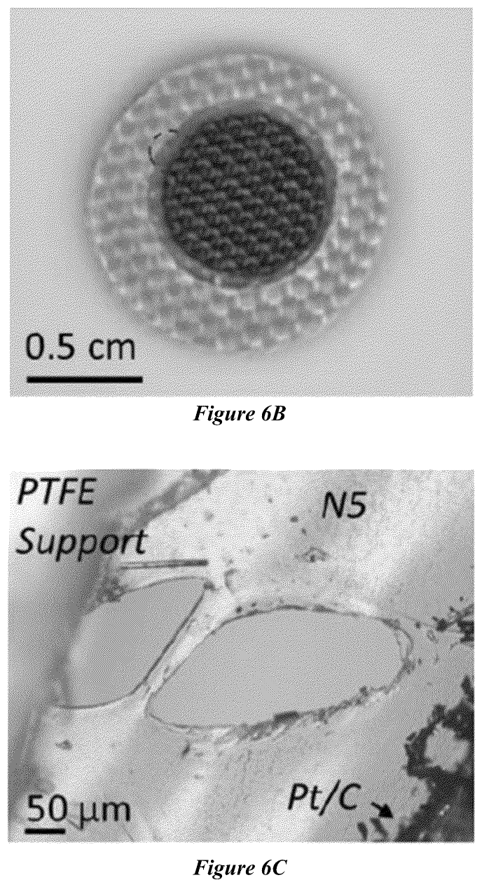

Probing the interplay between intrinsic defects in CVD graphene and Nafion support resistance on proton transport and H₂ crossover for PEMs. To develop an understanding of the interplay between intrinsic defects in graphene, Nafion support resistance and trade-offs for interfacing atomically thin CVD graphene with Nafion for PEMs, the impact of Nafion support thickness (N211˜25 μm, N10˜10 μm, N5˜5 μm thickness) on proton transport and H₂ crossover in conjunction with a resistance model (FIG. 3A-FIG. 3F) were experimentally studied. Notably, the N5 and N10 contain an embedded porous PTFE reinforcement structure and showed deformation on hot-press (see FIG. 6A-FIG. 6C) compared to conventional N211 (without PTFE reinforcement). Hence, the use of hot-press was limited to only adding electrodes for MEA fabrication (see methods) and to make the N10-GN10 sandwich (˜20 μm) to facilitate a comparison with N211|G (˜25 μm) of similar thickness.

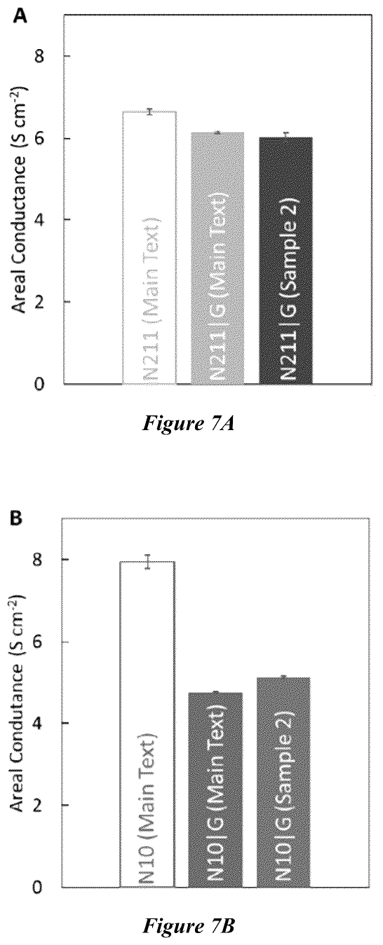

FIG. 2A shows I-V curves acquired at RT via linear sweep voltammetry (LSV) when supplying humidified H₂ to both sides of the Nafion|G composite PEMs and bare Nafion controls. The areal proton conductance (S cm⁻²) is computed by taking the inverse of the I-V slope (FIG. 2B). An increase in areal conductance is observed with decreasing thickness of Nafion (N211˜6.2 S cm⁻², N10˜7.9 S cm⁻² and N5˜9.1 S cm⁻²). Interestingly, the addition of graphene reduces proton conductance by varying amounts for the different Nafion substrates e.g. for N211|G˜7.5% reduction (filled green bar) is observed compared to N211 control (unfilled green bar), consistent with prior work (˜9-11%) [A3, A14]. However, graphene interfaced with N10 (N10|G, dark blue solid bar), shows ˜39.9% reduction (from ˜7.9 S cm⁻² to ˜4.8 S cm⁻²) and these observations are consistent across multiple samples (FIG. 7A-FIG. 7B). Finally, N5|G shows ˜10.8% reduction in proton conductance compared to N5 (FIG. 2B) despite the differences in processing required (see methods and FIG. 6B, FIG. 6C) which is consistent with the relative change in proton conductance observed for N211.

Interestingly, PEMs of similar thickness, i.e. N211 (˜25 μm thick) and N10|N10 sandwich (˜20 μm thick), show similar areal conductance to protons (N10|N10˜6.3 S cm⁻², N211˜6.6 S cm⁻²) despite differences in N10 being reinforcement with PTFE while N211 is not. This suggests the PTFE reinforcement has minimal influence on the proton transport and also that there is minimal interfacial resistance contribution between the N10 layers (FIG. 2B). Notably, the N10|GIN10 sandwich membrane similar in thickness to N211 showed ˜38.5% reduction in proton transport compared to the control sandwich and consistent with reduction for N10|G.

To understand the origins of the reduction in proton transport for N10|G and in an effort towards exploring avenues to increase the areal proton conductance, graphene grown under different CVD conditions (fast graphene [FG] due to the rate of CVD growth which has been demonstrated to have a higher defect density) [A3] was interfaced and it was found that the areal proton conductance can indeed be improved from ˜4.8 S cm⁻² (N10|G) to ˜5.7 S cm⁻² (N10|FG). The increase in areal conductance is attributed to the presence of an increased number of Angstrom-scale defects in the 2D lattice of FG arising from the differences in kinetics during CVD growth and manifests as differences in graphene domain shapes for G (rectangular, FIG. 2E) and FG (dendritic, FIG. 2G) prior to convergence to form a continuous film as well as density of etch pits formed in the Cu underneath defects in graphene upon subjecting CVD graphene on Cu foil to electrochemical etch tests (FIG. 2F, FIG. 2H) [A3]. The etch pits appear as bright spots in the SEM and the etched area of FG˜10.9%>G˜2.9% confirms higher defect density of FG [A12, A18].

To gain further insights into the significant reduction in areal proton conductance measured when G is transferred onto N10 compared to N211, an approximate analytical ion transport model was developed. The model builds on prior ion transport resistance modeling for this membrane structure [A3, A32]. Without graphene present, the resistance (R [Ω]) to ion transport through the Nafion layer is modeled as one-dimensional (1D) conduction. For a Nafion layer of thickness t_{N}(m) and ion conductivity σ_{N} (S m⁻¹), the transport resistance through one

$${R}_{N x} = \frac{{t}_{N}}{A {σ}_{N}} \qquad ( 1 )$$

where A (m²) is the total membrane area. Through two stacked layers of Nafion, each of thickness t_{N}, the areal resistance is,

$${R}_{N x + N x} = \frac{2 {t}_{N}}{A {σ}_{N}} \qquad ( 2 )$$

The Nafion conductivity is dependent on the formulations and preparation of the Nafion. For each type of membrane measured, the Nafion conductivity was determined from Equation 1 or Equation 2 from direct measurements of membrane conductance without graphene present.

As has been observed in prior studies, imperfections in graphene lead to transport pathways through the material [A32]. Larger tears in the material are distinguished from smaller defects based on size, which can lead to different implications for transport through the material (FIG. 3A). With a graphene layer covering one side of the Nafion, proton transport through the membrane can occur through tears, defects, or through the graphene lattice itself. Previous work has found that the conductance of tears and defects is significantly higher than through the lattice [A32], so the latter pathway is neglected in this modeling. An equivalent transport resistance model is presented in FIG. 3B.

To cross the membrane through a tear, ions experience resistance to funneling toward the tear within the solution (R_{TAS}), to passing through the tear (R_{TP}), and to diffusing through the Nafion on the other side. The resistance within the Nafion has two components: (1) the resistance to one-dimensional conduction through the material (R_{TCN}), which is present even without graphene, and (2) the spreading resistance (R_{TSN}) within the Nafion away from the tear by which ions diffuse out radially from the tear to access a wider area of the Nafion support to conduct through. The spreading resistance is negligible for membranes that are thick relative to the spacing between tears (FIG. 3D, top), but could restrict transport when the membrane is thin compared to this spacing because ions cannot access the entire cross-sectional area to diffuse to the other side (FIG. 3D, bottom).

The access resistance and pore resistance are estimated from the analytical equation for ion conduction through a circular opening in a thin plate with the same medium on either side.

In prior studies on membranes with the same structure and type of graphene, it was found that defect parameters of D=0.8 Å and n=3.3×10¹⁰ cm⁻² could match measured conductance and ion selectivity values [A32]. The same values are used in modeling calculations presented here. Tears can have a range of sizes but are approximated as all being circular with D_{T}=1 μm diameter. It is noted that different choices of tear diameter and fractional area coverage can be used to obtain similar conductance, but this is a reasonable size expected in graphene and is used to demonstrate that the transport pathways described can account for the measured conductance.

FIG. 3E compares model values of areal conductance to measurements, while FIG. 3F shows the conductance ratio for the graphene-Nafion composite membranes compared to Nafion without graphene. The model bands show predictions for graphene fractional arca occupied by tears between a=3.5% and 14%. The significantly greater reduction in conductance with the same graphene on the N10 layers compared to the N211 layers are accounted for by a lower tear density over the N10. This indicates that changes in membrane fabrication to accommodate differences in Nafion support have an important effect on the resulting membrane quality. The modeling further demonstrates how transport pathways through tears and defects can account for the experimentally measured conductance.

The pathways of transport for proton and H₂ through Nafion are different [A3, A4, A7-A9, A32], and interfacing CVD graphene can allow for leveraging high proton conductance of selective intrinsic defects as well as reduced H₂ crossover [A3-A5, A7, A32] due to i) impermeability of the pristine regions of the 2D lattice, and ii) the low propensity of large defects in 2D materials to precisely overlap with the water channels in the Nafion that allow for H₂ crossover [A3, A9, A12, A18, A46]. FIG. 2C shows H₂ crossover measured through each PEM by supplying humidified H₂ to one side and humidified N₂ to the other as well as the % H₂ crossover reduction (FIG. 2D) with respect to the controls. A different trend compared to areal proton conductance (FIG. 2A, FIG. 2B) is observed for H₂ crossover (FIG. 2C, FIG. 2D), i.e. ˜20-25 μm thick membranes (N211, N211|G, and N10|G|N10) show the least crossover (0.4-1.1 mA cm⁻²) and 5 μm thick membranes (N5, N5|G) show the highest (˜57.7 mA cm⁻²). However, the greatest % reduction in H₂ crossover is observed for the N10|G (˜78%) and the N10|G|N10 (˜64%) consistent with the areal conductance measurements, while that of N211|G (˜32%) and N5|G (˜40%) are similar. Interestingly, the H₂ crossover for the N5|G (˜34.7 mA cm⁻²) is an order of magnitude greater than the bare N211 (˜1 mA cm⁻²) and the N10|G H₂ crossover (˜0.7 mA cm⁻²) is similar to that of N211|G (˜0.7 mA cm⁻²), despite N10|G being ˜50% of the thickness of N211|G, indicating that high quality graphene is an effective barrier to H₂. Upon interfacing N10 with FG, the H₂ crossover increases to ˜2.1 mA cm⁻², consistent with the presence of more defects including non-selective defects.

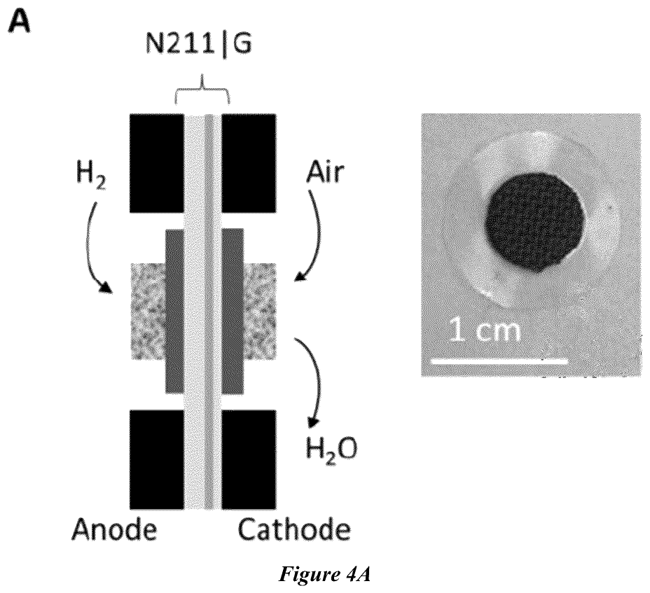

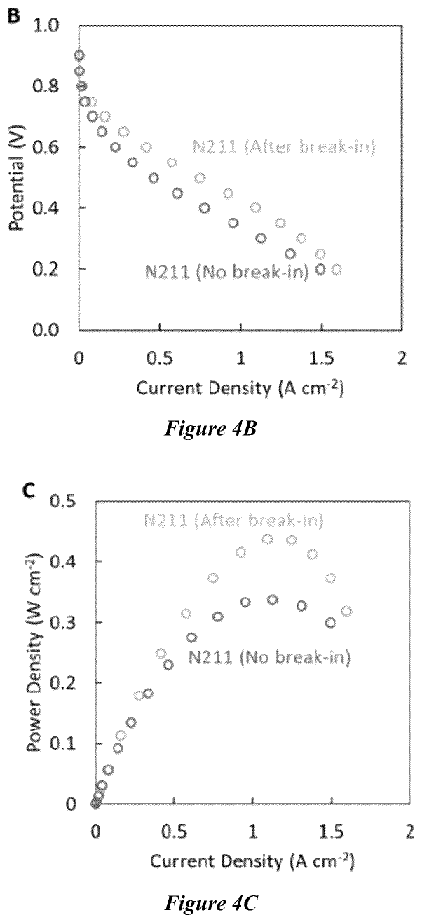

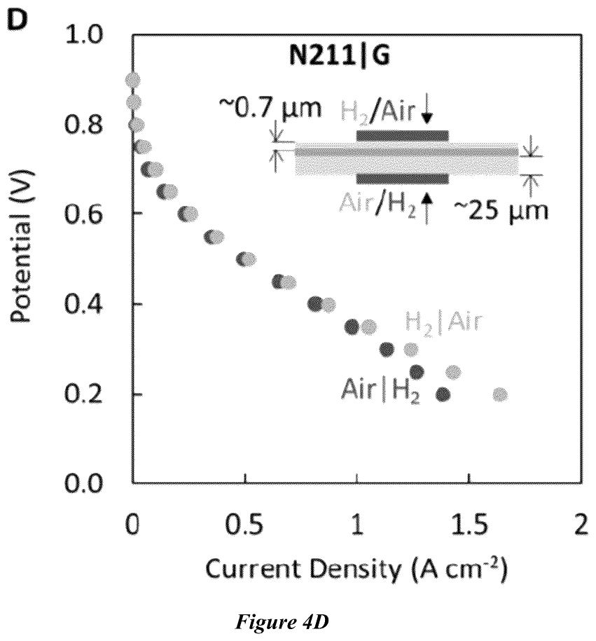

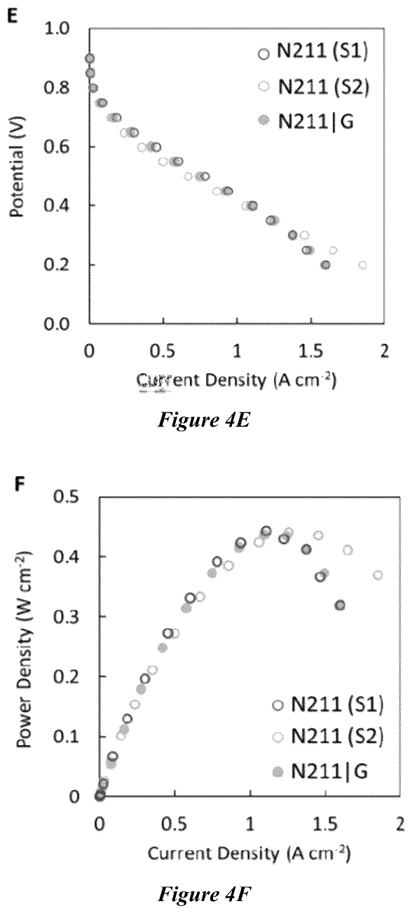

Performance of Nafion|G PEMs in a custom-built cell at room temperature. Since the N211|G membrane demonstrated the lowest reduction in areal proton conductance (˜7.5%) its performance was evaluated at room temperature using a custom-built cell in comparison to N211 (FIG. 4A-FIG. 4F). After the break-in procedure, which was used to ensure humidification of the membrane and stability of measurements, the current density at 450 mV for N211 increases from 610.9 mA cm⁻² to 923.9 mA cm⁻² and the peak power density from ˜0.34 W cm⁻² to ˜0.44 W cm⁻² (FIG. 4B, FIG. 4C). Next, it was evaluated whether the configuration of the N211|G in the cell had an effect, i.e. if the ˜700 nm spin-coated Nafion covering graphene on N211 faced the anode (H₂ side) or the cathode (air side) and found no significant effect in the polarization curves, regardless of orientation (FIG. 4D).

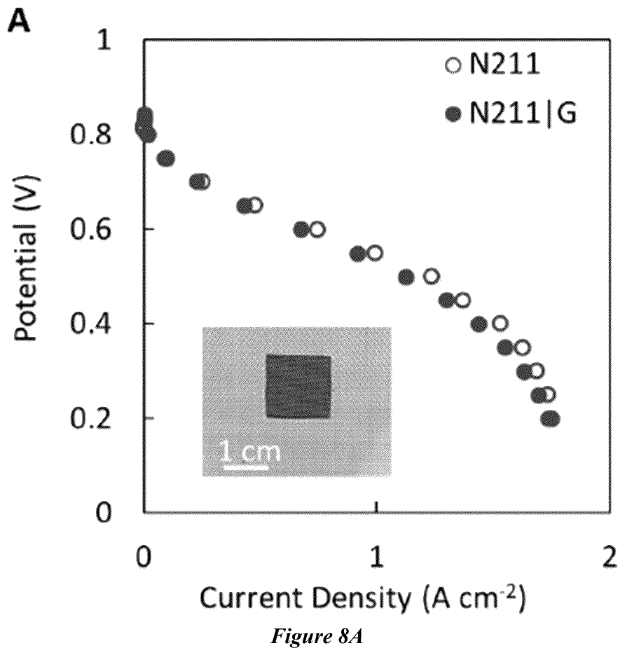

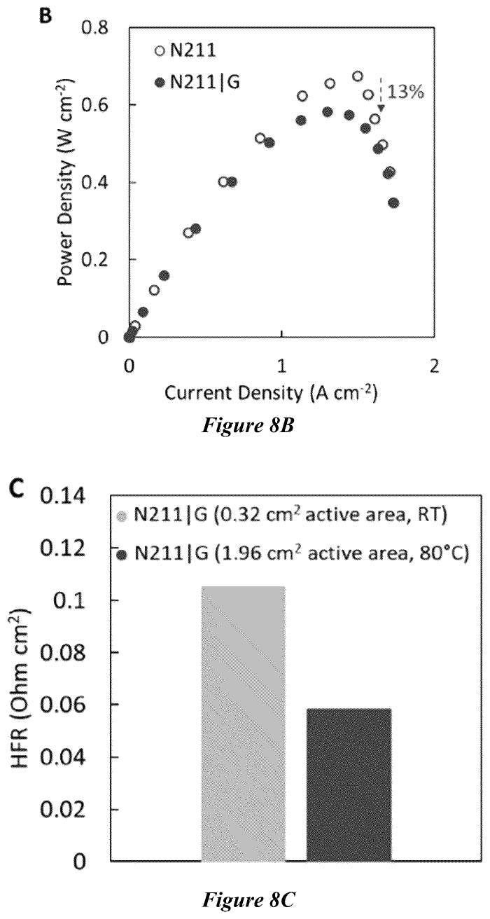

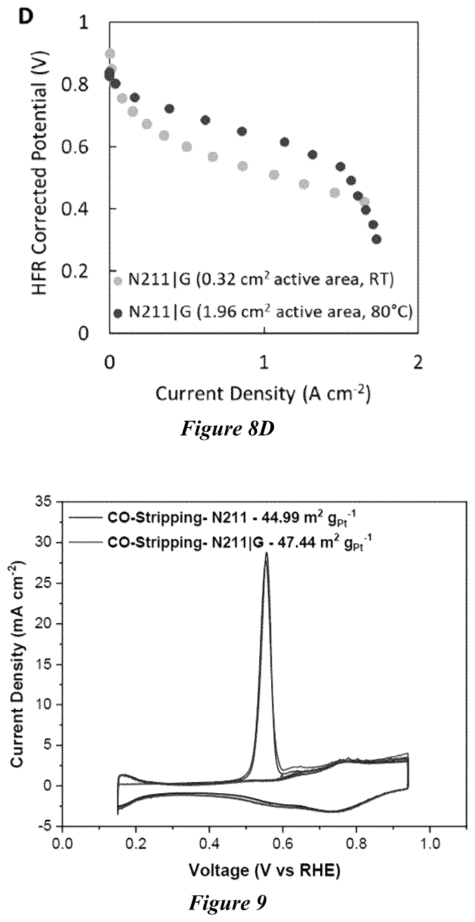

Interestingly, the N211|G membrane showed comparable performance to bare N211 measured under similar test conditions (i.e. room temperature and atmospheric pressure, FIG. 4E, FIG. 4F) [A51, A52], indicating the potential benefits of interfacing CVD graphene with Nafion for PEMs with high proton conductance and low H₂ crossover. Electrochemical impedance spectroscopy (EIS, FIG. 8A-FIG. 8D) is used to measure the high frequency resistance (HFR). The reduction in HFR for the N211|G membrane from ˜105.3 mΩ cm² (at RT) in the custom-built cell to ˜58.3 mΩ cm² (at 80° C.) in a standard Scribner fuel-cell test station indicates that lowering the system/contact resistance via controlled compression and increasing temperature may allow for higher performance (FIG. 8A-FIG. 8D). Indeed, subtraction of the ohmic resistance contribution from the polarization curve, shows better agreement between the two test systems (FIG. 8A-FIG. 8D).

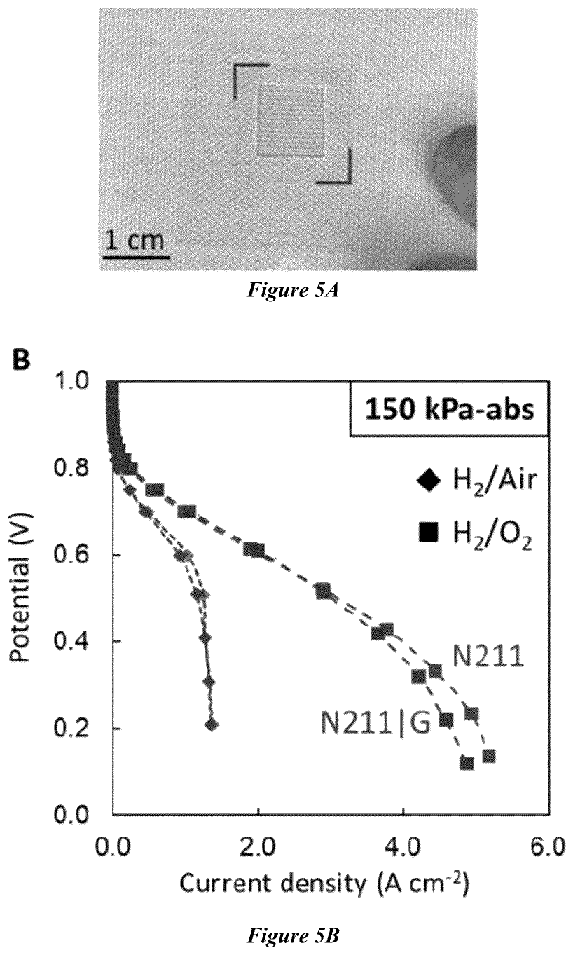

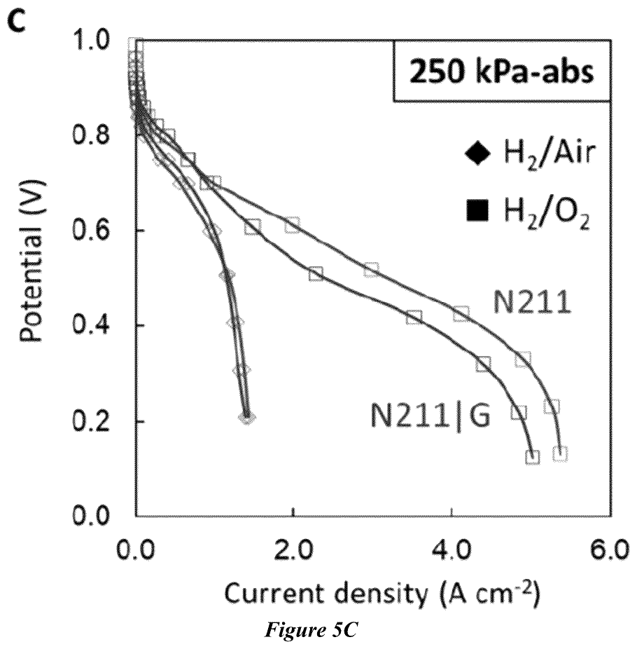

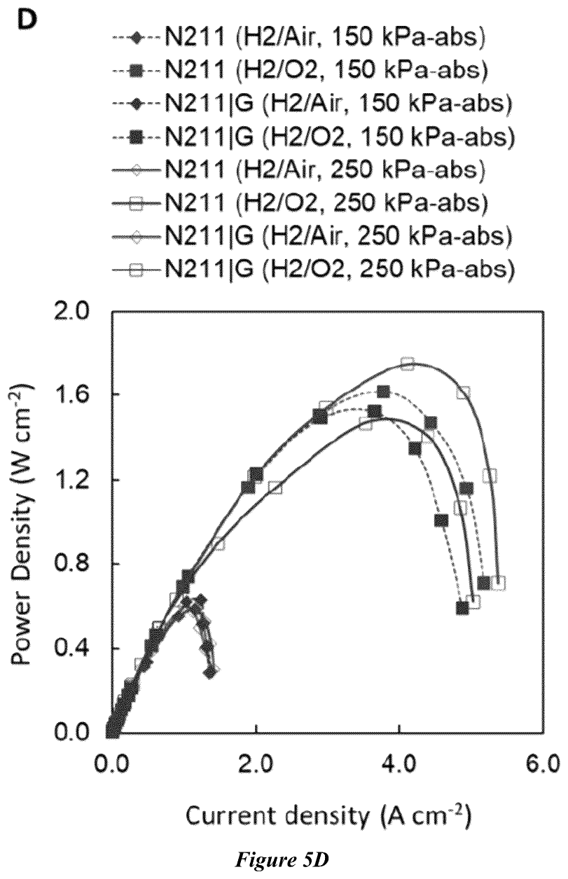

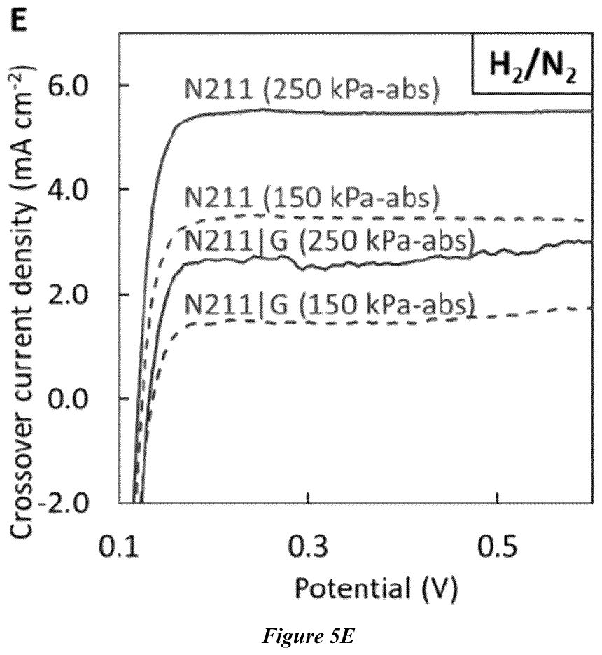

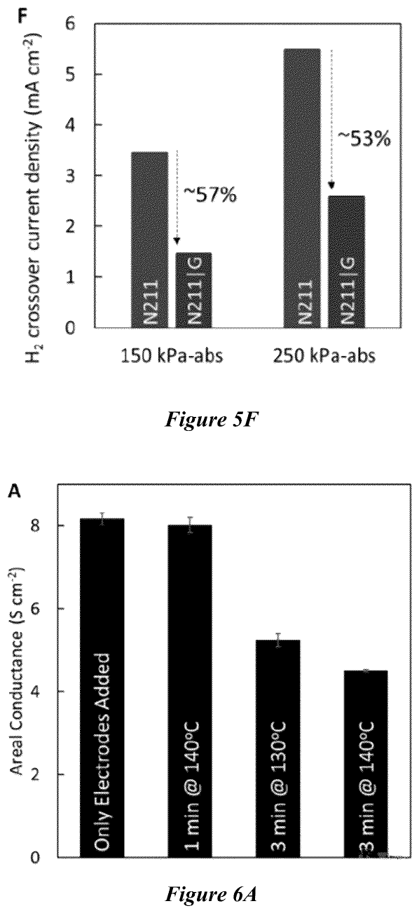

Fuel-cell performance of Nafion|G PEMs with H₂/Air and H₂/O₂ fuel cell at 80° C. and 150-250 kPa-abs. Finally, the performance of the N211|G membranes were evaluate relative to bare N211 under conditions relevant to practical fuel-cell operation (80° C., 100% RH, 150-250 kPa-abs, sec FIG. 5A-FIG. 5F). For better compatibility with the system, the transferred graphene area is increased to ˜2 cm², with active area ˜1 cm², ensuring the active arca is fully covered by the graphene (FIG. 5A).

Beginning-of-life H₂ crossover is evaluated using LSV after the break-in or the conditioning procedure (see methods). With the addition of graphene, the H₂ crossover current density at 0.4 V is reduced by ˜57% to ˜1.5 mA cm⁻² as compared to bare N211 (˜3.4 mA cm⁻²) at a backpressure of 150 kPa-abs (FIG. 5E, FIG. 5F). This is an improvement to the ˜34% reduction in H₂ crossover was observed for a similarly prepared, smaller area membrane [A3, A53], and is attributed to the break-in process that increases cross-over for the N211. A similar reduction in H₂ crossover is observed (˜53%) when the backpressure is increased to 250 kPa-abs (FIG. 5E, FIG. 5F).

Next, the performance of the N211|G compared to bare N211 was evaluated using 150 kPa-abs (FIG. 5B) of air/H₂ at the cathode/anode, respectively, and the performance of the N211|G membrane was observed to be comparable to the bare N211 membrane, reaching max current densities of ˜1.3 A cm⁻² (FIG. 5C), consistent with literature [A54-A56].

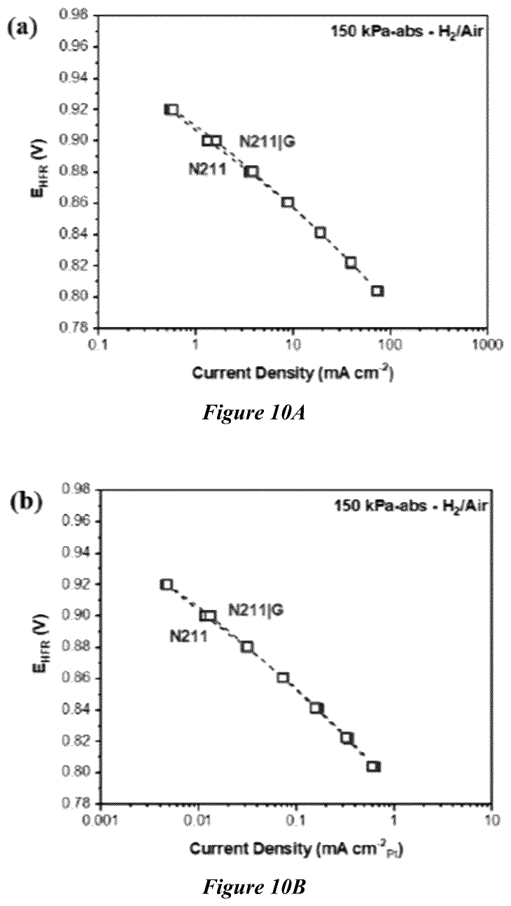

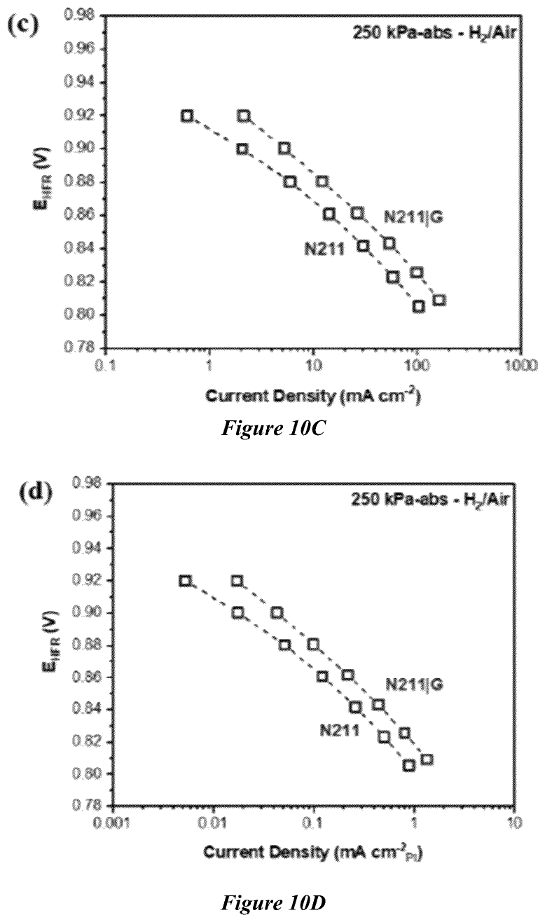

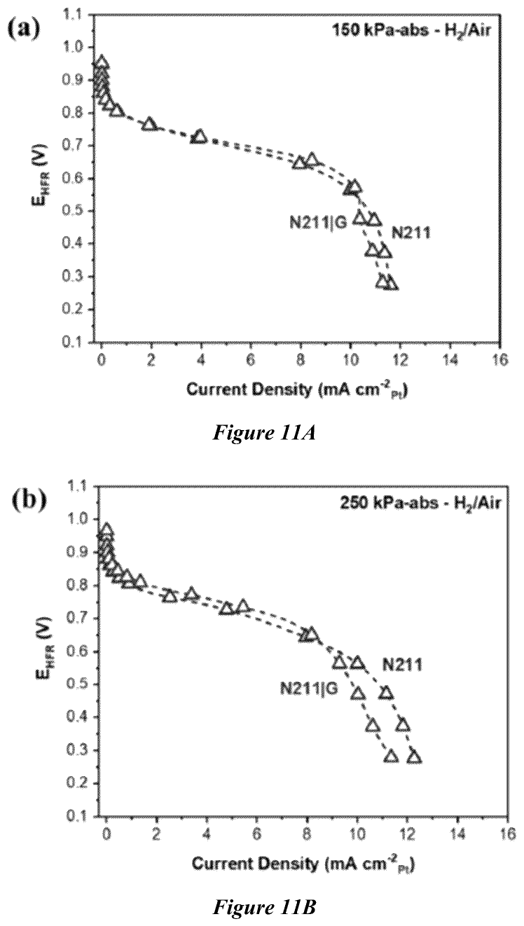

Cell-to-cell variations in the platinum electrochemically active surface area (ECSA), determined by CO stripping (FIG. 9), can induce small differences in the kinetic region of the polarization curves. The ECSA-normalized current can eliminate these difference. However, the addition of a graphene layer decreases the H₂ crossover current, which has the favorable impact of increasing the open circuit voltage (OCV) for N211|G cells, resulting in higher currents in the kinetic region and beyond (FIG. 10A-FIG. 10D). The beneficial effect of the graphene layer is notable in the polarization curve with the PT surface area-normalized current, confirming the higher kinetic performance of N211|G cells (FIG. 11A-FIG. 11B). The lower performance of N211|G cells at a higher current density is attributed to the graphene layer impeding the transport of produced water into the membrane, potentially resulting in flooding of the cathode. This results in minor differences in the peak power densities (FIG. 5D) between N211 and N211|G, both remaining consistent as well as within the range observed in literature (˜0.59-0.63 W cm⁻²) [A55-A57], suggesting the addition of graphene does not significantly hinder the overall PEM performance when operating in a fuel cell at 80° C.

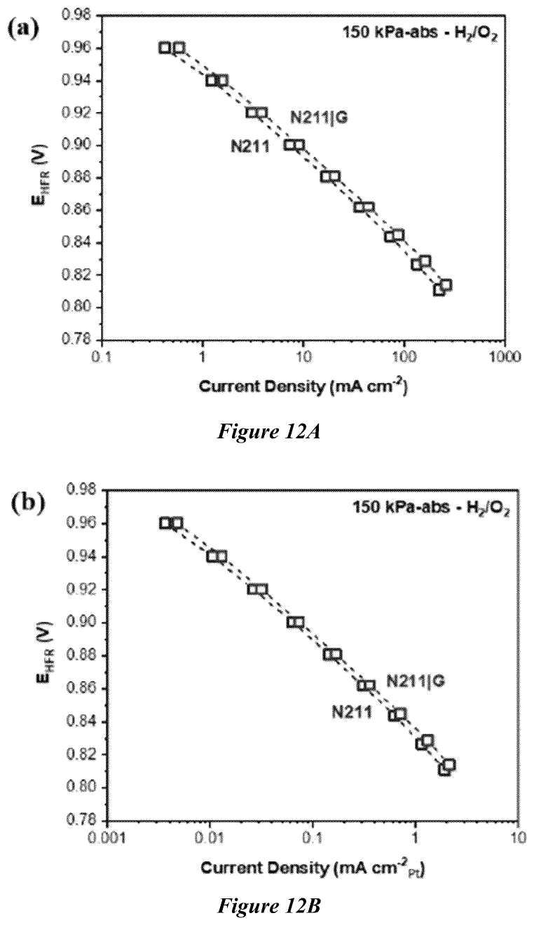

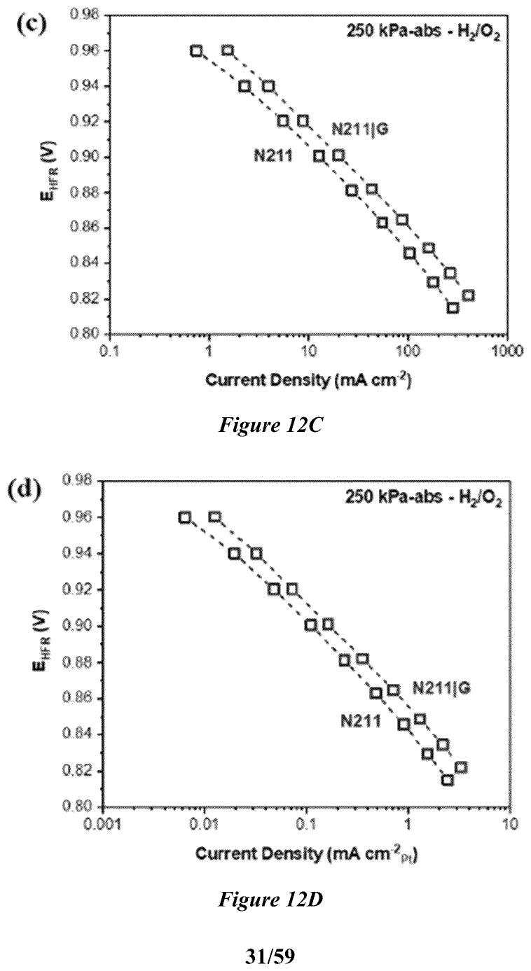

Replacement of air with O₂ at the cathode results in an increase in the OCV and Pt surface area-normalized kinetic current (FIG. 12A-FIG. 12D). Akin to the performance in air, control N211 membrane and the N211|G membrane cells show similar performance in the kinetically dominated region (≥0.7 V) for the O₂-fed cathode while the ohmic resistance-dominated region shows differences (FIG. 5B, FIG. 5C). This difference is reflected in the HFRs for N211|G (˜47.20 mΩ cm²) and N211 (˜45.50 mΩ cm²) at 400 mV, and upon iR correction and normalization to the ECSA, the ohmic regions of the polarization curves are in good agreement. Small differences between the N211 and N211|G membranes are observed in the (FIG. 5B-FIG. 5D). The minor reduction in the maximum current density for N211|G (˜1.52 W cm⁻²) compared to that of the N211 control (˜1.62 W cm⁻²) with back pressure to 150 kPa-abs is exacerbated by an increase in the back pressure to 250 kPa-abs (FIG. 5C, FIG. 5D). Compared to the custom-built cell (FIG. 4A-FIG. 4F), similar maximum current densities were observed for the N211 and N211|G membranes, but an increase in the maximum power density at relevant testing conditions (80° C., 100% RH, 150-250 kPa-abs (FIG. 5A-FIG. 5F). Considering O₂ transport effects can manifest at >300 mA/cm² as well as reduced H₂ crossover with graphene (FIG. 5E), these experiments potentially suggest the graphene layer could increase transport resistance for water produced at the cathode which would have otherwise diffused into the PEM. Ultimately, for practical application at lower operation current densities, air feed, and lower back pressures, such effects are expected to be relatively inconsequential.

Taken together, these experiments demonstrate integrating atomically thin graphene films with Nafion [A3, A4, A7-9, A32] can simultaneously allow for high proton conductance by leveraging selective intrinsic defects as well as reduced H₂ crossover [A3-A5, A7, A32] due to i) impermeability of the pristine 2D lattice to atoms/molecules, and ii) the low propensity of large defects in CVD grown 2D materials to precisely overlap with the water channels in the Nafion that typically allow for H₂ crossover [A3, A9, A12, A18, A46]. These observations illustrate the potential for interfacing CVD graphene into centimeter scale PEMs, run under relevant conditions with an improvement in H₂ crossover without detriment to performance, thereby offering the opportunity to overcome the typical trade-off between conductance and H₂ crossover for advancing next generation PEMs.

Conclusion. A facile approach to integrate CVD graphene with tunable defect density with Nafion of varying thicknesses (˜5-25 μm thick), to overcome the persistent gas crossover-conductance trade-off inherent to polymeric fuel-cell PEMs, was demonstrated. Notably, incorporating atomically thin monolayer CVD graphene into PEMs allows H₂ crossover reduction ˜34-78% compared to Nafion of similar thickness while simultaneously maintaining adequate proton conductance for applications (>4 S cm⁻²). These experimental observations in conjunction with resistance modelling allows for systematic and improved understanding of the critical trade-offs between the complex interplay of graphene defect density and Nafion proton transport resistance on areal proton conductance of the resulting graphene|Nafion composite membranes as well as H₂ crossover. Interfacing high-quality low-defect density CVD graphene on Nafion 211 (˜25 μm thickness) i.e. N211|G allows for the high areal proton conductance (˜6.1 S cm⁻²) as well as the lowest H₂ crossover (˜0.7 mA cm⁻²). The fully functional centimeter-scale N211|G fuel-cell PEMs demonstrate performance comparable to state-of-the-art Nafion N211 with H₂/Air (˜0.57-0.63 W/cm²) and H₂/O₂ feed (˜1.4-1.62 W/cm²) at room temperature as well as standard operating conditions (˜80° C., ˜150-250 kPa-abs). This work can aid future developments of PEMs for fuel-cells, and overcoming the crossover-conductance trade-off is also highly relevant for flow-batteries, electrolysis, isotope separation, and other PEM technologies.

### Experimental Section/Methods Section

Graphene growth. Graphene was synthesized using a custom built hot walled CVD reactor [A3, A37-A41, A58]. Cu foil (HA, 18 μm thickness, JX Holdings) is cleaned via sonication in 20 v/v % HNO₃ for 4 minutes followed by DI water rinse, air dried, and loaded into the reactor (base pressure ˜15 mTorr) [A3]. The reactor is heated to 1060° C. (˜35° C./min ramp rate) with 100 sccm H₂ (˜4 Torr) and the Cu foil is annealed for 60 min [A3].

Two different kinds of graphene are used in this study: 1) high quality graphene (G) with square domains and 2) graphene grown fast with a higher supply of dendritic domains (FG) [A3].

Conditions used for G: 1060° C., 300 sccm H₂ (˜14 Torr), growth step #1 with 0.5 sccm CH4 for 60 min, growth step #2 with 1 sccm CH₄ for 30 min. The reactor is quench cooled to room temperature [A3].

Conditions used for FG: 1060° C., 100 sccm H₂ (˜4 Torr), growth step #1 with 2 sccm CH₄ for 30 min, growth step #2 with 4 sccm CH₄ for 30 min [A3]. The reactor is quench cooled to room temperature [A3].

To obtain individual domains of graphene, growth times of ˜5 min for G (FIG. 2E) and 30 s for FG are used (FIG. 2G) [A3].

Electrochemical etch test. Electrochemical etch test is used to estimate the defect density of the synthesized G and FG [A3, A32, A37, A58]. In a two-electrode geometry, the working electrode connected to graphene on Cu foil (˜0.5×1 cm²) and the reference/counter electrode connected to bare Cu foil (˜1×5 cm²) were submerged in 0.5 M CuSO₄ and a 1 V bias was applied between the electrodes for 1 s. The graphene on Cu foil was then immediately rinsed in DI water, dried, and imaged with SEM (FIG. 2F, FIG. 2H). Etched regions underneath defects in graphene appear as bright, white spots in SEM images and ImageJ software was used to calculate the total area etched.

Raman spectroscopy. Raman spectra (FIG. 1E) were obtained using a ThermoFisher DXR Confocal Raman Microscope (532 nm laser, 1-3 mW power). Raman of graphene on spin coated Nafion is obtained by using a Si/SiO₂ wafer (300 nm SiO₂) as a support, by gently pressing the wafer downward on the floating G|Nafion such that a Si/SiO₂/Nafion/Graphene stack is obtained with graphene on the top side.

The spin coated Nafion control is obtained following the spin coating process described above but on bare, annealed Cu foil and the free-standing Nafion scooped onto Si/SiO₂ wafer.

For Raman of CVD graphene on Si/SiO₂, graphene is transferred via poly-methyl methacrylate (PMMA) transfer [A3, A32, A38, A42, A58]. Briefly, PMMA solution (MW 35000, 2 wt % in anisole) is drop casted on graphene and dried at room temperature before etching the Cu foil in 0.2 M ammonium persulfate (APS) as described above. The G|PMMA stack is scooped onto Si/SiO₂ wafer and dried (30 min at 60° C.). The PMMA is removed by soaking in acetone (˜12 h) and rinsing in isopropanol.

Graphene transfers via spin coated Nafion and membrane fabrication. Nafion is spin-coated on CVD graphene on Cu foil (˜1.5×1.5 cm²) in 3 steps:
Step 1: ˜0.5 mL of Nafion dispersion (5 wt %, Alcohol based, 1100 EW, Ion Power), 1000 RPM, 60 s solvent evaporation at 60° C. for 10 min.
Step 2: ˜0.5 mL of 2.5 wt % Nafion dispersion (diluted from 5 wt % solution with ethanol), 1000 RPM, 60 s, solvent evaporation at 60° C. for 10 min.
Step 3: ˜0.5 mL of 2.5 wt % Nafion dispersion, 1000 RPM, 60 s, final bake at 60° C. for 30 min resulting in ˜700 nm spin-coated Nafion film (cross-sectional SEM image in FIG. 1C).

The Nafion coated graphene on Cu is pre-etched by floating on 0.2 M APS solution for 10 min, followed by a DI water bath and removal of any graphene on the back side via laboratory wipes. The Cu foil is completely etched in 0.2 M APS solution (˜4 h) and the G|spin-coated-Nafion stack is rinsed by floating it on DI water.

N10 and N211 substrates (˜2×2 cm²) are prepared by adhering to PTFE-coated fiberglass supports (9 mil thickness) via mild hot press (˜130° C., ˜200 PSI, ˜30 s) then used to scoop out the G|Spin-coated-Nafion stack from a DI water bath.

N5 membranes are not hot pressed but rather suspended over a PTFE-coated fiberglass donut (˜½″ OD, ˜⅜″ ID) and then used to scoop out the G|spin-coated-Nafion stack, as the N5 membranes are highly sensitive to hot pressing.

The membranes are dried at ˜60° C. for ˜12 h before adding Pt/C electrodes (˜0.2 mg Pt/cm² on carbon cloth, ˜0.32 cm², Fuel Cell Store) to both sides via hot press (˜140° C., ˜200 psi, ˜1 min).

For the N10|GIN10 sandwich membrane, an additional N10 layer is hot pressed to the N10|G stack (˜140° C., ˜400 psi, ˜1 min) before the electrodes are added. Due to the fragility of the N5 membranes, PTFE-coated-fiberglass gaskets are used to provide support and minimize the formation of tears (FIG. 6B, FIG. 6C).

Areal Proton Conductance, H₂ crossover and fuel cell at room temperature ˜20-25° C. Proton transport through the fabricated membranes is measured at ambient conditions (room temperature and atmospheric pressure) by supplying humidified H₂ gas ˜40 sccm to both sides of the membrane (symmetric H₂ gas feed, humidified through H₂O bubblers) loaded into a custom-built test cell using rubber O-rings to seal and isolate the gas flow on either side of the membrane. Porous Ni foam is used to make electrical contact between the electrodes and graphite current collectors. A Gamry 1010E potentiostat collects linear sweep voltammetry (LSV), sweeping from −100 mV to+100 mV (scan rate 2 mV s-1) while measuring current. Current density is calculated by dividing the measured current by the electrode area (˜0.32 cm²). I-V curves are plotted as potential versus current density (FIG. 2A) and the areal proton conductance is extracted by taking the inverse of the slope using Ohm's law (FIG. 2B).

H₂ crossover is also measured using the same custom-built test cell (per DOE protocol) [A3, A23, A59]. 40 sccm H₂ flows to one electrode (reference/counter electrode) and 40 sccm N₂ to the other (working electrode). Once the open circuit potential is stable (˜90-120 mV), LSV is run from 700 mV to −150 mV (FIG. 2C). H₂ crossover current density is taken at 400 mV (FIG. 2D), as this region is free from effects of the Pt catalyst (i.e. H⁺ adsorption/desorption) and used to compute % reduction relative to the respective controls.

Polarization curves for fuel cell operation in the custom-built test cell were obtained at room temperature while flowing 40 sccm H₂ to one electrode and 120 sccm air to the other (FIG. 4A-FIG. 4F). A 1:3 ratio of H₂:air is used to compensate for the higher oxygen consumption at a specific current compared to hydrogen (per Faraday's law) and mass fraction of O₂ in air (˜23%) [A60]. The potential is swept from 900 mV to 200 mV stepwise (50 mV step size, 60 s per step) [A56, A61]. A break-in step by cycling between 200 mV and 600 mV (60 s hold each, repeat ˜100×) until the current stabilizes is used to condition the membrane [A61, A62]. The additional ˜700 nm thick Nafion layer's influence is evaluated by swapping the H₂/air inlets (FIG. 4D). Power density is calculated by multiplying the current density by the set potential.

Electrochemical impedance spectroscopy (EIS) is used to determine the membrane/contact resistance (HFR, FIG. 8A-FIG. 8D, 20 kHz to 1 Hz, AC voltage 10 mV rms, DC voltage 450 mV, 20 points per decade) from the intersection of the Nyquist plot with the x-axis. The intersection point is estimated by fitting the EIS in the Gamry Analyst software with a fuel cell equivalent circuit. To compare polarization curves without the influence of the high ohmic resistance of the custom-built cell, iR correction is performed by multiplying the HFR obtained from EIS with the measured current at each potential, then adding it to the set potential to obtain an iR corrected voltage which is plotted against current density to obtain an iR corrected polarization curve (FIG. 8A-FIG. 8D and Table 2).

TABLE 2
Calculated iR corrected polarization curves for N211|G
membrane in custom-built cell (active area ~0.32 cm²).
N211|G (~0.32 cm² active area)

| | Resistance | | | |
|---|---|---|---|---|
| | from EIS | | Voltage loss | |
| | (HFR, ohms) | | (iR drop) | iR |
| | 3.31 × 10⁻¹ | Current | between WE | corrected |
| Potential | Current | Density | and RefE | voltage |
| (mV) | (mA) | (mA cm⁻²) | (mV) | (mV) |
| 9.00 × 10² | 5.00 × 10⁻¹ | 1.56 | 1.65 × 10⁻¹ | 9.00 × 10² |
| 8.50 × 10² | 3.11 | 9.72 | 1.03 | 8.51 × 10² |
| 8.00 × 10² | 1.04 × 10 | 3.25 × 10¹ | 3.44 | 8.03 × 10² |
| 7.50 × 10² | 2.48 × 10 | 7.75 × 10¹ | 8.21 | 7.58 × 10² |
| 7.00 × 10² | 4.64 × 10 | 1.45 × 10² | 1.54 × 10¹ | 7.15 × 10² |
| 6.50 × 10² | 7.56 × 10 | 2.36 × 10² | 2.50 × 10¹ | 6.75 × 10² |
| 6.00 × 10² | 1.13 × 10² | 3.52 × 10² | 3.72 × 10¹ | 6.37 × 10² |
| 5.50 × 10² | 1.59 × 10² | 4.97 × 10² | 5.26 × 10¹ | 6.03 × 10² |
| 5.00 × 10² | 2.14 × 10² | 6.67 × 10² | 7.06 × 10¹ | 5.71 × 10² |
| 4.50 × 10² | 2.75 × 10² | 8.58 × 10² | 9.08 × 10¹ | 5.41 × 10² |
| 4.00 × 10² | 3.39 × 10² | 1.06 × 10³ | 1.12 × 10² | 5.12 × 10² |
| 3.50 × 10² | 4.03 × 10² | 1.26 × 10³ | 1.33 × 10² | 4.83 × 10² |
| 3.00 × 10² | 4.65 × 10² | 1.45 × 10³ | 1.54 × 10² | 4.54 × 10² |
| 2.50 × 10² | 5.28 × 10² | 1.65 × 10³ | 1.74 × 10² | 4.24 × 10² |
| 2.00 × 10² | 5.92 × 10² | 1.85 × 10³ | 1.96 × 10² | 3.96 × 10² |
| | | | (Voltage | (Potential + |
| | | | loss = | Voltage |
| | | | iR) | loss) |

The resistance contribution due to the membrane and contact is extracted from the EIS at 450 mV (FIG. 8C) and used to correct for iR drop. Polarization curves are obtained by sweeping from ˜900 mV (OCV) to 200 mV (column 1) and measuring the potential at each step (column 2). The voltage loss due to ohmic resistance (i.e. the Nafion membrane, contact resistance, etc.) (column 4) is calculated by multiplying the HFR by the current at each potential (column 2). The iR corrected voltage (column 5) is calculated by adding the V drop to each potential, then plotting it vs the current density to obtain the iR corrected polarization curve (FIG. 8D).

Conductance modeling. The access resistance to reach the pore from the solution side is calculated as [A63],

$${R}_{T A S} = \frac{1}{2 {D}_{T} {σ}_{S}} \qquad ( 3 )$$

and is half the access resistance for a thin pore with the same medium on either side. Here σ_{S} (S m⁻¹) is the ion conductivity of the solution, and D_{T} (m) is the tear diameter. The resistance for passing through the tear in the graphene is,

$${R}_{T P} = \frac{4 {t}_{G}}{π {σ}_{N} {D}_{T}^{2}} \qquad ( 4 )$$

where t_{G}=6.8 Å is the graphene thickness [A64]. Although the membrane may have a distribution of tear sizes, in this modeling tears were approximated as all having the same effective diameter with the aim of confirming that reasonable values of parameters such as tear size and density can explain the experimental results. The one-dimensional diffusion resistance in the Nafion after a tear is,

$${R}_{T C N} = \frac{{t}_{N}}{{σ}_{N} {L}_{T}^{2}} \qquad ( 5 )$$

where L_{T} [m] is the average spacing between the centers of tears. The tear density can be equivalently expressed either in terms of the average spacing between tears (L_{T}) or the open area fraction occupied by tears (a) of diameter D_{T}, where the two are related by,

$${L}_{T} = \sqrt{\frac{π}{4 a}} {D}_{T} \qquad ( 6 )$$

The spreading resistance within the Nafion away from a tear is approximated from an analytical expression for the spreading resistance from a circular opening at uniform concentration into a circular tube with zero flux on all edges except the opening and the opposite circular face [A65]. These boundary conditions approximate an impermeable graphene layer surrounding the tear and a symmetry condition at the midplane between pores. Although the circular boundary does not match the exact geometry, it provides a reasonable estimate given that the membrane structure parameters used in these calculations are also approximate. The spreading resistance is computed as,

$${R}_{TSN} = \frac{4 {L}_{T}}{π {σ}_{N} {D}_{T}^{2}} {\sum }_{i = 1}^{∞} \frac{1}{{δ}_{i}^{3} {J}_{0}^{2} ( {δ}_{i} )} {J}_{1} ( {δ}_{i} \frac{{D}_{T}}{{L}_{T}} ) sin ( {δ}_{i} \frac{{D}_{T}}{{L}_{T}} ) tanh ( {δ}_{i} \frac{2 {t}_{N}}{{L}_{T}} ) \qquad ( 7 )$$

where J₀ and J₁ are Bessel functions of the first kind of zeroth and first order, respectively, and di are the roots of J₁.

These transport resistances act in series through tears and comprise the left branch in FIG. 3B. The combined resistance to passing from solution on one side, through a tear, to solution on the other side is,

$${R}_{T} = {R}_{TAS} + {R}_{TP} + {R}_{TSN} + {R}_{TCN} \qquad ( 8 )$$

The right branch of FIG. 3B accounts for transport through smaller defects. Every defect will have diameter dependent resistances to accessing the defect from solution (R_{DAS}), getting through the defect (R_{DP}), spreading out from the pore in Nafion (R_{DAN}), then conducting through the Nafion. The access resistance to reach a defect of diameter D [m] from solution is estimated as,

$${R}_{DAS} = \frac{1}{2 D {σ}_{S}} \qquad ( 9 )$$

The resistance to crossing through the defect in graphene is,

$${R}_{DP} = \frac{4 {t}_{G}}{π {σ}_{N} {D}^{2}} \qquad ( 10 )$$

The access resistance to spread from a defect in Nafion is approximated as,

$${R}_{DAN} = \frac{1}{2 D {σ}_{N}} \qquad ( 11 )$$

Conduction in the Nafion from a single defect is approximated as occurring over the average membrane area in which a single defect is found. The average spacing between defects, L_{D} [m], is calculated from the defect density, n [m⁻²], as

$${L}_{D} = \sqrt{1 / n} \qquad ( 12 )$$

The resistance to conduction in Nafion through a single defect is then,

$${R}_{DCN} = \frac{{t}_{N}}{{σ}_{N} {L}_{D}^{2}} \qquad ( 13 )$$

These resistances act in series through a single defect, resulting in a combined resistance through the defect of,

$${R}_{D} ( D ) = {R}_{DS} + {R}_{DP} + {R}_{DAN} + {R}_{DCN} \qquad ( 14 )$$

Which depends on the defect diameter. Defects have a range of sizes, approximated by an exponential distribution,

$$p ( D ) = \frac{1}{\overline{D}} {e}^{- D / \overline{D}} \qquad ( 15 )$$

where p is the probability density for a pore having diameter D, and D̅ is a parameter determining the mean and spread of the distribution [34]. Defects act in parallel, resulting in an average conduction (inverse resistance) through defects of,

$$〈 {R}_{D}^{- 1} 〉 = {\int }_{0}^{∞} \frac{p ( D )}{{R}_{D} ( D )} dD \qquad ( 16 )$$

The net ion conduction through the membrane occurs through tears and defects, which act in parallel. Adding the multiple parallel tears and defects results in an areal conductance of,

$$\frac{G}{A} = \frac{1}{RA} = \frac{{R}_{T}^{- 1}}{{L}_{T}^{2}} + n ( 1 - a ) 〈 {R}_{D}^{- 1} 〉 \qquad ( 17 )$$

where G [S] is the total membrane conductance and R [Ω] is the total membrane resistance.

The model is extended to membranes that have Nafion on both sides of the graphene by changing the access resistances in solution to the access and one-dimensional conduction resistances in Nafion (FIG. 3C),

$${R}_{T} = {R}_{TP} + 2 {R}_{TSN} + 2 {R}_{TCN} \qquad ( 18 )$$

$$and$$

$${R}_{D} ( D ) = {R}_{DP} + 2 {R}_{DAN} + 2 {R}_{DCN} \qquad ( 19 )$$

Equation 18 and Equation 19 replace Equation 8 and Equation 14 in Equation 16 and Equation 17 when computing the areal conductance of membranes with Nafio on both sides of the graphene.

### Membrane Performance in Fuel Cell at 80° C. and Different Pressures (150 and 250 kPa-abs)

Membrane Electrode Assembly (MEA) Preparation: The transferred graphene layer is increased to ˜2 cm², with active area ˜1 cm². The layered graphene membranes are then loaded into the cell and run at 100% RH, 80° C., and at 150 kPa-abs and 250 kPa-abs.

The decal transfer method was used to prepare MEAs with active area ˜1 cm². Catalyst inks for both the anode and cathode were prepared by dispersing Pt/Vulcan catalyst (TEC10V40E, Tanaka Kikinzoku Kogyo K.K., TKK) in a low equivalent weight perfluorosulfonic acid (PFSA) ionomer (3 M, 725 EW). The ionomer-to-carbon (I/C) ratio was maintained at 0.8, while the solid-to-liquid (S/L) ratio was adjusted to 0.1 by adding a mixture of isopropanol (IPA) and ultra-pure water to ensure proper dispersion and optimal ink formulation. The ink components were placed in a 15 mL capped HDPE bottle containing ZrO₂ beads (Glenn Mills, USA) as a grinding medium. The mixture was then processed on a roller mill at 70 RPM for 18 h at room temperature to achieve thorough homogenization.

To create the catalyst-coated decal (CCD), the homogenized catalyst ink was coated onto a virgin PTFE sheet using an automatic film coater (MSK AFA-II, MTI Corporation, USA) fitted with a doctor blade. The coating process was carried out at a controlled speed of 10 mm s⁻¹ to ensure uniform deposition. The platinum loading on the cathode and anode electrodes was approximately 0.25 mg_{Pt} cm⁻²_{geo}, calculated based on the Pt content of the catalyst, I/C of 0.8 and weighing the decals before and after the hot-press process. The catalyst-coated membrane (CCM) with a geometrical area of 1 cm² on both the anode and cathode was controlled by a Kapton window created by hot-pressing the CCD against the Nafion-211 and Nafion-211|G|spin-coated Nafion membrane at 150° C. for 3 min with an applied force of 0.12 kN cm⁻².

Fuel cell testing: Fuel cell testing utilized a Biologic SP-200 potentiostat and a 100 W G20 Greenlight Innovation test station (Greenlight Innovation Corp., Canada). Electrochemical measurements were conducted using single-cell equipment sourced from Fuel Cell Technologies Inc. (USA), featuring a 50 cm² geometric graphite flow field with a 16 cm² channel area.

To achieve approximately 25% compression of the Gas Diffusion Layer (GDL) with microporous layer (MPL) (1.5 cm×1.5 cm on both sides), the hot-pressed Catalyst-Coated Membrane (CCM) was positioned between two GDLs containing a microporous layer (250 μm, Toray, TGP-H-060; Fuel Cell Store, USA) and guided by a 175 μm PTFE gasket. To prevent degradation at the edges and to independently control the compression of the catalyst layer and the gas diffusion layer containing the microporous layer (GDL/MPL), the GDL/MPL area was intentionally designed to be larger than the active area of the CCM. During cell assembly, a torque of 30 in-lb was applied in three steps (10 in-lb, 20 in-lb, and 30 in-lb).

Conditioning protocol: Before testing, all cells underwent conditioning to activate the MEA, hydrate the ionic network, and eliminate potential contamination. The conditioning protocol employed in this study combines elements from the USFCC [A66], DOE [A67], and NREL (USA) [A68]. Specifically, it involves H₂ pumping [A69], a constant voltage hold at 0.6 V from UFSCC [A66], and a potential cycling conditioning protocol (OCV to 0.6 V) similar to DOE [A67] (Table 1). The complete conditioning protocol is outlined in the table below, while a detailed description of each step can be found in prior publications [A70].

TABLE 1
Summary of the conditioning protocol.

| | | Inlet | Dew Point | | Flowrate | Reactant | Absolute | |
|---|---|---|---|---|---|---|---|---|
| | | Temperature | Temperature | RH | An/Ca | gas | Pressure | Duration |
| Step | Name | (° C.) | (° C.) | (%) | (NLPM) | An/Ca | (kPa) | (hours) |
| 1 | H² | 30 | 45 | ~226 | 0.5/0.5 | H₂/H₂ | 90 | 0.5 |
| | pumping | | | | | | | |
| | (Current | | | | | | | |
| | applied: | | | | | | | |
| | 200 mA | | | | | | | |
| | cm⁻²) | | | | | | | |
| 2 | Flooding | 70 | 80 | ~150 | 0.1/0.2 | H₂/N₂ | 150 | 8 |
| 3 | 0.6 V | 80 | 80 | 100 | 0.3/0.5 | H₂/O₂ | 300 | ~12 |
| | hold | | | | | | | |
| 4 | Potential | 80 | 80 | 100 | 0.3/0.5 | H₂/O₂ | 150 | Until the |
| | Cycling | | | | | | | last two |
| | (OCV - | | | | | | | measured |
| | 0.6 V) | | | | | | | current |
| | | | | | | | | values are |
| | | | | | | | | less than |
| | | | | | | | | 10 mA/cm² |

ECSA determination by CO-Stripping voltammetry: CO-Stripping voltammetry was conducted following a protocol similar to that described by Takeshita et al. [A71] at 80° C., 100% RH, and ambient pressure. Prior to testing, the cathode was cleaned by potential cycling between 0.115 V vs. RHE and 0.94 V vs. RHE at a scan rate of 50 mV s⁻¹. CO-Stripping was performed by supplying 0.2 NLPM of a humidified mixture containing 5% CO with N₂ on the cathode and 0.05 NLPM of 10% H₂ with N₂ on the anode. The low percentage of hydrogen on the anode side is to minimize H₂ crossover, which could introduce significant artifacts to the data [A72]. During flow conditioning, the cathode was held at 0.08 V vs. RHE for 20 minutes, followed by a 45 min purge with N₂ on both the cathode and anode to remove any residual CO. Subsequently, the cathode potential was scanned from OCV to 0.94 V vs. RHE at a scan rate of 20 mV s⁻¹ and held at the final potential to oxidatively strip all electrochemically available CO adsorbed on the Pt surface under the flow of N₂. The scanning process was repeated three times to serve as a baseline and to verify complete oxidation of the adsorbed CO (FIG. 9). The integration between the first anodic scan and the third scan was used to determine the Pt ECSA using a specific charge of 420 μC cm⁻²ₚₜ.

H₂ crossover: Electrochemical H₂ crossover was assessed via linear sweep voltammetry (LSV) with the anode and cathode pressures maintained at 150/250 kPa-abs under H₂/N₂ (0.1/0.2 NLPM) conditions at 80° C., 100% RH. The LSV scan ranged from 0.05 V vs. RHE to 0.6 V vs. RHE at a scan rate of 5 mV s⁻¹. To avoid shorting between the anode and cathode, the current was monitored until it reached a steady state between 0.4 V vs. RHE and 0.6 V vs. RHE. The current measured at 0.4 V vs. RHE was then utilized to determine the hydrogen crossover current.

Polarization curves: Differential flow polarization curves were generated using potentiostatic mode scanning from Open Circuit Voltage (OCV) to 0.8 V to determine kinetic parameters. The kinetic current was recorded over a 2 min period by maintaining a specific voltage within the aforementioned range, with the voltage decreasing in approximately ˜20 mV decrements. Subsequently, the remaining current was recorded from 0.8 V vs. RHE to 0.1 V vs. RHE (until limiting current), with a step size of 0.1 V. All experiments were conducted at 80° C., 100% RH, with a backpressure of either 150 or 250 kPa-abs. A constant flow of 0.3 NLPM of H₂ was maintained on the anode, while 0.5 NLPM of either pure O₂ or air was supplied to the cathode, with no pressure drop between the anode and cathode. Each polarization point was allowed to stabilize at a specific applied voltage for 3 min, and the resulting equilibrated current values were averaged over the final 30 s.

### References

(A1) Bukola, S.; Creager, S. E. Graphene-Based Proton Transmission and Hydrogen Crossover Mitigation in Electrochemical Hydrogen Pump Cells. ECS Trans 2019, 92 (8), 439-444. https://doi.org/10.1149/09208.0439ecst.
(A2) Chen, J et al. The Performance and Durability of High-Temperature Proton Exchange Membrane Fuel Cells Enhanced by Single-Layer Graphene. Nano Energy 2022, 93, 106829. https://doi.org/10.1016/J.NANOEN.2021.106829.
(A3) Mochring, N. K. et al. Kinetic Control of Angstrom-Scale Porosity in 2D Lattices for Direct Scalable Synthesis of Atomically Thin Proton Exchange Membranes. ACS Nano 2022, 16 (10), 16003-16018.
(A4) Yan, X. H. et al. A Monolayer Graphene—Nafion Sandwich Membrane for Direct Methanol Fuel Cells. J Power Sources 2016, 311, 188-194.
(A5) Holmes, S. M et al. 2D Crystals Significantly Enhance the Performance of a Working Fuel Cell. Adv Energy Mater 2017, 7 (5), 1-7.
(A6) Chen, Q et al. Graphene Enhances the Proton Selectivity of Porous Membrane in Vanadium Flow Batteries. Mater Des 2017, 113, 149-156.
(A7) Bukola, S et al. Single-Layer Graphene as a Highly Selective Barrier for Vanadium Crossover with High Proton Selectivity. Journal of Energy Chemistry 2021, 59, 419-430.
(A8) Bukola, S et al. Single-Layer Graphene Sandwiched between Proton-Exchange Membranes for Selective Proton Transmission. ACS Appl Nano Mater 2019, 2 (2), 964-974.
(A9) Lozada-Hidalgo, M et al. Scalable and Efficient Separation of Hydrogen Isotopes Using Graphene-Based Electrochemical Pumping. Nat Commun 2017, 8 (1), 15215.
(A10) Gittleman C S et al. Materials Research and Development Focus Areas for Low Cost Automotive Proton-Exchange Membrane Fuel Cells. Curr Opin Electrochem 2019, 18, 81-89. https://doi.org/10.1016/j.coclec.2019.10.009.
(A11) Metzger, N et al. Experimental Studies of Graphene-Coated Polymer Electrolyte Membranes for Direct Methanol Fuel Cells. Journal of Electrochemical Energy Conversion and Storage 2023, 20 (2). https://doi.org/10.1115/1.4056269/1150877.
(A12) Kidambi, P. R et al. Subatomic Species Transport through Atomically Thin Membranes: Present and Future Applications. Science (1979) 2021, 374 (cabd7687).
(A13) Shi, L et al. Theoretical Understanding of Mechanisms of Proton Exchange Membranes Made of 2D Crystals with Ultrahigh Selectivity. Journal of Physical Chemistry Letters 2017, 8 (18), 4354-4361. https://doi.org/10.1021/acs.jpclett.7b01999.
(A14) Bukola, S et al. Selective Proton/Deuteron Transport through Nafion|Graphene|Nafion Sandwich Structures at High Current Density. J Am Chem Soc 2018, 140 (5), 1743-1752. https://doi.org/10.1021/jacs.7b10853.
(A15) Chaturvedi, P et al. Ionic Conductance through Graphene: Assessing Its Applicability as a Proton Selective Membrane. ACS Nano 2019, 13 (10), 12109-12119.
(A16) Walker, M. I et al. Measuring the Proton Selectivity of Graphene Membranes. Appl Phys Lett 2015, 107 (21), 213104. https://doi.org/10.1063/1.4936335.
(A17) Achtyl, J. L et al. Aqueous Proton Transfer across Single-Layer Graphene. Nat Commun 2015, 6 (1), 1-7. https://doi.org/10.1038/ncomms7539.
(A18) Hu, S et al. Proton Transport through One-Atom-Thick Crystals. Nature 2014, 516 (7530), 227-230. https://doi.org/10.1038/nature 14015.
(A19) Bunch, J. S et al. Impermeable Atomic Membranes from Graphene Sheets. Nano Lett 2008, 8 (8), 2458-2462. https://doi.org/10.1021/n1801457b.
(A20) Qi, H et al. Fabrication of Sub-Nanometer Pores on Graphene Membrane for Ion Selective Transport. Nanoscale 2018, 10 (11), 5350-5357. https://doi.org/10.1039/c8nr00050f.
(A21) K. S. Novoselov eta 1. Electric Field Effect in Atomically Thin Carbon Films. Phys. Rev. Lett 2004, 306 (5696), 666-669.
(A22) Komma, M et al. Applicability of Single-Layer Graphene as a Hydrogen-Blocking Interlayer in Low-Temperature PEMFCs. ACS Appl Mater Interfaces 2024. https://doi.org/10.1021/acsami.4c01254.
(A23) Yoon, S. I et al. AA′-Stacked Trilayer Hexagonal Boron Nitride Membrane for Proton Exchange Membrane Fuel Cells. ACS Nano 2018, 12 (11), 10764-10771. https://doi.org/10.1021/acsnano.8b06268.
(A24) Bukola, S et al. Graphene-Based Proton Transmission and Hydrogen Crossover Mitigation in Electrochemical Hydrogen Pump Cells. ECS Trans 2019, 92 (8), 439-444. https://doi.org/10.1149/09208.0439ecst.
(A25) Kutagulla, S et al. Comparative Studies of Atomically Thin Proton Conductive Films to Reduce Crossover in Hydrogen Fuel Cells. ACS Appl Mater Interfaces 2023, 15 (51), 59358-59369. https://doi.org/10.1021/acsami.3c12650.
(A26) Kim, T et al. Monolayer Hexagonal Boron Nitride Nanosheets as Proton-Conductive Gas Barriers for Polymer Electrolyte Membrane Water Electrolysis. ACS Appl Nano Mater 2021, 4 (9), 9104-9112. https://doi.org/10.1021/acsanm.1c01691.
(A27) Lee, S et al. Rational Design of Ultrathin Gas Barrier Layer via Reconstruction of Hexagonal Boron Nitride Nanoflakes to Enhance the Chemical Stability of Proton Exchange Membrane Fuel Cells. Small 2019, 15 (44), 1-9. https://doi.org/10.1002/smll.201903705.
(A28) Chen, J et al. The Performance and Durability of High-Temperature Proton Exchange Membrane Fuel Cells Enhanced by Single-Layer Graphene. Nano Energy 2022, 93 (November 2021), 106829. https://doi.org/10.1016/j.nanoen.2021.106829.
(A29) Khan, A et al. Proton Conductivity of Graphene-Based Polymer Electrolyte Membrane. ECS Trans 2015, 69 (17), 569-577. https://doi.org/10.1149/06917.0569ecst.
(A30) Bentley, C. L et al. High-Resolution Ion-Flux Imaging of Proton Transport through Graphene|Nafion Membranes. ACS Nano 2022, 16 (4), 5233-5245.
(A31) Paneri, A et al. Proton Selective Ionic Graphene-Based Membrane for High Concentration Direct Methanol Fuel Cells. J Memb Sci 2014, 467, 217-225.
(A32) Chaturvedi, P et al. Deconstructing Proton Transport through Atomically Thin Monolayer CVD Graphene Membranes. J Mater Chem A Mater 2022, 10 (37), 19797-19810.
(A33) Koenig, S. P. et al. Selective Molecular Sieving through Porous Graphene. Nat Nanotechnol 2012, 7 (11), 728-732. https://doi.org/10.1038/nnano.2012.162.
(A34) O'Hern, S. C. et al. Selective Molecular Transport through Intrinsic Defects in a Single Layer of CVD Graphene. ACS Nano 2012, 6 (11), 10130-10138.
(A35) Kidambi, P. R. et al. Selective Nanoscale Mass Transport across Atomically Thin Single Crystalline Graphene Membranes. Advanced Materials 2017, 29 (19), 1605896. https://doi.org/10.1002/adma.201605896.
(A36) Cheng, P. et al. Nanoporous Atomically Thin Graphene Filters for Nanoscale Acrosols. ACS Appl Mater Interfaces 2022, 14 (36), 41328-41336. https://doi.org/10.1021/ACSAMI.2C10827/SUPPL_FILE/AM2C10827_SI_001.PDF.
(A37) Kidambi, P. R. et al. Assessment and Control of the Impermeability of Graphene for Atomically Thin Membranes and Barriers. Nanoscale 2017, 9 (24), 8496-8507. https://doi.org/10.1039/C7NR01921A.
(A38) Kidambi, P. R. et al. Facile Fabrication of Large-Area Atomically Thin Membranes by Direct Synthesis of Graphene with Nanoscale Porosity. Advanced Materials 2018, 30 (49), 1-10. https://doi.org/10.1002/adma.201804977.
(A39) Cheng, P. et al. Facile Size-Selective Defect Sealing in Large-Area Atomically Thin Graphene Membranes for Sub-Nanometer Scale Separations. Nano Lett 2020, 20 (8), 5951-5959.
(A40) Kidambi, P. R. et al. The Parameter Space of Graphene Chemical Vapor Deposition on Polycrystalline Cu. Journal of Physical Chemistry C 2012, 116 (42), 22492-22501. https://doi.org/10.1021/jp303597m.
(A41) Kidambi, P. R. et al. Observing Graphene Grow: Catalyst-Graphene Interactions during Scalable Graphene Growth on Polycrystalline Copper. Nano Lett 2013, 13 (10), 4769-4778. https://doi.org/10.1021/n14023572.
(A42) Kidambi, P. R. et al. A Scalable Route to Nanoporous Large-Area Atomically Thin Graphene Membranes by Roll-to-Roll Chemical Vapor Deposition and Polymer Support Casting. ACS Appl Mater Interfaces 2018, 10 (12), 10369-10378.
(A43) Kobayashi, T. et al. Production of a 100-m-Long High-Quality Graphene Transparent Conductive Film by Roll-to-Roll Chemical Vapor Deposition and Transfer Process. Appl Phys Lett 2013, 102 (2), 023112. https://doi.org/10.1063/1.4776707.
(A44) Griffin, E. et al. Proton and Li-Ion Permeation through Graphene with Eight-Atom-Ring Defects. ACS Nano 2020, 14 (6), 7280-7286. https://doi.org/10.1021/acsnano.0c02496.
(A45) Kidambi, P. R. et al. Nanoporous Atomically Thin Graphene Membranes for Desalting and Dialysis Applications. Advanced Materials 2017, 29 (33), 1700277. https://doi.org/10.1002/ADMA.201700277.
(A46) Mogg, L. et al. Perfect Proton Selectivity in Ion Transport through Two-Dimensional Crystals. Nat Commun 2019, 10 (1), 4243. https://doi.org/10.1038/s41467-019-12314-2.
(A47) Mochring, N. K. et al. Ultra-Thin Proton Conducting Carrier Layers for Scalable Integration of Atomically Thin 2D Materials with Proton Exchange Polymers for next-Generation PEMs. Nanoscale 2024, 16 (14), 6973-6983. https://doi.org/10.1039/D3NR05202H.
(A48) El Boukari, M. et al. Application of Raman Spectroscopy to Industrial Membranes. Part 1-Polyacrylic Membranes. Journal of Raman Spectroscopy 1990, 21 (11), 755-759. https://doi.org/10.1002/jrs.1250211109.
(A49) Tang, B. et al. Raman Spectroscopic Characterization of Graphene. Appl Spectrosc Rev 2010, 45 (5), 369-407. https://doi.org/10.1080/05704928.2010.483886.
(A50) Ferrari, A. C. et al. Raman Spectroscopy as a Versatile Tool for Studying the Properties of Graphene. Nature Nanotechnology 2013 8:4 2013, 8 (4), 235-246.
(A51) Ferreira, R. B. et al. Experimental Study on the Membrane Electrode Assembly of a Proton Exchange Membrane Fuel Cell: Effects of Microporous Layer, Membrane Thickness and Gas Diffusion Layer Hydrophobic Treatment. 2016. https://doi.org/10.1016/j.electacta.2016.12.074.
(A52) Liu, W. et al. Experimental Study of Proton Exchange Membrane Fuel Cells Using Nafion 212 and Nafion 211 for Portable Application at Ambient Pressure and Temperature Conditions. Int J Hydrogen Energy 2012, 37 (5), 4673-4677.
(A53) Chaturvedi, P. et al. The Parameter Space for Scalable Integration of Atomically Thin Graphene with Nafion for Proton Exchange Membrane (PEM) Applications. Mater Adv 2023, 4 (16), 3473-3481. https://doi.org/10.1039/D3MA00180F.
(A54) Islam, M. N. et al. Designing Fuel Cell Catalyst Support for Superior Catalytic Activity and Low Mass-Transport Resistance. Nat Commun 2022, 13 (1), 1-11.
(A55) Waldrop, K. et al. Electrospun Particle/Polymer Fiber Electrodes with a Neat Nafion Binder for Hydrogen/Air Fuel Cells. ECS Trans 2019, 92 (8), 595-602.
(A56) Waldrop, K. et al. Electrospun Nanofiber Electrodes for High and Low Humidity PEMFC Operation. J Electrochem Soc 2023, 170 (2), 024507.
(A57) Powers, D. et al. Electrospun Tri-Layer Membranes for H2/Air Fuel Cells. J Memb Sci 2019, 573, 107-116. https://doi.org/10.1016/j.memsci.2018.11.046.
(A58) Cheng, P. et al. Scalable Synthesis of Nanoporous Atomically Thin Graphene Membranes for Dialysis and Molecular Separations via Facile Isopropanol-Assisted Hot Lamination. Nanoscale 2021, 13 (5), 2825-2837. https://doi.org/10.1039/DONR07384A.
(A59) Inaba, M. et al. Gas Crossover and Membrane Degradation in Polymer Electrolyte Fuel Cells. Electrochim Acta 2006, 51 (26), 5746-5753.
(A60) Barbir, F. Vehicles with Hydrogen-Air Fuel Cells. In Energy carriers and conversion systems with emphasis . . . ; 2009; Vol. II.
(A61) Slack, J. J. et al. Impact of Polyvinylidene Fluoride on Nanofiber Cathode Structure and Durability in Proton Exchange Membrane Fuel Cells. J Electrochem Soc 2020, 167 (5), 054517. https://doi.org/10.1149/1945-7111/ab77fb.
(A62) Van Der Linden, F. et al. A Review on the Proton-Exchange Membrane Fuel Cell Break-in Physical Principles, Activation Procedures, and Characterization Methods. Journal of Power Sources. 2023, p 233168. https://doi.org/10.1016/j.jpowsour.2023.233168.
(A63) Suk, M. E.; Aluru, N. R. Ion Transport in Sub-5-Nm Graphene Nanopores. J Chem Phys 2014, 140 (8), 084707. https://doi.org/10.1063/1.4866643.
(A64) Rollings, R. C. et al. Ion Selectivity of Graphene Nanopores. Nat Commun 2016, 7 (1), 11408. https://doi.org/10.1038/ncomms11408.
(A65) W. M. Rohsenow, J. P. Hartnett, E. N. G. Handbook of Heat Transfer Fundamentals; 1992; Vol. 1.
(A66) Fuel Cell Council, U. USFCC Single Cell Test Protocol #05-014; 2006. http://www.members.fchea.org/core/import/PDFs/Technical Resources/MatComp Single Cell Test Protocol 05-014RevB.2 071306.pdf (accessed 2024 Jul. 28).
(A67) Balogun, E.; Barnett, A. O.; Holdcroft, S. Cathode Starvation as an Accelerated Conditioning Procedure for Perfluorosulfonic Acid Ionomer Fuel Cells. Journal of Power Sources Advances 2020, 3 (May), 100012. https://doi.org/10.1016/j.powera.2020.100012.
(A68) Kabir, S. et al. Elucidating the Dynamic Nature of Fuel Cell Electrodes as a Function of Conditioning: An Ex Situ Material Characterization and in Situ Electrochemical Diagnostic Study. ACS Appl Mater Interfaces 2019, 11 (48), 45016-45030.
(A69) U.S. Pat. No. 6,730,424B1
(A70) Basha, A. B. M.; Karan, K. Understanding Potential Decay during OCV Hold via Dry Recovery Process. J Electrochem Soc 2023, 170 (6), 064505. https://doi.org/10.1149/1945-7111/acd724.
(A71) Takeshita, T. et al. Evaluation of Ionomer Coverage on Pt Catalysts in Polymer Electrolyte Membrane Fuel Cells by CO Stripping Voltammetry and Its Effect on Oxygen Reduction Reaction Activity. Journal of Electroanalytical Chemistry 2020, 871, 114250.
(A72) Garrick, T. R. et al. Editors' Choice—Electrochemically Active Surface Arca Measurement of Aged Pt Alloy Catalysts in PEM Fuel Cells by CO Stripping. J Electrochem Soc 2017, 164 (2), F55-F59. https://doi.org/10.1149/2.0381702jes.
(A73) Génevé, T. et al. Voltammetric Methods for Hydrogen Crossover Diagnosis in a PEMFC Stack. Fuel Cells 2017, 17 (2), 210-216. https://doi.org/10.1002/fuce.201600073.

### Example 4

### Ultra-Thin Proton Conducting Carrier Layers for Scalable Integration of Atomically Thin 2D Materials With Proton Exchange Polymers for Next-Generation PEMs

Abstract. Scalable approaches for synthesis and integration of proton selective atomically thin 2D materials with proton conducting polymers can enable next-generation proton exchange membranes (PEMs) with minimal crossover of reactants or undesired species while maintaining adequately high proton conductance for practical applications. Here, facile and scalable approaches to interface monolayer graphene synthesized via scalable chemical vapor deposition (CVD) on Cu foil with the most widely used proton exchange polymer Nafion 211 (N211, ˜25 μm thick film) via (i) spin-coating a ˜700 nm thin Nafion carrier layer to transfer graphene (spin+scoop), (ii) casting a Nafion film and cold pressing (cold press), and (iii) hot pressing (hot press) while minimizing micron-scale defects to <0.3% area are systematically investigated. Interfacing CVD graphene on Cu with N211 via cold press or hot press and subsequent removal of Cu via etching results in ˜50% lower areal proton conductance compared to membranes fabricated via the spin+scoop method. Notably, the areal proton conductance can be recovered by soaking the hot and cold press membranes in 0.1 M HCl, without significant damage to graphene. These findings are rationalized by the significantly smaller reservoir for cation uptake from Cu etching for the ˜700 nm thin carrier Nafion layer used for spin+scoop transfer compared to the ˜25 μm thick N211 film for hot and cold pressing. Finally, performance is demonstrated in H₂ fuel cells with power densities of ˜0.23 W cm⁻² and up to ˜41-54% reduction in H₂ crossover for the N211|G|N211 sandwich membranes compared to the control N211|N211, indicating potential for this approach in enabling advanced PEMs for fuel cells, redox-flow batteries, isotope separations and beyond.

Introduction. The pristine lattice of atomically thin 2D materials such as graphene and hexagonal boron nitride (h-BN) allows for electric-field driven permeation of protons, while maintaining impermeability to atoms and larger ions [B1-B12]. Such selective proton transport through 2D materials presents potential for enabling next-generation proton exchange membranes (PEMs) with minimal crossover of reactants or undesired species, thereby providing avenues to address persistent issues in conventional state-of-the-art proton conducting polymers (e.g., Nafion) [B1-B12].

Practical applications necessitate large area 2D material synthesis as well as facile integration approaches for realizing functional devices [B13-B20]. In this context, chemical vapor deposition (CVD) has emerged as the most promising approach for large area 2D material synthesis [B21-B24]. However, bottom-up synthesis via CVD inevitably introduces intrinsic defects into the 2D lattice [B25, B26]. Intrinsic defects can enhance proton transport through 2D materials, but large intrinsic defects may also allow permeation of undesired species [B11-B15]. Interfacing 2D materials with conventional state-of-the-art proton conducting polymers allows for synergistic advantages of reduced crossover (2D materials reduce crossover) while retaining high proton conductance (via intrinsic defects in 2D materials) by leveraging the low probability of large, non-selective defects in 2D materials aligning perfectly with pores/water channels of the Nafion support [B10-B12, B27, B28]. Hence, the development of a facile and scalable approach to integrate 2D materials with Nafion is imperative [B10-B12, B27, B28].

Hot pressing proton conducting polymers (e.g., Nafion) directly onto CVD graphene grown on Cu foil, has been explored in prior studies and optimized to enable large area graphene transfer for applications in fuel cell, redox flow batteries, isotope separations and beyond [B2, B7, B11, B29]. However, oxidation of the Cu underneath defects in graphene can cause damage to graphene compromising selectivity, necessitating new approaches [B29].

Here, scalable approaches in addition to hot press are systematically explored to interface atomically thin CVD graphene with one of the most widely used PEM (i.e., Nafion 211) (N211, ˜25 μm thick film). Specifically, casting a Nafion film on graphene on Cu foil followed by room-temperature pressing (cold press) to a N211 layer as well as a spin-coated ˜700 nm thin Nafion carrier layer (spin+scoop) to transfer graphene on N211 are leveraged to minimize micron-scale defects to <0.3% area (˜88% less than conventional hot press transfer method). Graphene transfer via cold press or hot press results in ˜50% lower areal proton conductance compared to membranes fabricated via the spin+scoop method, but the areal proton conductance is recovered by soaking the membranes in 0.1 M HCl. The important role of the significantly smaller reservoir for cation (Cu and ammonium ions) uptake from Cu etching [B2, B11, B30, B31] for the ˜700 nm thin carrier Nafion layer used for spin+scoop transfer compared to the ˜25 μm thick N211 film for hot and cold press is highlighted and PEMs for H₂ fuel cells are demonstrated with power densities ˜0.23 W cm⁻² and up to ˜41-54% reduction in H₂ crossover compared to bare Nafion control PEMs.

### Experimental Methods

Graphene synthesis and characterization. Graphene is synthesized via low pressure chemical vapor deposition (CVD) in a custom-built, 1″ diameter tube furnace reactor [B7, B11, B15-B21, B23, B29, B32]. In brief, Cu foil (HA, 18 μm thickness, JX Holdings) is cleaned via sonication in ˜20% Nitric Acid followed by DI water wash and air drying [B11]. The Cu foil is heated to ˜1060° C. and annealed under 100 sccm H₂ for 45 minutes, then 300 sccm for an additional 15 minutes [B11]. While maintaining a H₂ flow rate of 300 sccm, the graphene growth is initiated by introducing methane via a two-step process to ensure a complete film: step 1 (0.5 sccm CH₄ for 45 minutes), step 2 (1 sccm of CH4 for an additional 30 min) [B11]. The system is quench cooled while still flowing the reaction gases until the temperature reaches <100° C.

Raman spectroscopy of graphene after transfer to 300 nm SiO₂/Si (University Wafers) using poly(methyl) methacrylate (PMMA) carrier layer is used to determine the resulting graphene quality [B7, B11, B32]. 2 wt % PMMA (Acros Organics, 35 000 M.W.) in Anisole (BeanTown Chemical, 99%) is drop casted on the graphene on Cu foil, dried, then the Cu foil etched in 0.2 M ammonium persulfate (APS, Acros Organics, ACS reagent grade, (98+%)). Once fully etched, the graphene/PMMA stack is rinsed with DI water then scooped onto SiO₂/Si wafers and dried before the PMMA is removed with acetone and rinsed with isopropanol. Raman spectra are collected using a Thermoscientific DXR Raman Microscope (532 nm, 1 Mw laser, spot size ˜1.1 μm). For Raman of graphene already transferred to Nafion, the laser power was increased to 3 mW to improve the signal to noise ratio.

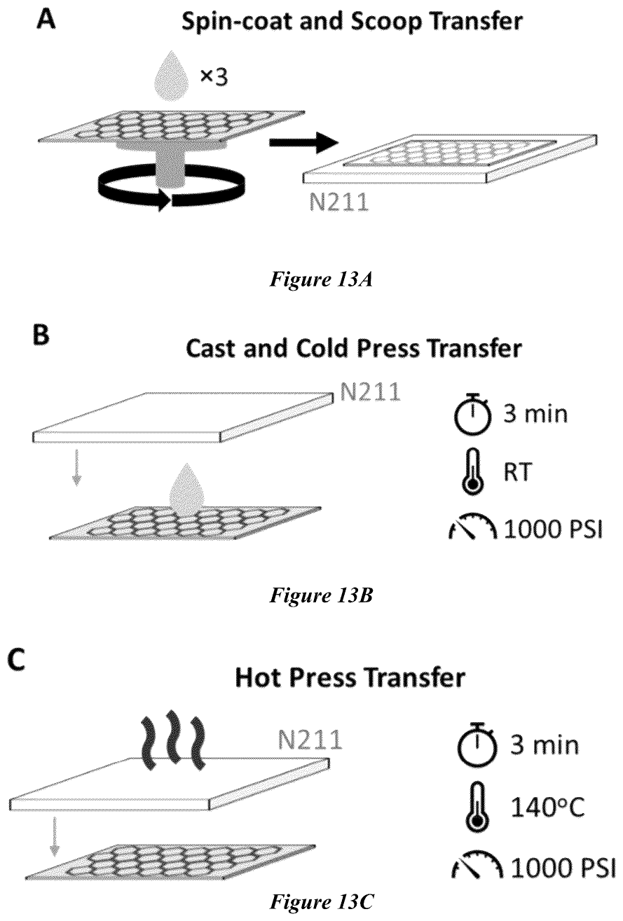

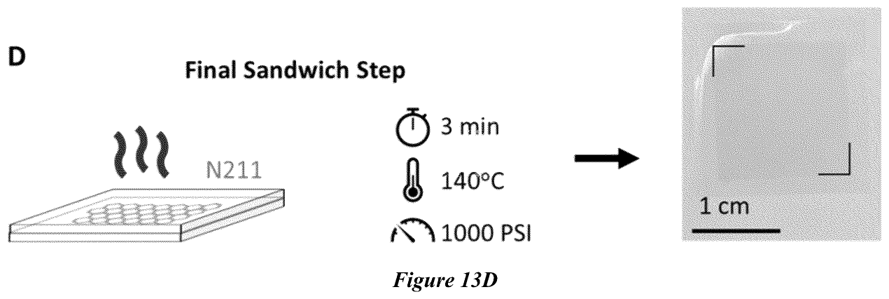

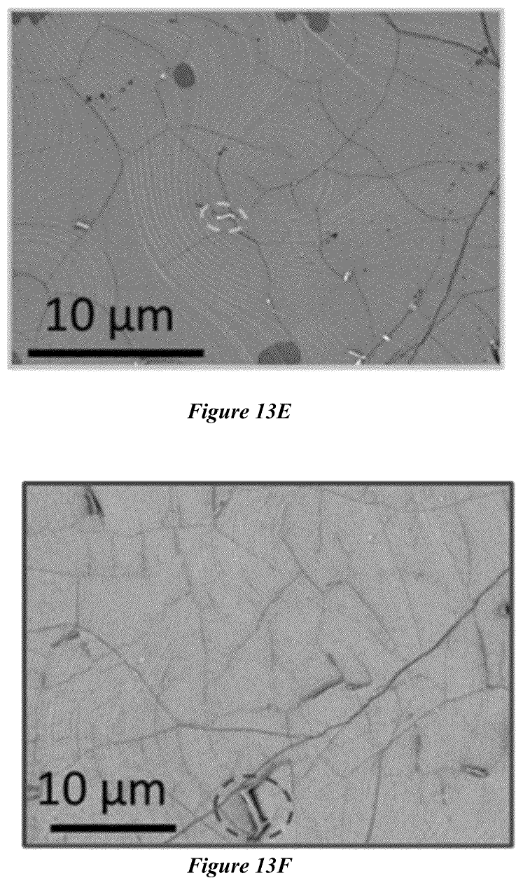

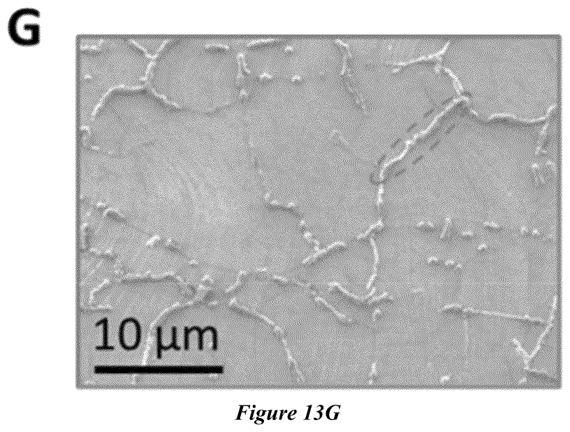

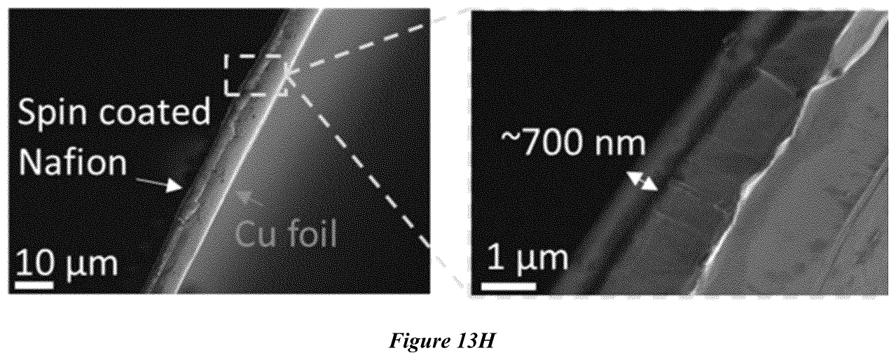

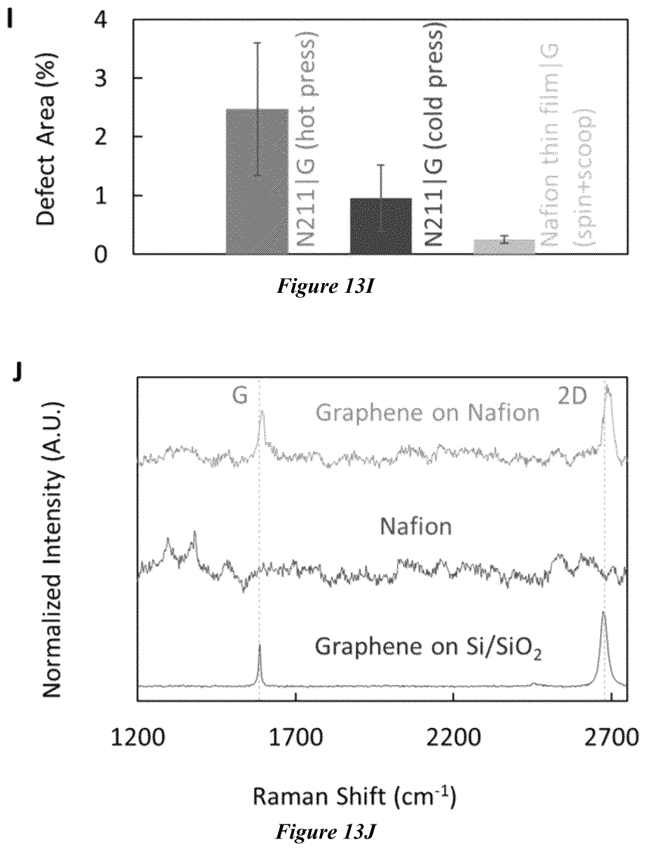

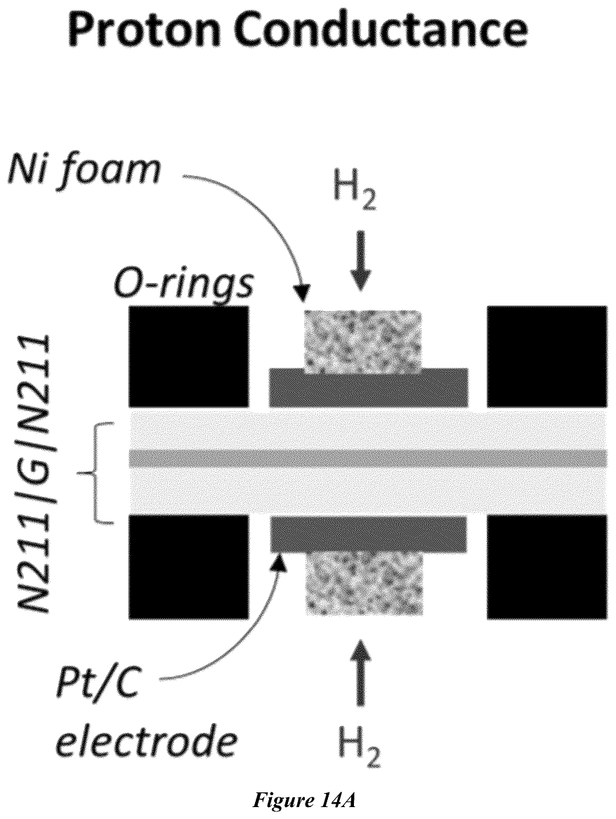

Proton exchange membrane (PEM) fabrication. Graphene is transferred to H⁺ form Nafion 211 (N211, 25 μm thickness, Ion Power) using three distinct methods (FIG. 13A-FIG. 13J): (i) hot press, (ii) cast and cold press (referred to as cold press), and (iii) spin-coat and scoop (referred to as spin+scoop). Hot press: graphene on Cu foil is pressed to Nafion by sandwiching it between two sheets of PTFE-coated fiberglass sheets (McMaster Carr, ˜10 mil thickness) at ˜140° C. under 1000 psi for 3 minutes [B7, B11, B29]. Cold press: a thin layer of Nafion (1 wt % Nafion solution, 1100 EW—equivalent weight of Nafion in alcohol, Ion Power) is casted (via drop-casting or spin-coating) on CVD graphene on Cu before pressing N211 via sandwiching between the PTFE-coated fiberglass sheets at room temperature under 1000 psi for 3 minutes. Spin+scoop: Graphene on Cu foil is coated with a thin Nafion film via spin-coating. Three layers of Nafion are spin-coated (1000 rpm, 60 seconds) and dried to create a film strong enough to maintain structural integrity during the transfer process. The first layer comprises 5 wt % Nafion solution while the second 2 layers are 1 wt % Nafion solution. For each layer, ˜0.1 mL of Nafion solution is added and the sample spun for 60 seconds at 1000 RPM. Between each step, the film is dried at ˜60° C. for ˜10 minutes and a final drying time of ˜30 minutes. The resulting film thickness is ˜700 nm (see FIG. 13H).

Next, the Cu foil is etched using ammonium persulfate (APS) solution. An initial ˜10 min etch in 0.2 M APS, followed by ˜10 min float in DI water rinse is repeated twice to ensure that graphene on the bottom side of the Cu foil is removed before floating on ˜0.2 M APS for ˜3 hours to fully etch the Cu foil, after which the sample is rinsed in a series of DI water baths. For the hot press and cold press methods, the samples are dried, then the second layer of Nafion is added by hot pressing at 140° C. under 1000 PSI for 3 minutes to result in graphene sandwiched between 2 layers of N211. For the spin+scoop sample, a layer of Nafion attached to PTFE-coated fiberglass is submerged in the water and used to scoop the graphene|Nafion-thin-film stack onto it and then dried before adding the second Nafion layer via hot pressing.

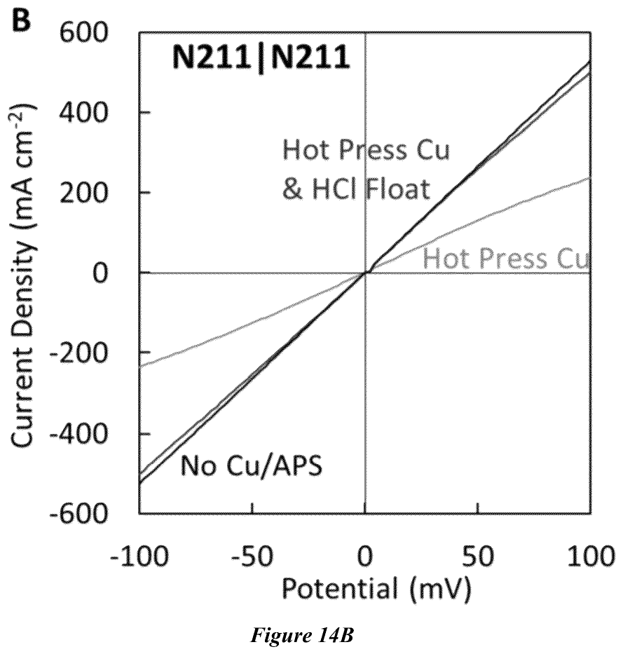

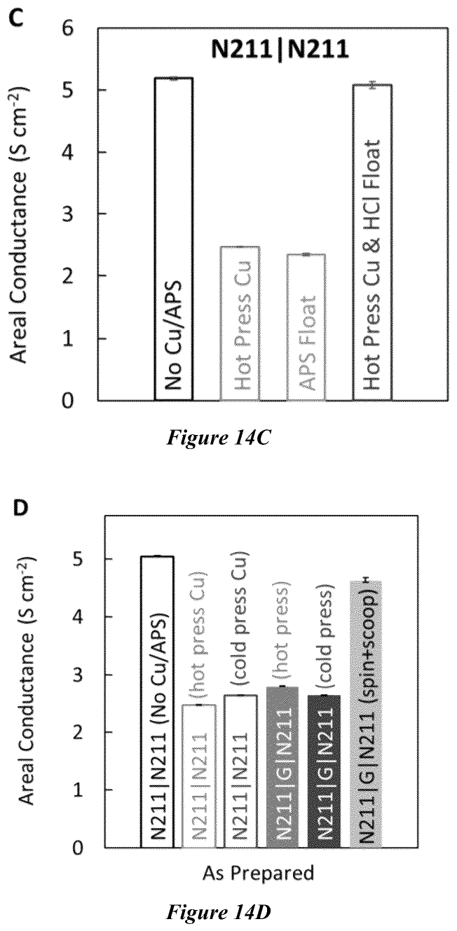

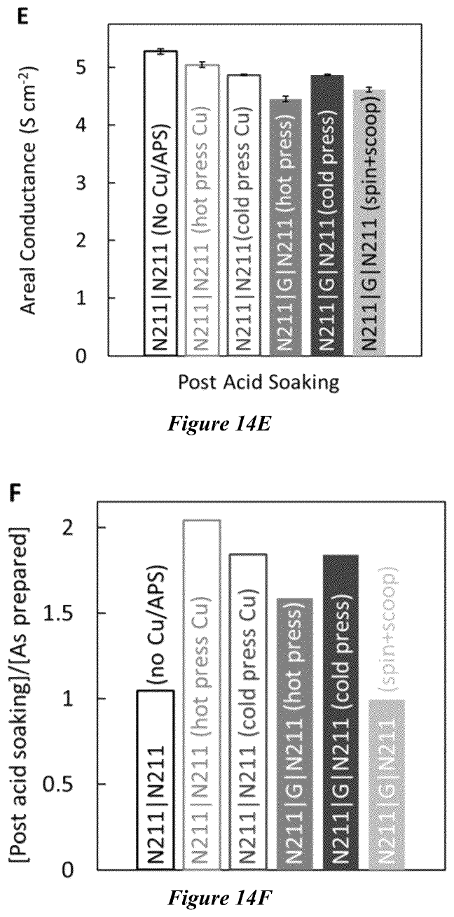

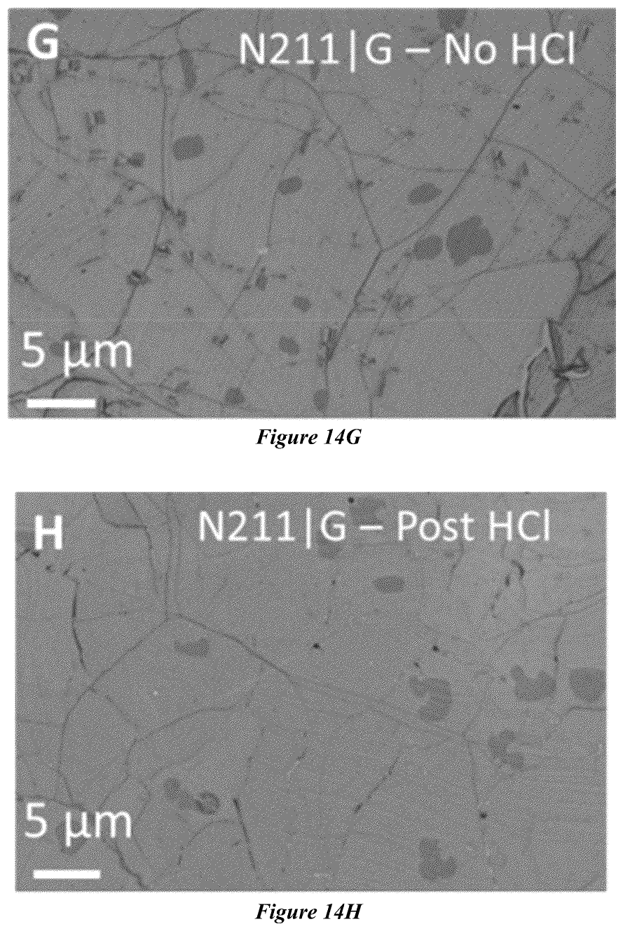

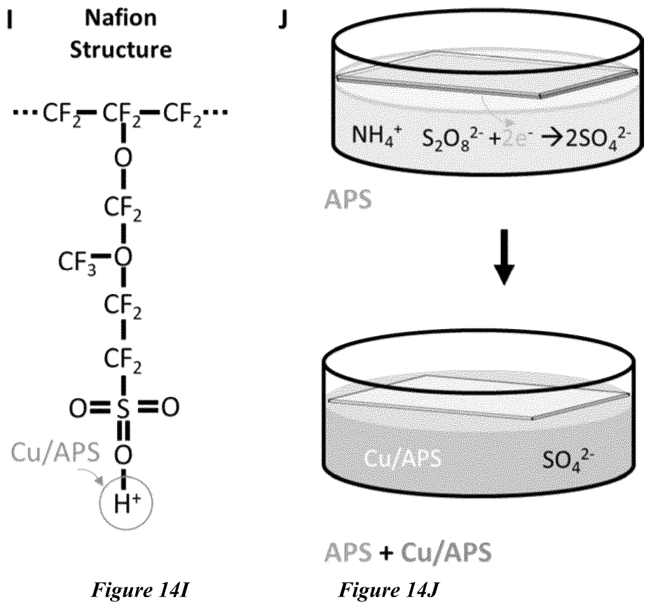

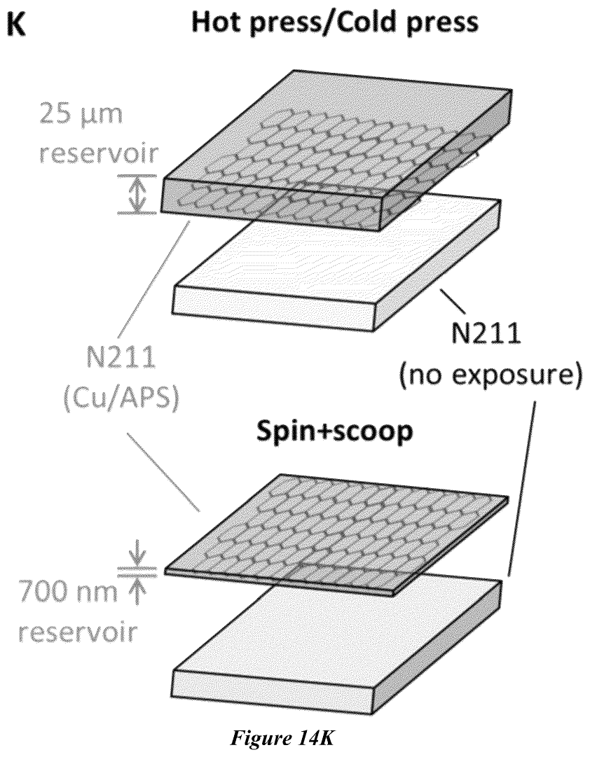

Proton transport experiments. Proton transport characterization of the fabricated membranes were performed by supplying H₂ gas as the source of protons and by adding ˜0.25-inch diameter platinum-carbon electrodes (Pt/C, 0.2 mg cm⁻² Pt loading, Fuel cell store, ˜0.32 cm²) via hot press at ˜200 psi and ˜140° C. for ˜1 minute [B7, B11, B29]. Before testing, the membranes were soaked in DI water for 10 minutes to ensure the Nafion was fully hydrated (as prepared). Membranes were loaded into a custom-built miniature fuel cell and ˜40 sccm of humidified H₂ gas (99.9999%, AL Gas) is introduced to both sides of the membrane (see FIG. 14A). A potentiostat (Gamry Interface 1010B) is used to run linear sweep voltammetry from −100 mV to+100 mV at a scan rate of 2 mV s⁻¹. The membrane conductance is determined from the slope of the resulting curve:

$$\frac{I}{V} = \frac{1}{R} = σ$$

then normalized to the active area (˜0.32 cm²) to obtain areal proton conductance. After the initial proton conductance and H₂ crossover measurements, the samples are removed from the measurement cell, soaked for 12 hours in 0.1 M HCl, rinsed in DI water and then reloaded in the cell and measured again (post acid soaking).

Ion exchange capacity (IEC). IEC was determined by neutralization titration [B33]. Membranes were prepared with Nafion 212 (N212, ˜50 μm thickness) using the hot press method. Prior to hot pressing, the N212 pieces were weighed to acquire their dry mass (mnaf). After sandwiching, each membrane is soaked in 75±0.25 mL of ˜0.5 M KCl for ˜2 hours, then removed. Three aliquots of 20±0.25 mL were taken and 2 drops of Brothymyl blue indicator (BTB) added to each so that a yellow color was observed. Each aliquot was titrated with ˜0.01 N NaOH until the aliquot color changed to green/blue, indicating a pH of ˜7.0. The IEC is calculated using:

$$IEC = ( \frac{N \times V}{{m}_{naf}} ) ( \frac{{V}_{KCl , total}}{{V}_{KCl , aliquot}} )$$

where N is the normality of the NaOH titrant, V is the volume of titrant added to neutralize the KCl solution, m_{naf} is the mass of the dry Nafion, V_{KCl, total} is the total KCl volume the sample was soaked in, and V_{KCl, aliquot} is the volume of each KCl aliquot.

Energy dispersive X-ray spectroscopy (EDS). As prepared graphene transferred to N211 (N211|G) via hot press method was mounted to the sample holder (without soaking in 0.1 M

HCl) and loaded into a Zeiss Merlin SEM with EDS. At a working distance of ˜8.5 mm, the N211|G sample is brought into focus at low magnification (<800×) to mitigate charging/damage to the sample due to the high voltages (20 kV) and probe current (2 nA) used. The EDS spectra was collected over ˜5 minutes in an area of the sample covered with graphene. Next, the magnification was increased (>800×) and the EDS spectra collected again.

H₂ crossover measurements. H₂ crossover at room temperature is determined using electrochemical techniques previously described [B7, B11, B12, B29]. ˜40 sccm of humidified H₂ gas is flowed on one side of the membrane while ˜40 sccm of humidified N₂ (99.999%, AL Gas) is flowed on the other side of the membrane and the OCV monitored until stable. Linear sweep voltammetry is run from +600 mV to −150 mV. At potentials above the OCV, the current results from hydrogen which diffused through the membrane and is available to react at the electrode on the N₂ side of the membrane. Therefore, the measured current is directly related to the magnitude of H₂ crossover through the membrane. The limiting current density at 400 mV is taken to compare crossover between membranes as per U.S. Department of Energy standard [B11].

Hydrogen fuel cell. Fuel cell measurements were done at room temperature by supplying humified H₂ to one side and humidified air to the other side of the membrane. An initial break-in procedure is performed prior to each measurement wherein the membrane potential is cycled between 600 and 200 mV, holding for 60 seconds at each step for ˜3 hours. I-V curves and power density plots are obtained by sweeping the applied potential from ˜900 mV to ˜200 mV at a scan rate of ˜2 mV s-1. Power density is calculated by multiplying current density by the potential. Maximum power density is extracted from the power density plots as the maximum point.

### Results and Discussion

Transfer of CVD graphene to N211 via hot press, cold press, and spin+scoop approaches. Three different methods were used to transfer CVD graphene to N211: (i) spin-coating a thin layer of Nafion on CVD graphene on Cu, followed by subsequent etch of Cu and scooping the Nafion|graphene (N211|G) on to N211 (spin+scoop, FIG. 13A), (ii) casting a Nafion film on CVD graphene on Cu and cold pressing on to N211 (FIG. 13B) and subsequent etch of Cu, and (iii) hot pressing N211 on to CVD graphene on Cu and subsequent etch of Cu (FIG. 13C). Finally, another layer of N211 is hot pressed to fabricate an N211|G|N211 sandwich PEM, electrically isolating and protecting the graphene layer in-between (FIG. 13D).

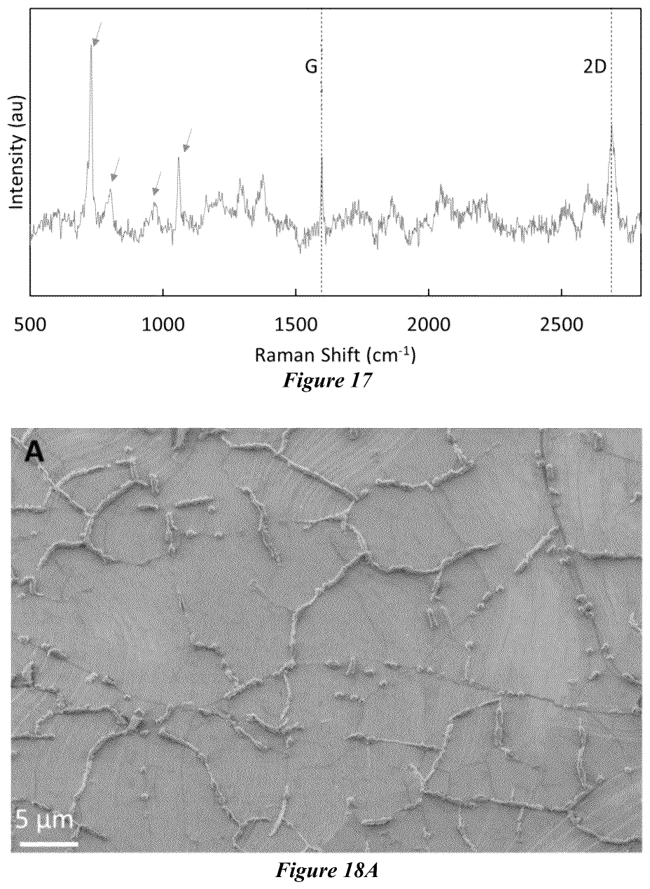

Scanning electron microscopy (SEM, FIG. 13E-FIG. 13G), and Raman spectroscopy (FIG. 13J) performed on graphene transferred to N211 (prior to hot pressing the additional sheet of N211) confirms successful graphene transfer. SEM images show wrinkles in graphene and some multi-layer spots indicating CVD graphene transfer using each method (FIG. 13E-FIG. 13G). Raman spectroscopy confirms (i) the high quality of the as-synthesized monolayer CVD graphene (FIG. 13J, red spectrum) as well as (ii) the successful transfer of graphene to Nafion (FIG. 13J, light blue spectrum, FIG. 17). Raman spectra are collected from 1200 cm⁻¹ to 2800 cm⁻¹ as the characteristic graphene peaks appear within this range and allows confirmation of graphene transfer [B10, B34, B35]. Specifically, Raman peaks at ˜2690 cm⁻¹ (2D), ˜1580 cm⁻¹ (G), and the absence of a peak at ˜1350 cm⁻¹ are characteristic to graphene and a ratio of ID/IG ˜0.032, confirms high quality (FIG. 13J, red spectrum) [B35, B36]. Nafion does not have peaks at 2690 cm⁻¹ or 1580 cm⁻¹ (FIG. 13J, dark blue spectrum) [B37]. Hence, the presence of characteristic graphene peaks after graphene transfer is indicative of successful graphene transfer (FIG. 13J, light blue spectrum). However, broad, characteristic Nafion peaks are present around 1350 cm⁻¹ (˜1300 cm⁻¹ and 1380 cm⁻¹) and therefore this method cannot be used to quantify the quality of the graphene after transfer to Nafion.

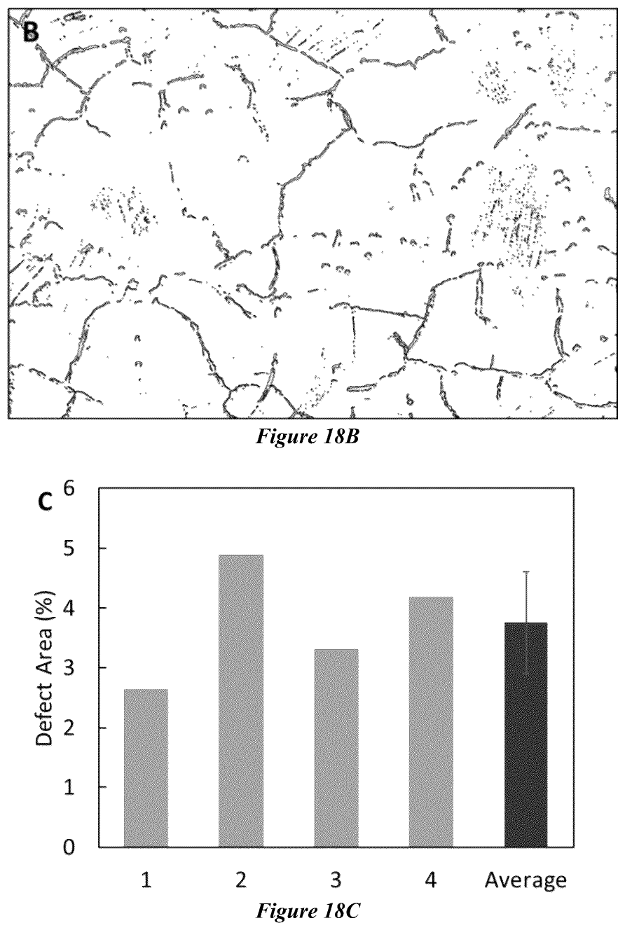

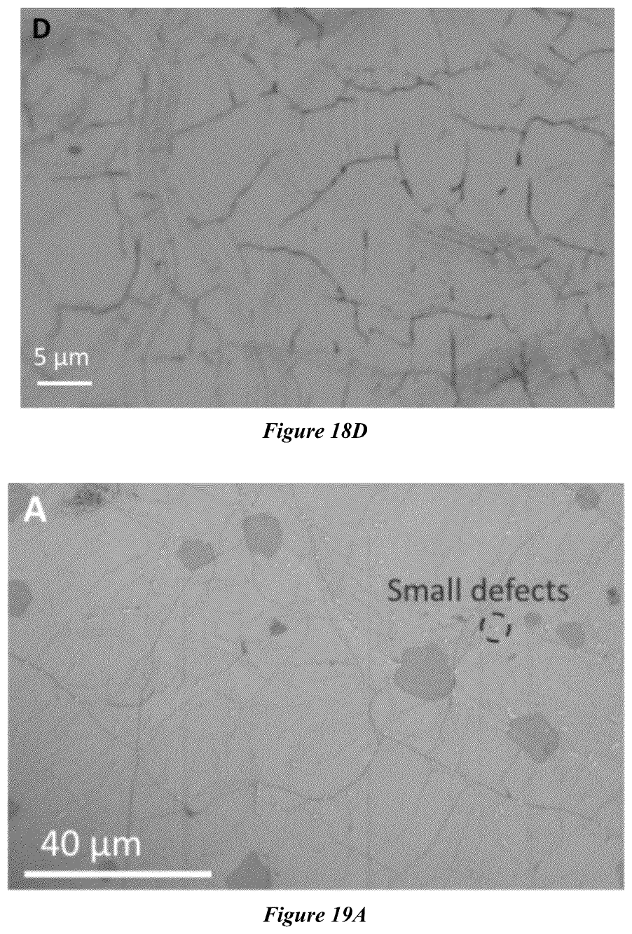

Notably, graphene transferred via hot press shows spot/linear defects (FIG. 13G) consistent with prior literature reports of damage to graphene via oxidation of the Cu foil underneath intrinsic defects in CVD graphene which are large enough to allow for H₂/O₂ permeation [B29, B38, B39]. Further, such oxidation related features appear to line up along wrinkles in CVD graphene [B29, B38, B39], as is apparent when comparing CVD graphene on Cu foil that has been oxidized via heating in ambient atmosphere (see FIG. 18A-FIG. 18D).

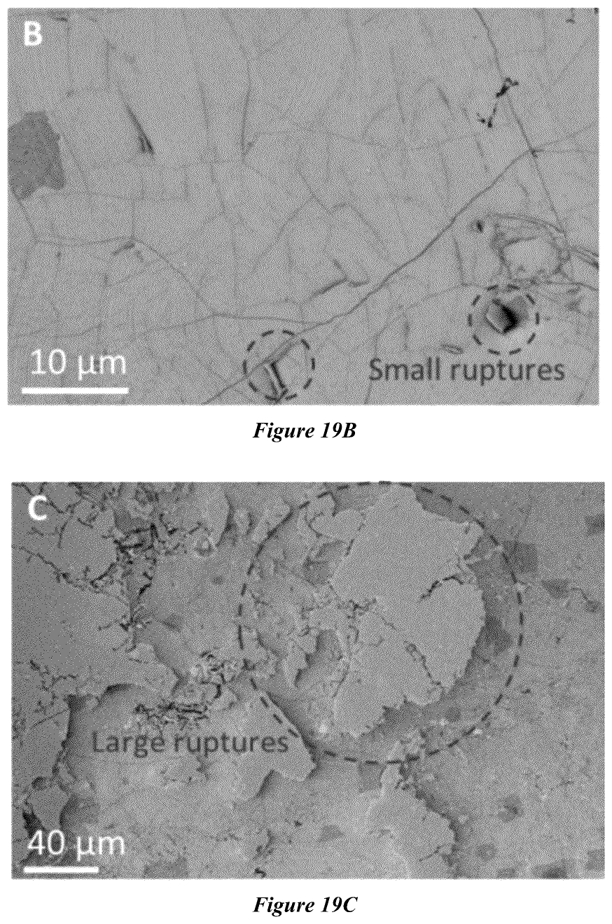

Interestingly, graphene transferred without using elevated temperatures (as used in hot press) does not show oxidation related features (FIG. 13E and FIG. 13F). However, some minor areas with different damaged/ruptured regions for the graphene transferred via cold press are observed. These regions appear brighter under SEM imaging due to charging of the underlying exposed Nafion (due to the non-conducting nature of the polymer compared to graphene) along with much darker regions in the immediate vicinity (FIG. 13F). These darker patches were attributed to >1 layer of graphene that ruptured due to poor contact with the N211 (exposing Nafion in the bright regions of SEM) and folded over [B29]. It is noted that cold press in some instances results in large areas of non-conformal contact (see FIG. 19A-FIG. 19C) in addition to the minor ruptures, although they occurred less frequently across several samples tested and were mitigated when a thin layer of Nafion is cast on the CulG before the cold press to N211 (FIG. 13B). Finally, it is noted that graphene transferred via a spin-coated, ultra-thin Nafion film (˜700 nm thickness, FIG. 13H) showed minimal damage/rupture of either type (FIG. 13E). A quantitative analysis of the percentage area attributed to defects/damage/ruptures (FIG. 13I) from SEM images with ImageJ confirms the qualitative observations with hot press>(˜2.5±1.3%) >cold press (˜0.95±0.56%)>spin+scoop (˜0.25±0.07%) (FIG. 13I). The low defective area for the spin+scoop sample was attributed to the lack of elevated temperatures which ensures no damage results from the Cu oxidation and the spin-coated Nafion film achieving conformal contact with CVD graphene on Cu.

Areal proton conductance of the fabricated N211|G|N211 PEMs. Proton transport through fabricated PEM sandwich membranes was evaluated by adding Pt/C electrodes to either side of the membrane (0.32 cm²) and using a custom built, miniature test cell (FIG. 14A) [B11, B29]. The PEM is loaded into the cell and sealed between two graphite rods and Ni foam for electrical contact with Pt/C electrodes on either side and o-rings to isolate either side of the membrane from gas leakage. Current-Voltage (I-V) curves are measured while supplying humidified H₂ gas on either side of the PEM (symmetric measurements), and the slope of the I-V curve collected using linear sweep voltammetry (LSV) is used to compute PEM conductance (FIG. 14B) using Ohm's law [B11, B29, B34].

It is noted that CVD graphene transfer to N211 inevitably necessitates the removal of catalytic CVD substrate, and chemical etching of Cu has emerged as the most preferred route due to Cu being relatively inexpensive, and since approaches such as mechanical peeling or interface oxidation for delamination can result in damage to CVD graphene [B32, B40]. Hence, understanding the impact of this chemical etching process of Cu is imperative for facile and scalable PEM fabrication.

To evaluate the influence of the etching step on proton conductance, four different kinds of N211 (controls) were prepared and studies: (i) as received N211 with no exposure to Cu or etching solution of ammonium persulfate (APS), (ii) N211 hot pressed to bare Cu foil and etched in APS, (iii) N211 floated on fresh APS solution, and (iv) N211 hot press to bare Cu foil, etch in APS, then soaked in 0.1 M HCl (FIG. 14C). Each of these N211 layers were subsequently sandwiched with another as-received N211 (without any treatment) and proceeded to evaluate proton transport through the N211|N211 PEMs.

The un-treated N211 shows the highest conductance ˜5.2 S cm⁻² (FIG. 14C) but after exposure to Cu and APS, the conductance drops significantly ˜2.3-2.5 S cm⁻². It is hypothesized that this lowering in areal conductance stems from uptake of cations present in the etching solution e.g. Cu and ammonium ions into Nafion replacing/exchanging the H⁺ usually present on the sulfonated groups (FIG. 14I) [B41, B42]. To test this hypothesis, the N211|N211 PEMs exposed to Cu and APS were soaked in dilute HCl (0.1 M) and it was found that the areal conductance recovers to match that of the untreated membrane ˜5.1 S cm⁻², suggesting that the cations have been exchanged out with H⁺ and contamination effectively removed. Similarly, a drop in areal proton conductance to ˜2.5-2.6 S cm⁻² was observed for N211|N211 PEMs which were contacted with bare Cu via hot pressing and cold pressing (FIG. 14D) techniques in comparison to N211|N211 (no contact with Cu/APS) and recovery upon soaking in 0.1 M HCl (FIG. 14E). These observations are consistent with studies by Hongsirikarn et al. [B42] wherein the in-plane ionic conductance of N211 decreased linearly from ˜115 mS cm⁻¹ to ˜25 mS cm⁻¹ when equilibrated with increasing concentrations of ammonium ions via contamination of Nafion with NH₄⁺ as well as re-protonation of Nafion via uptake cations present in solutions (acids with high H⁺ concentration) via diffusion [B2, B11].

Hot as well as cold pressed graphene membranes N211|G|N211 also show lowering of areal proton conductance and recovery upon soaking in 0.1 M HCl, similar to the N211|N211 (controls) but the resistance of the graphene membrane remains higher than the controls (FIG. 14D-FIG. 14F), since graphene presents additional resistance to proton transport [B2, B11]. Comparison of the areal conductance after soaking in 0.1 M HCl to the areal conductance as prepared, the control membranes demonstrate the greatest increase in conductivity (˜2×) while the hot press graphene sample changes by ˜1.5× and the cold press ˜1.8× (FIG. 14F). To ensure that the 0.1 M HCl soak is not introducing microscale defects, the graphene surface on Nafion within the same area was imaged via SEM before and after soaking in 0.1 M HCl and no significant differences in the graphene features or the introduction of tears/ruptures were observed (FIG. 14G and FIG. 14H). Interestingly, the spin+scoop sample did not show a significant drop in the proton conductance prior to acid soaking and upon acid soaking the proton conductance only marginally changes i.e. post acid soaking: as prepared ratio ˜0.99× (FIG. 14F). It is proposed that these differences between spin+scoop vs. hot/cold pressed N211|G|211 PEMs originate from a reservoir effect (FIG. 14J and FIG. 14K) as well as any material properties differences for the ultra-thin ˜700 nm Nafion films versus ˜25 μm N211.

Nafion films have been suggested to experience confinement effects and substrate/film interactions with slower water diffusion and reduced water uptake, amongst other effects [B43-B46]. Specifically, when casted on a hydrophobic surface, thin Nafion films have been suggested to orient the ionic domains parallel to the surface which in turn could reduce water uptake [B43-B46]. For Cu and ammonium ions to exchange with the protons in the Nafion film, water must permeate through the graphene barrier via defects overlapping with the Nafion channels. Once there is water in the ionic channels, diffusion and ion exchange of Cu and ammonium ions with H⁺ can occur. Additionally, the N211 thickness is significantly greater than that of the spin-coated film (25 μm vs. 700 nm) and so the N211 has a greater volume for holding these contaminants, hindering efficient proton transport and reducing the conductance if not re-protonated (FIG. 14K). Hence, it was concluded that when graphene is transferred to N211 via hot press or cold press, soaking in 0.1 M HCl is necessary to re-protonate and remove contamination from the etching step (i.e. Cu and ammonium ions), while graphene that is transferred via the spin+scoop method does not require an additional 0.1 M HCl soaking step.

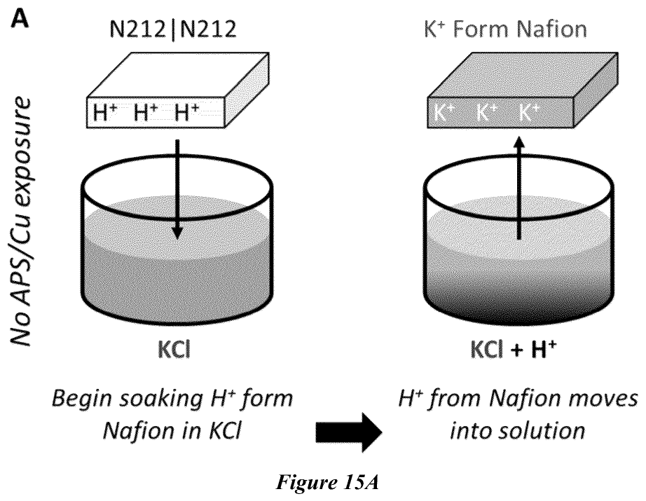

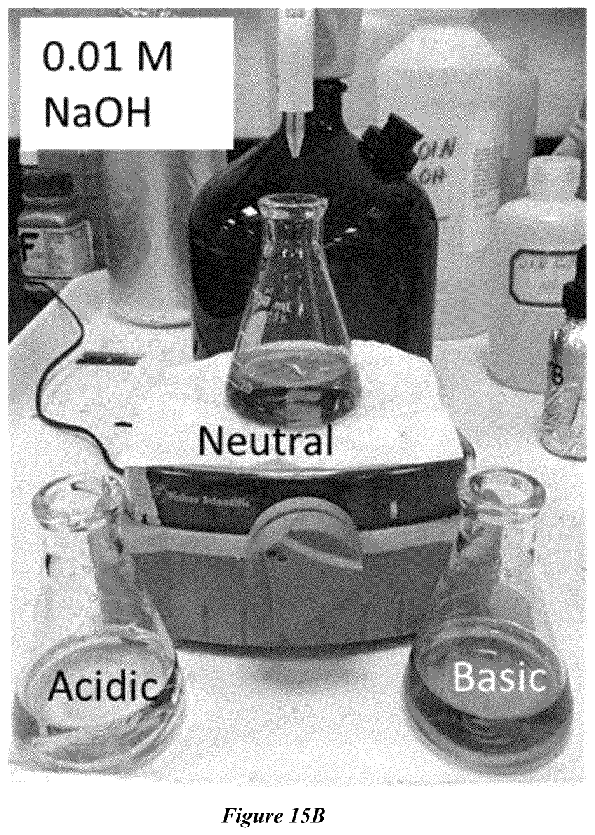

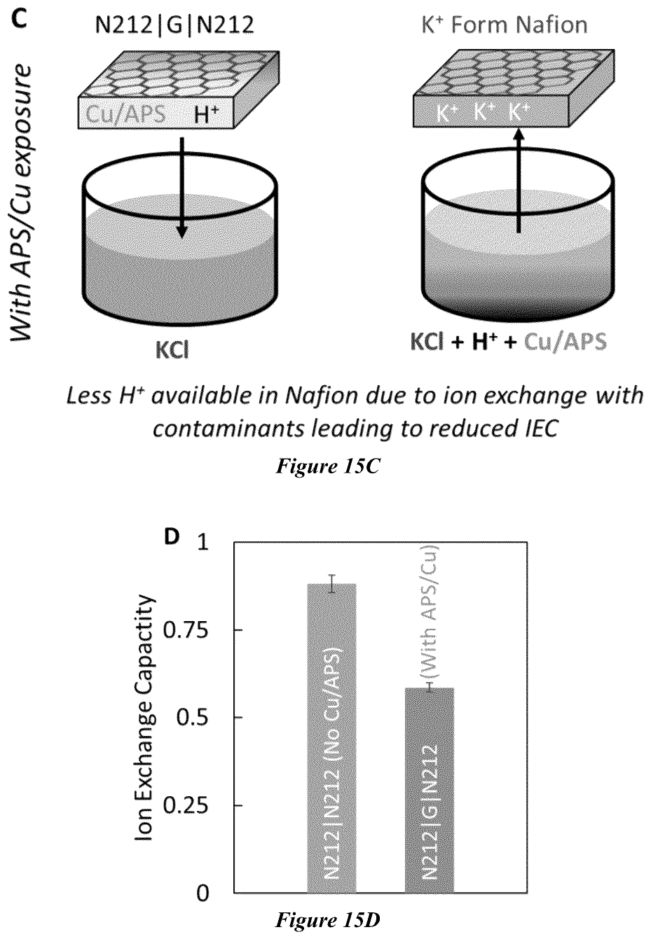

Differences in the ion exchange capacity (IEC, mol of cation per g of Nafion) are also observed for graphene membranes which have contact with Cu²⁺ and NH₄⁺ as compared to pristine Nafion (FIG. 15A-FIG. 15D). Typically, Nafion in H⁺ form (i.e., protons associated with the sulfonate groups in the Nafion) can be exchanged out with other cations (K⁺) by soaking in a solution such as KCl. Due to the concentration gradient, the protons in Nafion diffuse into the KCl solution and are replaced with K⁺. The concentration of protons removed from the Nafion can then be determined by simple titration and the IEC value calculated. It is noted that although the addition of graphene has been shown to provide resistance to electrically driven K⁺ transport in Nafion, the presence of graphene is not projected to completely eliminate the diffusion of K⁺ into Nafion during these experiments. Previous experiments with Nafion|G|Nafion membranes have indeed demonstrated that K⁺ can be fully removed from N211|G|N211 sandwich membranes by soaking in HCl [B7, B11].

The control sandwich membrane not exposed to Cu or APS has an IEC of ˜0.88 (FIG. 15D, gray bar). Slight deviation from the theoretical value of ˜0.9 could be attributed to the accuracy of the titration method or some variability in the mass of the dry Nafion due to residual water [B33]. When graphene is transferred to the Nafion (i.e. 1 layer of Nafion is exposed to Cu and APS), the IEC is significantly lower at ˜0.59 (FIG. 15D, blue bar). This low IEC was attributed to the reduced proton concentration in the Nafion due to the exchange with Cu and/or ammonia ions during the etching process. When soaked in KCl, these ions may still exchange out with the K⁺ but they do not contribute significantly to the acidity of the KCl solution to be titrated, thereby reducing the volume of titrant needed for neutralization and the subsequent calculated IEC.

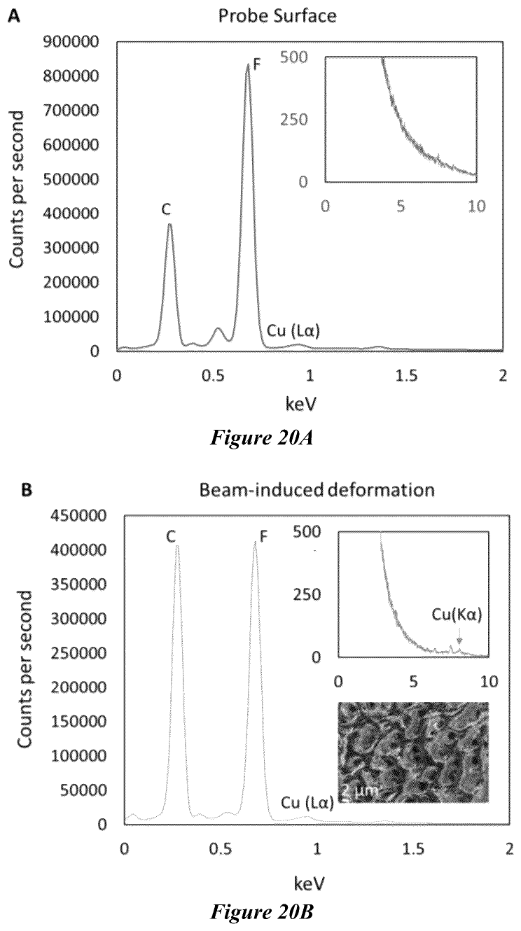

To confirm whether Cu ions are participating in the ion exchange process with Nafion, energy-dispersive X-ray spectroscopy (EDS) of a N211|G membrane was performed (FIG. 20A-FIG. 20B) and the Cu Lα peak at ˜0.930 keV was observed when the sample surface was probed, indicating the presence of Cu. At higher magnification (same beam energy distributed over a smaller area), the incident electron beam interacts with the Nafion sample, leading to deformation of the sample surface [B47], and an emergence of the Cu Kα peak at ˜8.04 keV (FIG. 20B, inset).

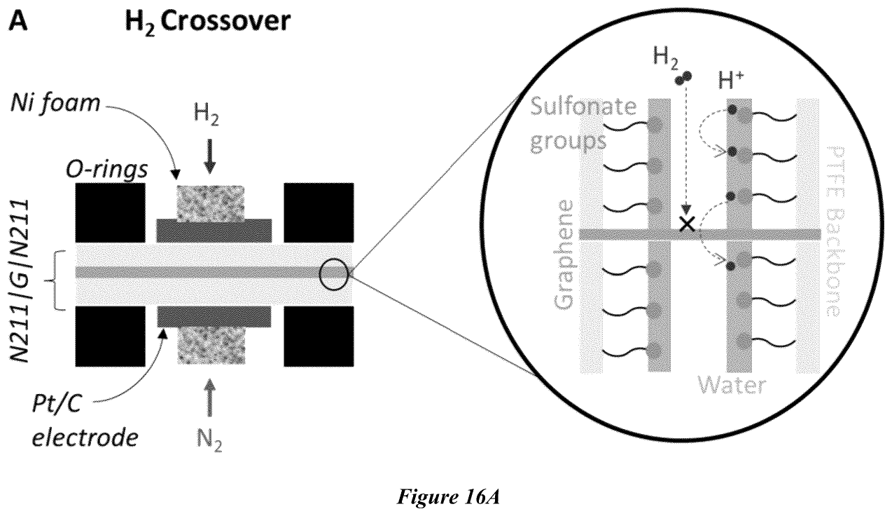

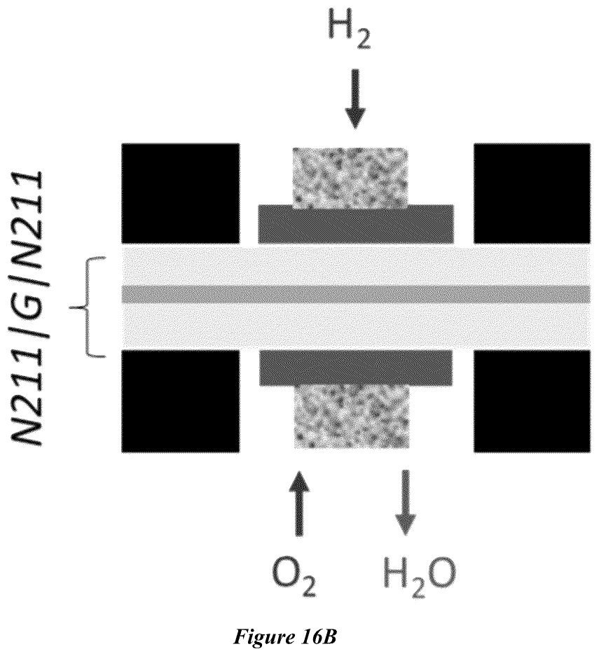

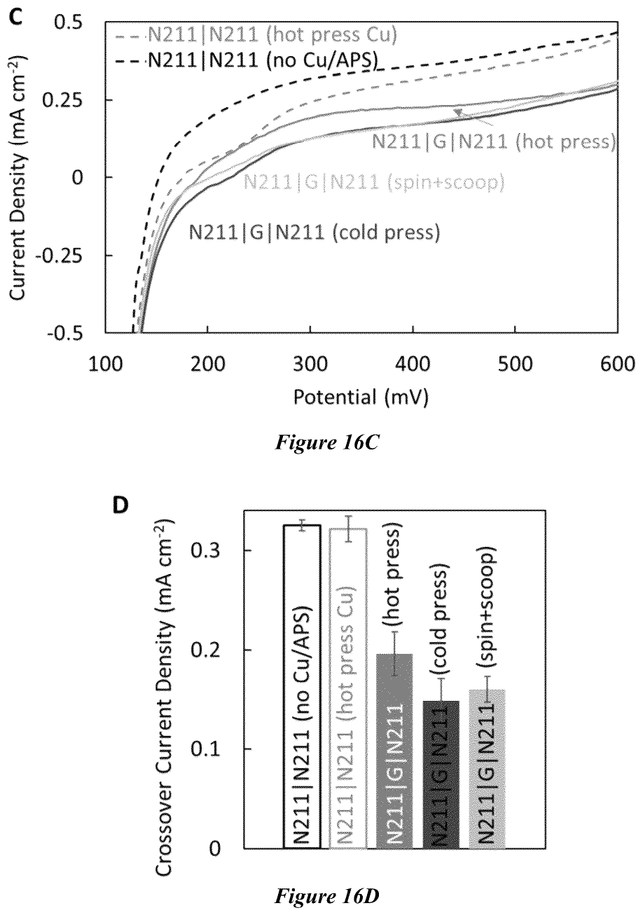

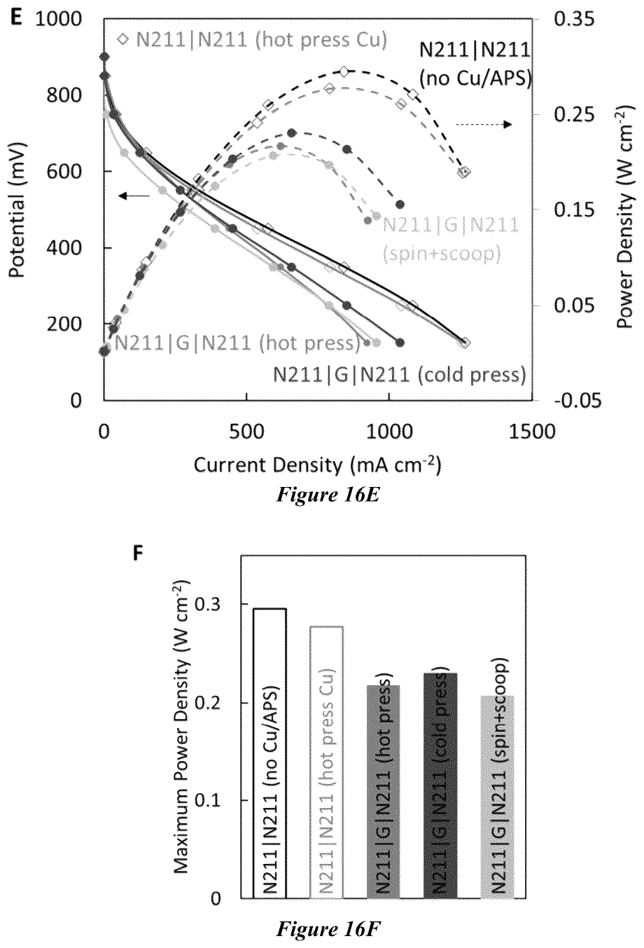

Hydrogen crossover and H₂/Air fuel cell performance of the fabricated N211|G|N211 PEMs. Having developed approaches to effectively integrate graphene with Nafion and fabricate PEMs, it was proceeded to evaluate H₂ crossover and H₂/Air fuel cell performance of the fabricated N211|G|N211 PEMs (FIG. 16A and FIG. 16B and Experimental methods) [B11, B48, B49]. It is emphasized that since graphene is sandwiched between 2 layers of Nafion (N211), direct imaging techniques cannot be used to evaluate the morphology/surface chemistry of graphene and hence H₂ crossover reduction was used as a measure of the integrity of graphene and its barrier properties. For H₂ crossover, I-V curves are obtained from LSV when flowing H₂ on one side of the membrane and N₂ on the other side of the membrane at equal mass flow rates (FIG. 16C). At potentials more negative than the open circuit potential (˜120 mV), the onset of the hydrogen evolution reaction was seen, identified by the steep slope. At potentials more positive than the open circuit potential (H₂ crossover region), the measured current results from the oxidation of H₂ which has diffused as molecular H₂ through the PEM [B49, B50]. The crossover current density is taken at 400 mV for each membrane to compare relative crossover (FIG. 16D) [B49, B50]. As with the proton conductance, after HCl soaking the H₂ crossover current densities for the controls whether pressed against bare Cu or not are similar at ˜0.32 mA cm⁻² (FIG. 16D). Upon the incorporation of graphene, the crossover current densities for each of the graphene membranes (N211|G|N211) drops significantly as compared to the controls (N211|N211).

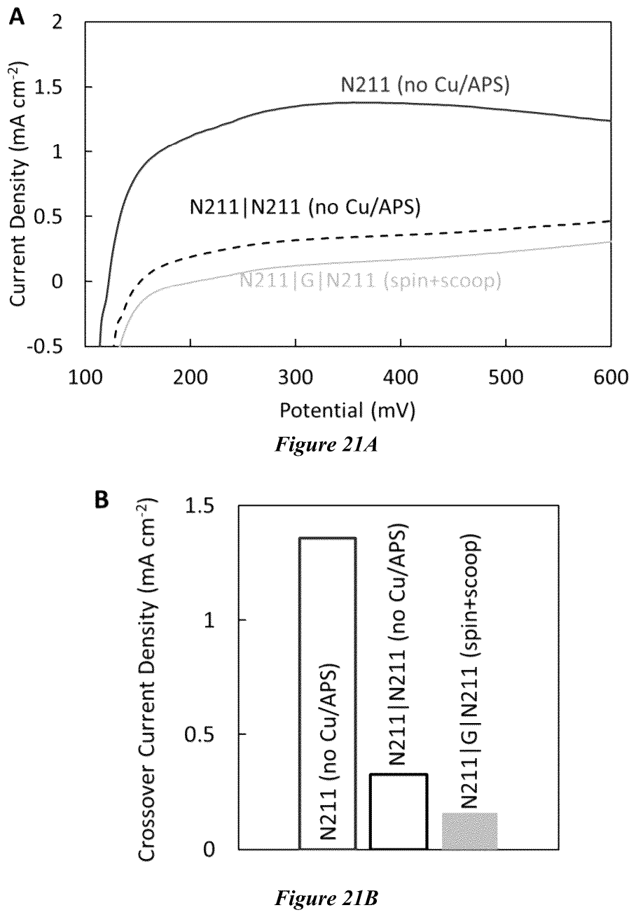

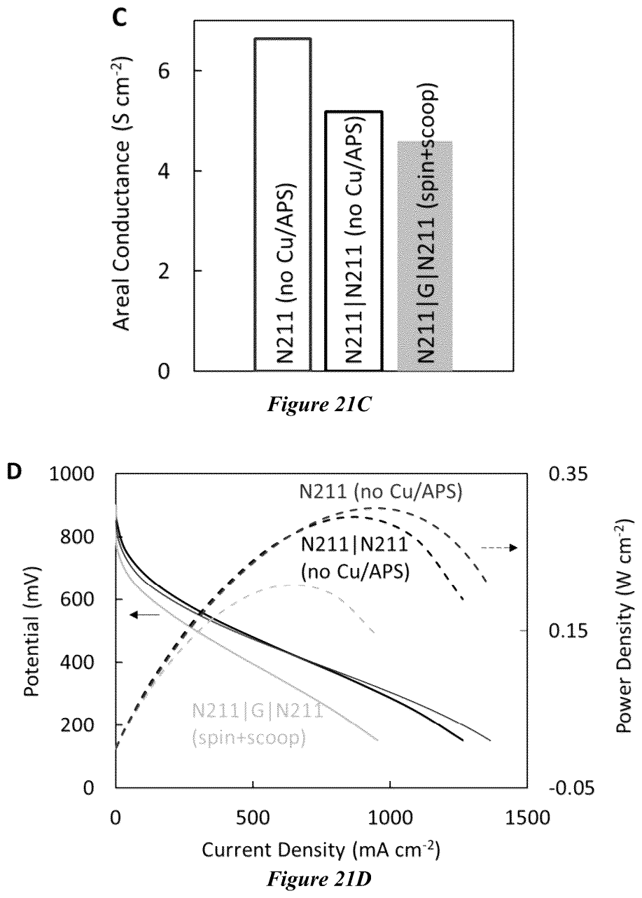

The hot press sample shows the lowest reduction in H₂ crossover ˜41% (˜0.20 mA cm⁻²), in agreement with prior reports of crossover reduction (˜0.17 mA cm⁻²) [B11]. The cold press and spin+scoop samples show higher H₂ crossover reduction to ˜54% (˜0.15 mA cm⁻²) and ˜53% (˜0.16 mA cm⁻²), respectively. N211|G|N211 membranes were also compared to a single layer of N211, which is more commonly used than the sandwich structure in standard H₂ fuel cells, and ˜87% reduction in H₂ crossover was observed (see FIG. 21A-FIG. 21D). It is noted that the gas phase measurements are done under humid conditions, which has previously been shown to result in lateral expansion of Nafion of up to ˜10% at room temperature [B51]. While this could cause strain in the graphene, it still allows for between 41-54% reduction in crossover. Reduced H₂ crossover upon the addition of graphene can aid longevity of PEMs since reactant crossover (H₂ and O₂) reduces fuel cell efficiency and direct reaction between H₂ and O₂ can lead to the formation of peroxides which degrade Nafion, ultimately leading to membrane failure [B49, B50].

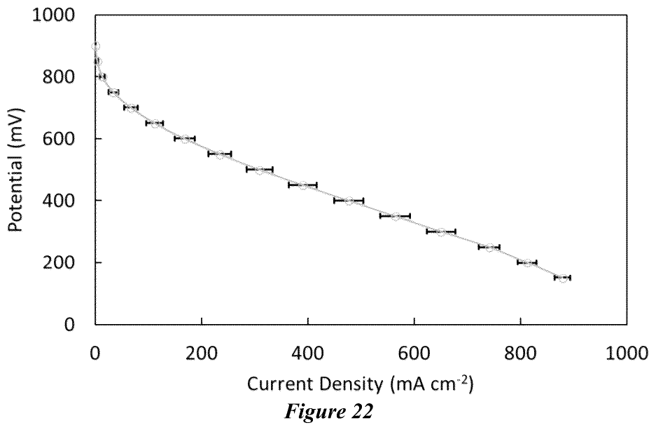

Beginning of life performance when the N₂ feed is changed to air (i.e., in an H₂/Air fuel cell) was further evaluated (FIG. 16B). Fuel cell measurements were done at room temperature in the same test fixture as the symmetric and asymmetric tests. Due to the significant drop in conductance observed for hot press and cold press samples prior to soaking in HCl, fuel cell measurements were only performed post acid soaking. During room temperature operation of the custom-built H₂/Air fuel at atmospheric pressure, the performance of the membranes was found to be stable for the duration of the experiments (FIG. 22). The graphene membranes demonstrate slightly lower max current densities (˜954-1004 mA cm⁻²) compared to the sandwich control membranes (˜1260 mA cm⁻²) as also reflected in the maximum power density (FIG. 16E and FIG. 16F). Between the hot press, cold press, and spin+scoop samples, max power density for the cold press sample is marginally higher than the hot press and spin+scoop samples, which is consistent with the higher proton conductance measured for the cold press sample (FIG. 14A-FIG. 14K and FIG. 16D) but overall all membranes are impacted by the increase in ohmic resistance due to graphene. However, the max power density is only reduced by ˜22% while the H₂ crossover is reduced ˜41-53%, indicating the graphene barrier successfully passes the typical selectivity/permeability tradeoff.

These beginning of life H₂ fuel cell measurements serve as proof-of-concept experiments that the approaches developed for interfacing graphene with Nafion can be used for applications. The mitigation of deleterious effects from transfer processes allows future studies to focus on evaluating/optimizing fuel cell performance at elevated temperatures (˜70-80° C.) to increase efficiencies, extended time studies, stress testing, among others that could provide more technological insights into the role of the interfaced 2D material.

Conclusions. Scalable approaches to integrate proton selective atomically thin graphene with Nafion can allow for the development of next-generation PEMs with minimal crossover of reactant or undesired species while simultaneously maintaining high proton conductance for applications. Transferring CVD graphene to Nafion via hot pressing has emerged as one of the most widely used transfer methods. However, typical use of Nafion does not involve the removal of Cu foil via exposure to acids/oxidizing solutions (such as ammonium persulfate) and typical graphene transfer methods utilize polymers that do not interact with the etchant. In this study, three different methods were demonstrated to successfully transfer graphene to Nafion 211 for N211|G|N211 sandwich membranes. The effects of cation contamination on proton conductance when transferring to N211 using hot press and cold press techniques were found (36-52% reduction in areal proton conductance) and it was demonstrated that a simple HCl soak can reverse this deleterious effect. A spin+scoop method was introduced which mitigates contamination, by providing a significantly smaller reservoir for the uptake of Cu or NH₄⁺ in the ultrathin ˜700 nm Nafion films vs. N211. Finally, H₂ crossover reduction up to ˜41-54% was demonstrated for the graphene membranes compared to Nafion sandwich controls with ˜22% reduction in the peak power densities, demonstrating performance above the typical linear selectivity/permeability tradeoff observed for conventional membranes.

### References

[B1] X. H. Yan et al. J. Power Sources, 2016, 311, 188-194.
[B2] S. Bukola et al. ACS Appl. Nano Mater., 2019, 2, 964-974.
[B3] A. Khan et al. ECS Trans., 2015, 69, 569-577.
[B4] C. L. Bentley et al. ACS Nano, 2022, 16, 5233-5245.
[B5] S. Bukola and S. E. Creager, ECS Trans., 2019, 92, 439-444.
[B6] A. Paneri et al. J. Membr. Sci., 2014, 467, 217-225.
[B7] P. Chaturvedi et al. J. Mater. Chem. A, 2022, 10, 19797-19810.
[B8] Q. Chen et al. Mater. Des., 2017, 113, 149-156.
[B9] S. Bukola et al. J. Energy Chem., 2021, 59, 419-430.
[B10] M. Lozada-Hidalgo et al. Nat. Commun., 2017, 8, 15215.
[B11] N. K. Mochring et al. ACS Nano, 2022, 16, 16003-16018.
[B12] P. R. Kidambi et al. Science, 2021, 374, 1-12.
[B13] S. P. Koenig et al. Nat. Nanotechnol., 2012, 7, 728-732.
[B14] S. C. O'Hern et al. ACS Nano, 2012, 6, 10130-10138.
[B15] P. R. Kidambi et al. Adv. Mater., 2017, 29, 1700277.
[B16] P. Cheng et al. ACS Appl. Mater. Interfaces, 2022, 14, 41328-41336.
[B17] P. R. Kidambi et al. Adv. Mater., 2017, 29, 1605896.
[B18] P. R. Kidambi et al. Nanoscale, 2017, 9, 8496-8507.
[B19] P. R. Kidambi et al. Adv. Mater., 2018, 30, 1-10.
[B20] P. Cheng et al. Nano Lett., 2020, 20, 5951-5959.
[B21] P. R. Kidambi et al. J. Phys. Chem. C, 2012, 116, 22492-22501.
[B22] P. R. Kidambi et al. Nano Lett., 2013, 13, 4769-4778.
[B23] P. R. Kidambi et al. ACS Appl. Mater. Interfaces, 2018, 10, 10369-10378.
[B24] T. Kobayashi et al. Appl. Phys. Lett., 2013, 102, 023112.
[B25] P. Y. Huang et al. Nature, 2011, 469, 389-392.
[B26] L. Colombo et al. ECS Trans., 2010, 28, 109-114.
[B27] L. Mogg et al. Nat. Commun., 2019, 10, 4243.
[B28] S. Hu et al. Nature, 2014, 516, 227-230.
[B29] P. Chaturvedi et al. Mater. Adv., 2023, 4, 3473-3481.
[B30] M. A. Izquierdo-Gil et al. Chem. Eng. Sci., 2012, 72, 1-9.
[B31] R. Tandon and P. N. Pintauro, J. Membr. Sci., 1997, 136, 207-219.
[B32] P. Cheng et al. Nanoscale, 2021, 13, 2825-2837.
[B33] E. Moukheiber et al. J. Membr. Sci., 2012, 389, 294-304.
[B34] B. Tang et al. Appl. Spectrosc. Rev., 2010, 45, 369-407.
[B35] A. C. Ferrari et al. Phys. Rev. Lett., 2006, 97, 1-4.
[B36] M. El Boukari et al. J. Raman Spectrosc., 1990, 21, 755-759.
[B37] J. Kwak et al. Nat. Commun., 2017, 8, 1549.
[B38] C. Jia, J. Jiang, L. Gan and X. Guo, Sci. Rep., 2012, 2, 707.
[B39] S. Bukola et al. J. Am. Chem. Soc., 2018, 140, 1743-1752.
[B40] R. Wang et al. ACS Appl. Mater. Interfaces, 2016, 8, 33072-33082.
[B41] B. Kienitz et al. J. Electrochem. Soc., 2011, 158, B1175-B1183.
[B42] K. Hongsirikarn et al. J. Power Sources, 2010, 195, 30-38.
[B43] K. A. Page et al. Nano Lett., 2014, 14, 2299-2304.
[B44] S. A. Eastman et al. Macromolecules, 2012, 45, 7920-7930.
[B45] M. A. Modestino et al. Macromolecules, 2012, 45, 4681-4688.
[B46] E. M. Davis et al. ACS Macro Lett., 2014, 3, 1029-1035.
[B47] S. Yakovlev et al. Membranes, 2013, 3, 424-439.
[B48] S. I. Yoon et al. ACS Nano, 2018, 12, 10764-10771.
[B49] M. Schoemaker et al. Fuel Cells, 2014, 14, 412-415.
[B50] A. Z. Weber, J. Electrochem. Soc., 2008, 155, B521-B531.
[B51] F. Bauer et al. J. Polym. Sci., 2005, 43, 786-795.
[C1] N. K. Mochring et al. ACS Nano, 2022, 16, 16003-16018.
[C2] P. R. Kidambi et al. Nanoscale, 2017, 9, 8496-8507.

### EXEMPLARY ASPECTS

In view of the described compositions, devices, systems, and methods, herein below are described certain more particularly described aspects of the inventions. The particularly recited aspects should not, however, be interpreted to have any limiting effect on any different claims containing different or more general teachings described herein or that the “particular” aspects are somehow limited in some way other than the inherent meanings of the language and formulas literally used therein.

### Example 1

A membrane comprising: a two-dimensional (2D) material, a support, and an ionomer, wherein the two-dimensional (2D) material disposed on the support, thereby forming a construct, wherein the two-dimensional material is infilled with the ionomer, the support is infilled with the ionomer, the construct is infilled with the ionomer, or a combination thereof, thereby forming the membrane.

### Example 2

The membrane of any examples herein, particularly example 1, wherein the two-dimensional material comprises graphene, hexagonal boron nitride (h-BN), a transition metal dichalcogenide (e.g., porous TMDC), a covalent organic framework, a metal organic framework, ultra-thin oxides, mica, graphdyene like periodic porous structures, layered clays, mineral clays, or a combination thereof.

### Example 3

The membrane of any examples herein, particularly example 1 or example 2, wherein the two-dimensional material comprises graphene, hexagonal boron nitride (h-BN), or a combination thereof.

### Example 4

The membrane of any examples herein, particularly examples 1-3, wherein the two-dimensional material comprises graphene.

### Example 5

The membrane of any examples herein, particularly examples 1-4, wherein the two-dimensional material comprises graphene oxide.

### Example 6

The membrane of any examples herein, particularly examples 1-5, wherein the two-dimensional material comprises h-BN.

### Example 7

The membrane of any examples herein, particularly examples 1-6, wherein the two-dimensional material has an average thickness of from 0.3 to 100 nm.

### Example 8

The membrane of any examples herein, particularly examples 1-7, wherein the 2D material is permeated by one or more pores, one or more defects, or a combination thereof.

### Example 9

The membrane of any examples herein, particularly example 8, wherein at least a portion of the one or more pores, the one or more defects, or a combination thereof in the 2D material are infilled by the ionomer.

### Example 10

The membrane of any examples herein, particularly examples 1-9, wherein the support comprises polyether sulfone (PES), polystyrene (PS), polyvinylidene fluoride (PVDF), polyethylene terephthalate (PET), polycarbonate and polycarbonate track etch supports (PCTE), polyethylene (PE), high density polyethylene (HDPE), Polyester, Poly imide, Teflon,

Nylon, Rayon, electrospun fibers, woven cloths or metal meshes, anodic alumina (AAO), porous silicon, derivatives thereof, or combinations thereof.

### Example 11

The membrane of any examples herein, particularly examples 1-10, wherein the support has no pores (e.g., wherein the support is dense).

### Example 12

The membrane of any examples herein, particularly examples 1-10, wherein the support is porous in that the support is permeated by one or more pores, one or more defects, or a combination thereof.

### Example 13

The membrane of any examples herein, particularly example 12, wherein at least a portion of the one or more pores, the one or more defects, or a combination thereof in the porous support are infilled by the ionomer.

### Example 14

The membrane of any examples herein, particularly examples 1-13, wherein the ionomer comprises a proton conducting polymer, an anion conducting polymer, or a combination thereof.

### Example 15

The membrane of any examples herein, particularly examples 1-14, wherein the ionomer comprises a proton conducting polymer.

### Example 16

The membrane of any examples herein, particularly examples 1-15, wherein the ionomer comprises an anion conducting polymer.

### Example 17

The membrane of any examples herein, particularly examples 1-16, wherein the ionomer comprises Polybenzimidazoles (PBIs); Poly(aryl ether sulfones), such as sulfonated poly(arylene ether sulfone)s; Poly(phenylene oxide) (PPO) and derivatives thereof, such as PPO polymers, such as sulfonated poly(phenylene oxide) (SPPO); Poly(ether imide); Poly(vinyl alcohol) (PVA), such as PVA-based polymers, especially when modified or blended with other materials; Poly(ionic liquids), such as poly(ionic liquid) materials; conductive polymers, such as polyaniline, polypyrrole, and polythiophene, when doped with suitable acids; Nafion; SPEEK (Sulfonated PolyEtherEtherKetone); ammonium-functionalized (e.g., quaternary ammonium-functionalized) polysulfones or polyethers or Polyarylene Ethers or Polyethylene or Polyvinyl Alcohol; Ammonium-functionalized (e.g., Quaternary ammonium-functionalized) poly(phenylene oxide) (PPO); ammonium-functionalized (e.g., quaternary ammonium-functionalized) poly(styrene); Imidazolium-functionalized polysulfones or polyethers or Polyarylene Ethers or Polyethylene or Polyvinyl Alcohol; Imidazolium-functionalized poly(phenylene oxide) (PPO); Imidazolium-functionalized poly(styrene); Phosphonium-functionalized polysulfones or polyethers or Polyarylene Ethers or Polyethylene or Polyvinyl Alcohol; Phosphonium-functionalized poly(phenylene oxide) (PPO); Phosphonium-functionalized poly(styrene); derivatives thereof; or combinations thereof.

### Example 18

The membrane of any examples herein, particularly examples 1-17, wherein the ionomer comprises Polybenzimidazoles (PBIs); Poly(aryl ether sulfones), such as sulfonated poly(arylene ether sulfone)s; Poly(phenylene oxide) (PPO) and derivatives thereof, such as PPO polymers, such as sulfonated poly(phenylene oxide) (SPPO); Poly(ether imide); Poly(vinyl alcohol) (PVA), such as PVA-based polymers, especially when modified or blended with other materials; Poly(ionic liquids), such as poly(ionic liquid) materials; conductive polymers, such as polyaniline, polypyrrole, and polythiophene, when doped with suitable acids; SPEEK (Sulfonated PolyEtherEtherKetone); ammonium-functionalized (e.g., quaternary ammonium-functionalized) polysulfones or polyethers or Polyarylene Ethers or Polyethylene or Polyvinyl Alcohol; Ammonium-functionalized (e.g., Quaternary ammonium-functionalized) poly(phenylene oxide) (PPO); ammonium-functionalized (e.g., quaternary ammonium-functionalized) poly(styrene); Imidazolium-functionalized polysulfones or polyethers or Polyarylene Ethers or Polyethylene or Polyvinyl Alcohol; Imidazolium-functionalized poly(phenylene oxide) (PPO); Imidazolium-functionalized poly(styrene); Phosphonium-functionalized polysulfones or polyethers or Polyarylene Ethers or Polyethylene or Polyvinyl Alcohol; Phosphonium-functionalized poly(phenylene oxide) (PPO); Phosphonium-functionalized poly(styrene); derivatives thereof; or combinations thereof.

### Example 19

The membrane of any examples herein, particularly examples 1-18, wherein the ionomer comprises Polybenzimidazoles (PBIs); Poly(aryl ether sulfones), such as sulfonated poly(arylene ether sulfone)s; Poly(phenylene oxide) (PPO) and derivatives thereof, such as PPO polymers, such as sulfonated poly(phenylene oxide) (SPPO); Poly(ether imide); Poly(vinyl alcohol) (PVA), such as PVA-based polymers, especially when modified or blended with other materials; Poly(ionic liquids), such as poly(ionic liquid) materials; conductive polymers, such as polyaniline, polypyrrole, and polythiophene, when doped with suitable acids; Nafion; SPEEK (Sulfonated PolyEtherEtherKetone); derivatives thereof; or combinations thereof.

### Example 20

The membrane of any examples herein, particularly examples 1-19, wherein the ionomer comprises Polybenzimidazoles (PBIs); Poly(aryl ether sulfones), such as sulfonated poly(arylene ether sulfone)s; Poly(phenylene oxide) (PPO) and derivatives thereof, such as PPO polymers, such as sulfonated poly(phenylene oxide) (SPPO); Poly(ether imide); Poly(vinyl alcohol) (PVA), such as PVA-based polymers, especially when modified or blended with other materials; Poly(ionic liquids), such as poly(ionic liquid) materials; conductive polymers, such as polyaniline, polypyrrole, and polythiophene, when doped with suitable acids; SPEEK (Sulfonated PolyEtherEtherKetone); derivatives thereof; or combinations thereof.

### Example 21

The membrane of any examples herein, particularly examples 1-20, wherein the ionomer is substantially free of perfluoroalkyl and polyfluoroalkyl substances (PFAS).

### Example 22

The membrane of any examples herein, particularly examples 1-21, wherein the ionomer comprises a first ionomer and a second ionomer, wherein the first ionomer and the second ionomer are different, and wherein the two-dimensional material is infilled with the first ionomer and the support is infilled with the second ionomer.

### Example 23

The membrane of any examples herein, particularly examples 1-22, wherein the membrane is substantially free of perfluoroalkyl and polyfluoroalkyl substances (PFAS).

### Example 24

The membrane of any examples herein, particularly examples 1-23, wherein the membrane is an electrolysis membrane, an ion exchange membrane, a cation exchange membrane, a proton exchange membrane, an anion exchange membrane, or a combination thereof.

### Example 25

A method of making the membrane of any examples herein, particularly examples 1-24.

### Example 26

A device comprising the membrane of any examples herein, particularly examples 1-24.

### Example 27

The device of any examples herein, particularly example 26, wherein the device comprises a fuel cell; a separation device, such as a hydrogen, deuterium, and/or tritium separation device; a purification device, such as a gas purification device ang/or a hydrogen purification device; a hydrogen generation device; an electrolysis device; an energy storage device, such as a battery; or a combination thereof.

### Example 28

A method of use of the membrane of any examples herein, particularly examples 1-24 or the device of any examples herein, particularly examples 26-27.

### Example 29

The method of any examples herein, particularly example 28, wherein the method comprises using the membrane or device in a fuel cell, in a gas purification, in an energy conversion process, in environmental remediation, in an isotope separation, in a detector, in a membrane electrode application, or a combination thereof.

### Example 30

The method of any examples herein, particularly example 28 or example 29, wherein the method comprises using the membrane or device in a gas purification.

### Example 31

The method of any examples herein, particularly example 30, wherein the gas purification comprises D₂-He separation; tritium-³He separation; separation of H, D, and/or T from a mixture of HD, TD, and/or HT; or a combination thereof.

### Example 32

The method of any examples herein, particularly example 30 or example 31, wherein the gas purification comprises hydrogen gas purification.

### Example 33

The method of any examples herein, particularly example 28 or example 29, wherein the method comprises using the membrane or device in an isotope separation.

### Example 34

The method of any examples herein, particularly example 33, wherein the isotope separation comprises hydrogen isotope separation.

### Example 35

The method of any examples herein, particularly example 33 or example 34, wherein the isotope separation comprises a ¹H-D separation.

### Example 36

The method of any examples herein, particularly example 28 or example 29, wherein in the method comprises using the membrane or device in a proton exchange application.

### Example 37

The method of any examples herein, particularly example 28 or example 29, wherein the method comprises using the membrane or device in an application including, but not limited to, hydrogen technologies, such as electrolysis for H₂ production, fuel cells for transport, flow batteries for grid scale storage, seasonal energy storage, hydrogen purification, distributed hydrogen production, isotope separations, chemical production, etc.

### Example 38

The method of any examples herein, particularly example 28 or example 29, wherein the method comprises using the membrane or device in hydrogen, deuterium, and tritium separation.

Other advantages which are obvious and which are inherent to the invention will be evident to one skilled in the art. It will be understood that certain features and sub-combinations are of utility and may be employed without reference to other features and sub-combinations. This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

The methods of the appended claims are not limited in scope by the specific methods described herein, which are intended as illustrations of a few aspects of the claims and any methods that are functionally equivalent are intended to fall within the scope of the claims. Various modifications of the methods in addition to those shown and described herein are intended to fall within the scope of the appended claims. Further, while only certain representative method steps disclosed herein are specifically described, other combinations of the method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

What is claimed is:

1. A membrane comprising:
a two-dimensional (2D) material,
a support, and
an ionomer,
wherein the two-dimensional (2D) material disposed on the support, thereby forming a construct,
wherein the two-dimensional material is infilled with the ionomer, the support is infilled with the ionomer, the construct is infilled with the ionomer, or a combination thereof, thereby forming the membrane.

2. The membrane of claim 1, wherein the two-dimensional material comprises graphene, hexagonal boron nitride (h-BN), a transition metal dichalcogenide (e.g., porous TMDC), a covalent organic framework, a metal organic framework, ultra-thin oxides, mica, graphdyene like periodic porous structures, layered clays, mineral clays, or a combination thereof.

3. The membrane of claim 1, wherein the two-dimensional material comprises graphene, hexagonal boron nitride (h-BN), or a combination thereof.

4. The membrane of claim 1, wherein the two-dimensional material has an average thickness of from 0.3 to 100 nm.

5. The membrane of claim 1, wherein the 2D material is permeated by one or more pores, one or more defects, or a combination thereof.

6. The membrane of claim 5, wherein at least a portion of the one or more pores, the one or more defects, or a combination thereof in the 2D material are infilled by the ionomer.

7. The membrane of claim 1, wherein the support comprises polyether sulfone (PES), polystyrene (PS), polyvinylidene fluoride (PVDF), polyethylene terephthalate (PET), polycarbonate and polycarbonate track etch supports (PCTE), polyethylene (PE), high density polyethylene (HDPE), Polyester, Poly imide, Teflon, Nylon, Rayon, electrospun fibers, woven cloths or metal meshes, anodic alumina (AAO), porous silicon, derivatives thereof, or combinations thereof.

8. The membrane of claim 1, wherein the support has no pores.

9. The membrane of claim 1, wherein the support is porous in that the support is permeated by one or more pores, one or more defects, or a combination thereof.

10. The membrane of claim 9, wherein at least a portion of the one or more pores, the one or more defects, or a combination thereof in the porous support are infilled by the ionomer.

11. The membrane of claim 1, wherein the ionomer comprises a proton conducting polymer, an anion conducting polymer, or a combination thereof.

12. The membrane of claim 1, wherein the ionomer comprises Polybenzimidazoles (PBIs); Poly(aryl ether sulfones); Poly(phenylene oxide) (PPO) and derivatives thereof; Poly(ether imide); Poly(vinyl alcohol) (PVA); Poly(ionic liquids); conductive polymers; Nafion; SPEEK (Sulfonated PolyEtherEtherKetone); ammonium-functionalized polysulfones or polyethers or Polyarylene Ethers or Polyethylene or Polyvinyl Alcohol; Ammonium-functionalized poly(phenylene oxide) (PPO); ammonium-functionalized; Imidazolium-functionalized polysulfones or polyethers or Polyarylene Ethers or Polyethylene or Polyvinyl Alcohol; Imidazolium-functionalized poly(phenylene oxide) (PPO); Imidazolium-functionalized poly(styrene); Phosphonium-functionalized polysulfones or polyethers or Polyarylene Ethers or Polyethylene or Polyvinyl Alcohol; Phosphonium-functionalized poly(phenylene oxide) (PPO); Phosphonium-functionalized poly(styrene); derivatives thereof; or combinations thereof.

13. The membrane of claim 1, wherein the ionomer comprises Polybenzimidazoles (PBIs); Poly(aryl ether sulfones); Poly(phenylene oxide) (PPO) and derivatives thereof; Poly(ether imide); Poly(vinyl alcohol) (PVA); Poly(ionic liquids); conductive polymers; SPEEK (Sulfonated PolyEtherEtherKetone); ammonium-functionalized polysulfones or polyethers or Polyarylene Ethers or Polyethylene or Polyvinyl Alcohol; Ammonium-functionalized poly(phenylene oxide) (PPO); ammonium-functionalized poly(styrene); Imidazolium-functionalized polysulfones or polyethers or Polyarylene Ethers or Polyethylene or Polyvinyl Alcohol; Imidazolium-functionalized poly(phenylene oxide) (PPO); Imidazolium-functionalized poly(styrene); Phosphonium-functionalized polysulfones or polyethers or Polyarylene Ethers or Polyethylene or Polyvinyl Alcohol; Phosphonium-functionalized poly(phenylene oxide) (PPO); Phosphonium-functionalized poly(styrene); derivatives thereof; or combinations thereof.

14. The membrane of claim 1, wherein the ionomer comprises Polybenzimidazoles (PBIs); Poly(aryl ether sulfones); Poly(phenylene oxide) (PPO) and derivatives thereof; Poly(ether imide); Poly(vinyl alcohol) (PVA); Poly(ionic liquids); conductive polymers; Nafion; SPEEK (Sulfonated PolyEtherEtherKetone); derivatives thereof; or combinations thereof.

15. The membrane of claim 1, wherein the ionomer comprises Polybenzimidazoles (PBIs); Poly(aryl ether sulfones); Poly(phenylene oxide) (PPO) and derivatives thereof; Poly(ether imide); Poly(vinyl alcohol) (PVA); Poly(ionic liquids); conductive polymers; SPEEK (Sulfonated PolyEtherEtherKetone); derivatives thereof; or combinations thereof.

16. The membrane of claim 1, wherein the ionomer is substantially free of perfluoroalkyl and polyfluoroalkyl substances (PFAS).

17. The membrane of claim 1, wherein the ionomer comprises a first ionomer and a second ionomer, wherein the first ionomer and the second ionomer are different, and wherein the two-dimensional material is infilled with the first ionomer and the support is infilled with the second ionomer.

18. The membrane of claim 1, wherein the membrane is substantially free of perfluoroalkyl and polyfluoroalkyl substances (PFAS).

19. A device comprising the membrane of claim 1, wherein the device comprises a fuel cell; a separation device; a purification device; a hydrogen generation device; an electrolysis device; an energy storage device, such as a battery; or a combination thereof.

20. A method of use of the membrane of claim 1, wherein the method comprises using the membrane or device in a fuel cell, in a gas purification, in an energy conversion process, in environmental remediation, in an isotope separation, in a detector, in a membrane electrode application, or a combination thereof.
